(19) United States
(12) Patent Application Publication
(10) Pub. No.: US 2025/0016460 A1
(43) Pub. Date: Jan. 9, 2025

(54) IMAGE PROCESSING DEVICE, IMAGE PROCESSING METHOD, AND PROGRAM

(71) Applicant: SONY GROUP CORPORATION, TOKYO (JP)

(72) Inventors: TAISHI ONO, TOKYO (JP); YUHI KONDO, TOKYO (JP); LEGONG SUN, TOKYO (JP); TEPPEI KURITA, TOKYO (JP)

(21) Appl. No.: 18/715,532

(22) PCT Filed: Oct. 25, 2022
(86) PCT No.: PCT/JP2022/039660

§ 371 Date: May 31, 2024

(30) Foreign Application Priority Data
Dec. 8, 2021 (JP) 2021-199040

(51) Int. Cl. H04N 23/88; G02B 5/30; G06T 7/12; G06V 10/762

(52) U.S. Cl. CPC H04N 23/88; G02B 5/30; G06T 7/12; G06V 10/762

(57) ABSTRACT

White balance gain calculation processing and white balance adjustment are executed using polarization information acquired from a color polarized image. There are provided a polarization information acquisition unit configured to acquire polarization information from a color polarized image, a white balance gain calculation unit configured to calculate a white balance gain by using the acquired polarization information, and a white balance adjustment unit configured to execute white balance adjustment processing to which the calculated white balance gain is applied. The polarization information acquisition unit calculates a color-corresponding polarization degree from the color polarized image, and the white balance gain calculation unit detects a pixel position where polarization degrees of two colors coincide with each other on the basis of a pixel position where subject reflectances of the two colors coincide with each other, and calculates a white balance gain by using color-corresponding polarization information of the detected pixel position.

### TECHNICAL FIELD

The present disclosure relates to an image processing device, an image processing method, and a program. More specifically, the present disclosure relates to an image processing device, an image processing method, and a program for executing white balance gain calculation processing and white balance adjustment processing.

### BACKGROUND ART

As one of problems of an image captured by an imaging device (camera), there is a problem that a color different from an original subject color is output.

For example, a white subject may be output as a reddish color or a bluish color, which is not white. This is mainly caused by a color of irradiation light on the subject, that is, a light source color.

Specifically, for example, when an image of a scene is captured in the setting sun, the entire image becomes reddish. Furthermore, this similarly applies to an image captured in a room with orange illumination light, and the entire image becomes reddish.

Furthermore, an image captured under strong blue illumination light is to be an image that is entirely bluish.

When a subject is irradiated with light having a color as described above, an image is captured in which an original color of the subject is not reproduced due to the color of the irradiation light.

In order to solve this problem, many imaging devices have a function of executing white balance (WB) adjustment processing on a captured image.

The white balance adjustment processing is executed as pixel value correction processing for setting a pixel value of a captured image to an original color of a subject.

For example, the pixel value correction processing is performed so as to output a pixel value of white in an area where the original color of the subject is white, a pixel value of red in an area where the original color of the subject is red, and a pixel value of blue in an area where the original color of the subject is blue. By performing the white balance adjustment processing, an image in which the original color of the subject is reproduced can be generated and recorded.

Furthermore, recent cameras have an automatic white balance (AWB) function for automatically executing the white balance adjustment processing.

The automatic white balance (AWB) function is a function that automatically calculates a white balance gain, which is an output adjustment gain for each color component (RGB) in consideration of a light source color of an imaging scene or the like, and executes signal level adjustment for each color component by performing correction processing of each RGB pixel value by using the calculated gain.

As a technique for realizing the automatic white balance (AWB) function, a technique called gray world is widely known.

This technique is a technique of executing white balance adjustment on the assumption that an average value of pixel values of the entire captured image is to be substantially achromatic.

However, since this technique performs processing on the assumption that the average value of the entire captured image is to be substantially achromatic, accuracy of the white balance adjustment processing decreases in a case where the subject average color of the captured image is not achromatic.

Moreover, since this technique is a technique of uniformly adjusting the entire image by using an average color of the entire image, there is a problem that this technique cannot be used, for example, in a case where every image area is irradiated with light of different colors.

Furthermore, Patent Document 1 (Japanese Patent No. 4447520) discloses a light source color estimation technique using a reflection model of an object.

The technique disclosed in Patent Document 1 is a technique including: assuming that a luminance value of a pixel in a captured image is configured by two types of luminance values of “only diffused reflection light” or “diffused reflection light+specular reflection light”; calculating a specular reflection light component by performing subtraction of these two types of luminance values; estimating a color of the calculated specular reflection light component as a light source color; and executing white balance adjustment processing based on the estimated light source color.

However, in practice, intensity of diffused reflection light varies depending on texture of a subject or an object normal line defined by an uneven shape of the subject. Therefore, there is a high possibility that the value calculated by the subtraction described above greatly changes depending on texture corresponding to a pixel used to calculate the diffused reflection light component or the uneven shape, and the estimated value of the light source color greatly fluctuates. Furthermore, the assumption that the luminance value of the pixel is “only diffused reflection light” is very strict assumption, and it is also difficult to find a pixel in which this assumption is established.

Moreover, Patent Document 2 (Japanese Patent Application Laid-Open No. H06-319150) discloses a technique of performing white balance adjustment processing by using a chromatic color area in an image.

However, this technique is a technique based on the assumption that a light source color with which a subject is irradiated is along a black-body radiation curve, and accuracy decreases in a case where this assumption is not established.

Furthermore, Non-Patent Document 1 (Afifi, Mahmoud and Brown, Michael S. Deep White-Balance Editing, CVPR 2020) discloses a technique of executing white balance adjustment processing by using deep learning.

This technique is a technique of estimating an optimal white balance adjustment parameter for a captured image by using a learning model generated in advance using a context such as an object in an image, an environment, or a time zone, and performing white balance adjustment processing using the estimated parameter.

However, in this technique, it is necessary to generate the learning model by executing learning processing using a large number of captured images in advance, and processing accuracy of the white balance adjustment processing depends on the generated learning model. Moreover, there is a problem that arithmetic processing using a learning model for performing optimal parameter calculation processing is to be very heavy and complicated processing, and usage is difficult unless a camera or an image processing device is provided with a processor having a high arithmetic function.

### CITATION LIST

### Patent Document

Patent Document 1: Japanese Patent No. 4447520
Patent Document 2: Japanese Patent Application Laid-Open No. H06-319150

### Non-Patent Document

Non-Patent Document 1: Afifi, Mahmoud and Brown, Michael S. Deep White-Balance Editing, CVPR 2020.

### SUMMARY OF THE INVENTION

### Problems to be Solved by the Invention

The present disclosure has been made in view of the problems described above, for example, and an object thereof is to provide an image processing device, an image processing method, and a program capable of calculating a high-precision white balance gain using a color polarized image.

Furthermore, the present disclosure provides an image processing device, an image processing method, and a program capable of white balance gain calculation processing using a pixel value of a chromatic area of a polarization color image captured by a polarization camera, and optimal white balance gain calculation in unit of pixel or in unit of image area of the captured image.

### Solutions to Problems

A first aspect of the present disclosure is an image processing device including:
a polarization information acquisition unit configured to acquire polarization information from a color polarized image;
a white balance gain calculation unit configured to calculate a white balance gain by using polarization information acquired by the polarization information acquisition unit; and
a white balance adjustment unit configured to execute white balance adjustment processing to which a white balance gain calculated by the white balance gain calculation unit is applied, in which
the polarization information acquisition unit
calculates a color-corresponding polarization degree from the color polarized image, and
the white balance gain calculation unit
calculates a white balance gain by using color-corresponding polarization information of a pixel position where polarization degrees of two colors coincide with each other.

Moreover, a second aspect of the present disclosure is
an image processing method executed in an image processing device, the image processing method including:
a polarization information acquisition step of acquiring, by a polarization information acquisition unit, polarization information from a color polarized image;
a white balance gain calculation step of calculating, by a white balance gain calculation unit, a white balance gain by using polarization information acquired in the polarization information acquisition step; and
a white balance adjustment step of executing, by a white balance adjustment unit, white balance adjustment processing to which a white balance gain calculated in the white balance gain calculation step is applied, in which
the polarization information acquisition step includes
a step of calculating a color-corresponding polarization degree from the color polarized image, and
the white balance gain calculation step
calculates a white balance gain by using color-corresponding polarization information of a pixel position where polarization degrees of two colors coincide with each other.

Moreover, a third aspect of the present disclosure is
a program for causing an image processing device to execute image processing, the program causing execution of:
a polarization information acquisition step of causing a polarization information acquisition unit to acquire polarization information from a color polarized image;
a white balance gain calculation step of causing a white balance gain calculation unit to calculate a white balance gain by using polarization information acquired in the polarization information acquisition step; and
a white balance adjustment step of causing a white balance adjustment unit to execute white balance adjustment processing to which a white balance gain calculated in the white balance gain calculation step is applied, in which
in the polarization information acquisition step,
a color-corresponding polarization degree is calculated from the color polarized image, and
in the white balance gain calculation step,
a white balance gain is calculated using color-corresponding polarization information of a pixel position where polarization degrees of two colors coincide with each other.

Note that the program of the present disclosure is, for example, a program that can be provided by a storage medium or a communication medium that provides a variety of program codes in a computer-readable format, to an information processing device or a computer system that can execute the program codes. By providing such a program in a computer-readable format, processing corresponding to the program is implemented on the information processing device or the computer system.

Other objects, features, and advantages of the present disclosure will become apparent from a more detailed description based on embodiments of the present disclosure described later and the accompanying drawings. Note that a system described herein is a logical set configuration of a plurality of devices, and is not limited to a system in which devices with respective configurations are in the same housing.

According to a configuration of one embodiment of the present disclosure, a configuration is realized in which white balance gain calculation processing and white balance adjustment are executed by using polarization information acquired from a color polarized image.

Specifically, for example, there are provided: the polarization information acquisition unit configured to acquire polarization information from a color polarized image; the white balance gain calculation unit configured to calculate a white balance gain by using the acquired polarization information; and the white balance adjustment unit configured to execute white balance adjustment processing to which the calculated white balance gain is applied. The polarization information acquisition unit calculates a color-corresponding polarization degree from the color polarized image, and the white balance gain calculation unit detects a pixel position where polarization degrees of two colors coincide with each other on the basis of a pixel position where subject reflectances of the two colors coincide with each other, and calculates a white balance gain by using color-corresponding polarization information of the detected pixel position.

With this configuration, a configuration is realized in which white balance gain calculation processing and white balance adjustment are executed by using polarization information acquired from a color polarized image.

Note that the effects described herein are merely examples and are not limited, and additional effects may also be provided.

### BRIEF DESCRIPTION OF DRAWINGS

FIG. 1 is a diagram for explaining an outline of white balance adjustment processing.

FIG. 2 is a diagram for explaining an example of the white balance adjustment processing.

FIG. 3 is a diagram for explaining an outline of processing executed by an image processing device of the present disclosure.

FIG. 4 is a diagram for explaining an example of processing executed by the image processing device of the present disclosure.

FIG. 5 is a diagram for explaining White balance gain calculation processing example 1 executed by the image processing device of the present disclosure.

FIG. 6 is a diagram for explaining White balance gain calculation processing example 2 executed by the image processing device of the present disclosure.

FIG. 7 is a diagram for explaining a reason why a relational expression: opposite color (R, G, B) of white balance adjusted image (K_{R}i_{R}, i_{G}, k_{B}i_{B})=color of linear polarization degree (DoLP), is established.

FIG. 8 is a diagram for explaining a reason why a relational expression: opposite color (R, G, B) of white balance adjusted image (K_{R}i_{R}, i_{G}, k_{B}i_{B})=color of linear polarization degree (DoLP), is established.

FIG. 9 is a diagram for explaining a usage example of the image processing device of the present disclosure.

FIG. 10 is a diagram for explaining a configuration example of an imaging system and the image processing device of the present disclosure.

FIG. 11 is a diagram for explaining a specific configuration example of an imaging unit (color polarized image capturing camera).

FIG. 12 is a diagram for explaining a specific configuration example of the imaging unit (color polarized image capturing camera).

FIG. 13 is a diagram for explaining a specific configuration example of the imaging unit (color polarized image capturing camera).

FIG. 14 is a diagram for explaining a specific configuration example of the imaging unit (color polarized image capturing camera).

FIG. 15 is a diagram for explaining a specific configuration example of the imaging unit (color polarized image capturing camera).

FIG. 16 is a diagram for explaining a specific configuration example of the imaging unit (color polarized image capturing camera).

FIG. 17 is a diagram for explaining a specific configuration example of the imaging unit (color polarized image capturing camera).

FIG. 18 is a flowchart for explaining a processing sequence executed by the image processing device of the present disclosure.

FIG. 19 is a flowchart for explaining a processing sequence of white balance gain calculation processing executed by the image processing device of the present disclosure.

FIG. 20 is a flowchart for explaining a processing sequence of the white balance gain calculation processing executed by the image processing device of the present disclosure.

FIG. 21 is a diagram for explaining a specific example of processing of calculating different white balance gains in unit of pixel constituting an image or in unit of image area including multiple pixels.

FIG. 22 is a diagram for explaining a specific example of processing of calculating different white balance gains in unit of pixel constituting an image or in unit of image area including multiple pixels.

FIG. 23 is a diagram for explaining a processing example of performing area segmentation and calculating a white balance gain in unit of image area. It is a diagram for explaining a usage example of the image processing device of the present disclosure.

FIG. 24 is a flowchart for explaining a sequence of the white balance gain calculation processing in unit of pixel or in unit of image area executed by a white balance gain calculation unit.

FIG. 25 is a diagram for explaining a white balance gain calculation example corresponding to multiple image areas (classes).

FIG. 26 is a diagram for explaining a hardware configuration example of the image processing device of the present disclosure.

### MODE FOR CARRYING OUT THE INVENTION

Hereinafter, details of an image processing device, and an image processing method, and a program of the present disclosure will be described with reference to the drawings. Note that the description will be made in accordance with the following items.
1. About outline of white balance adjustment processing
2. About outline of processing executed by image processing device of present disclosure
3. About details of white balance gain calculation processing using polarization information
3-1. White balance gain calculation processing example 1 using polarization information
3-2. White balance gain calculation processing example 2 using polarization information
4. About configuration example of image processing device of present disclosure
5. About sequence of processing executed by image processing device of present disclosure
6. About white balance gain calculation and white balance adjustment processing in unit of pixel or in unit of image area
7. About hardware configuration example of image processing device
8. Conclusion of configuration of present disclosure

### 1. About Outline of White Balance Adjustment Processing

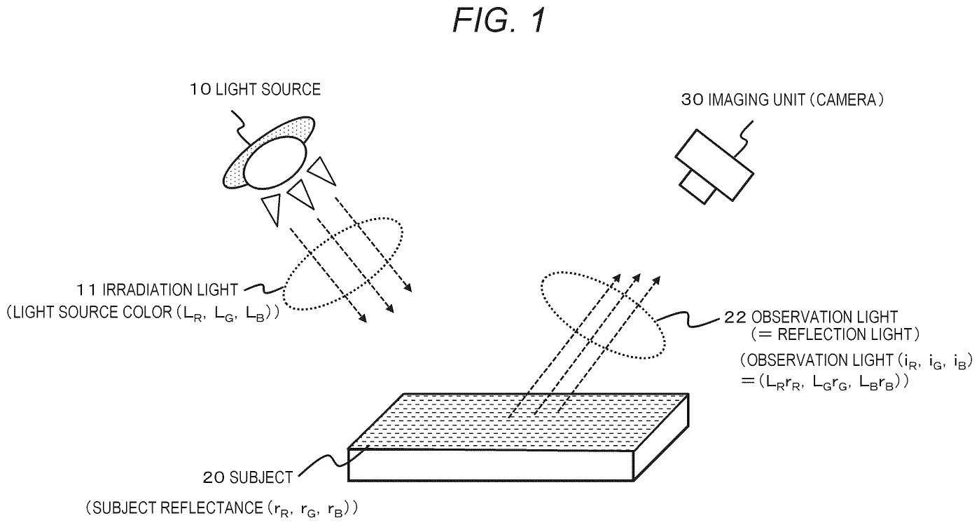

Before describing processing executed by an image processing device of the present disclosure, first, an outline of white balance adjustment processing will be described with reference to FIG. 1 and subsequent figures.

FIG. 1 illustrates a light source 10, a subject 20, and an imaging unit (camera) 30.

Irradiation light 11 of the light source 10 is reflected by the subject 20, and the imaging unit (camera) 30 captures the reflection light as observation light 22, generates a captured image of the subject 20, and records the captured image in a memory.

Here, by using an intensity ratio (relative intensity) of R (red), G (green), and B (blue), which are three primary colors of colors, a light source color (color characteristic), which is a color of the irradiation light 11 of the light source 10, is indicated as
light source color (L_{R}, L_{G}, L_{B}).
(L_{R}, L_{G}, L_{B}) described above indicates that the intensity ratio of R (red), G (green), and B (blue) of the irradiation light 11 of the light source 10 is L_{R}:L_{G}:L_{B}.

When the subject 20 is irradiated with the irradiation light 11 of the light source 10 having such a light source color (color characteristic), reflection light is output from the subject 20.

Note that the reflection light is different for each constituent part of the subject 20.

The reflection light output from each part of the subject 20 is input to the imaging unit (camera) 30 as the observation light 22, and an image is captured in which a pixel value based on the observation light 22 is set.

The pixel value of the captured image is set on the basis of the reflection light (=observation light 22) output from each part of the subject 20.

As a result, each pixel value of the image captured by the imaging unit (camera) 30 is a pixel value reflecting the color characteristic of the observation light 22.

Here, a reflectance of each color of R (red), G (green), and B (blue) at a certain point P of the subject 20 is defined as
subject reflectance (r_{R}, r_{G}, r_{B}).

Note that the subject reflectance (r_{R}, r_{G}, r_{B}) is a value different for each constituent part of the subject 20.

Here, as an example, a subject reflectance of one point P of the subject 20 will be described as (r_{R}, r_{G}, r_{B}).

Note that, in a case where a reflection characteristic of the subject 20 satisfies a dichroic reflection model (reflectance=diffuse reflectance+specular reflectance), each element of the subject reflectance (r_{R}, r_{G}, r_{B}) is indicated as a sum of a specular reflectance rₛ common to each color of R (red), G (green), and B (blue) and diffuse reflectances r_{dR}, r_{dG}, and r_{dB} different for each color of R (red), G (green), and B (blue).

That is, the following is satisfied.

$${r}_{R} = {r}_{s} + {r}_{dR}$$

$${r}_{G} = {r}_{s} + {r}_{dG}$$

$${r}_{B} = {r}_{s} + {r}_{dB}$$

A color characteristic (=an intensity ratio of each of RGB colors) of R (red), G (green), and B (blue) of the observation light 22 corresponding to the point P and being incident on the imaging unit (camera) from one point P of the subject 20, that is, the point P having the subject reflectance (r_{R}, r_{G}, r_{B}) are defined as
observation light (i_{R}, i_{G}, i_{B}).
(i_{R}, i_{G}, i_{B}) described above indicates that the intensity ratio of R (red), G (green), and B (blue) of the observation light 22 corresponding to the point P and being incident on the imaging unit (camera) is i_{R}:i_{G}:i_{B}.

The observation light (i_{R}, i_{G}, i_{B}) corresponding to the point P is a multiplication value of the light source color (L_{R}, L_{G}, L_{B}) of the light source 10 and the subject reflectance (r_{R}, r_{G}, r_{B}) of the point P of the subject 20 for each of R (red), G (green), and B (blue).

That is, the observation light (i_{R}, i_{G}, i_{B}) corresponding to the point P of the subject 20 can be calculated according to the following (Expression 1).

$$Observation light ( {i}_{R} , {i}_{G} , {i}_{B} ) = ( {L}_{R} {r}_{R} , {L}_{G} {r}_{G} , {L}_{B} {r}_{B} ) \qquad ( Expression 1 )$$

As the pixel value corresponding to the point P of the subject 20 in an image captured by the imaging unit (camera) 30, a pixel value according to the color characteristic calculated by (Expression 1) described above is set.

This similarly applies to constituent parts other than the point P of the subject 20, and the observation light (i_{R}, i_{G}, i_{B}) corresponding to each constituent point of the subject 20 can be calculated according to a multiplication value of the light source color (L_{R}, L_{G}, L_{B}) of the light source 10 and the subject reflectance (r_{R}, r_{G}, r_{B}) of each constituent point of the subject 20, that is, according to (Expression 1) described above.

As understood from (Expression 1) described above, a pixel value of the observation light 22, that is, an image captured by the imaging unit (camera) 30 is a pixel value that changes in proportion to the light source color (L_{R}, L_{G}, L_{B}).

Therefore, for example, if the light source color (L_{R}, L_{G}, L_{B}) of the light source 10 is a reddish color, the pixel value of the image captured by the imaging unit (camera) 30 is set to a reddish pixel value.

Furthermore, if the light source color (L_{R}, L_{G}, L_{B}) of the light source 10 is a bluish color, the pixel value of the image captured by the imaging unit (camera) 30 is also a bluish pixel value.

That is, the color of the light source color (L_{R}, L_{G}, L_{B}) is reflected in the color of the pixel value of the image captured by the imaging unit (camera) 30, and an image having a color different from the original color of the subject 20 is captured.

The white balance adjustment processing is executed as processing of correcting the pixel value of the image captured by the imaging unit (camera) 30 to the original color of the subject 20 independent of the light source color (L_{R}, L_{G}, L_{B}).

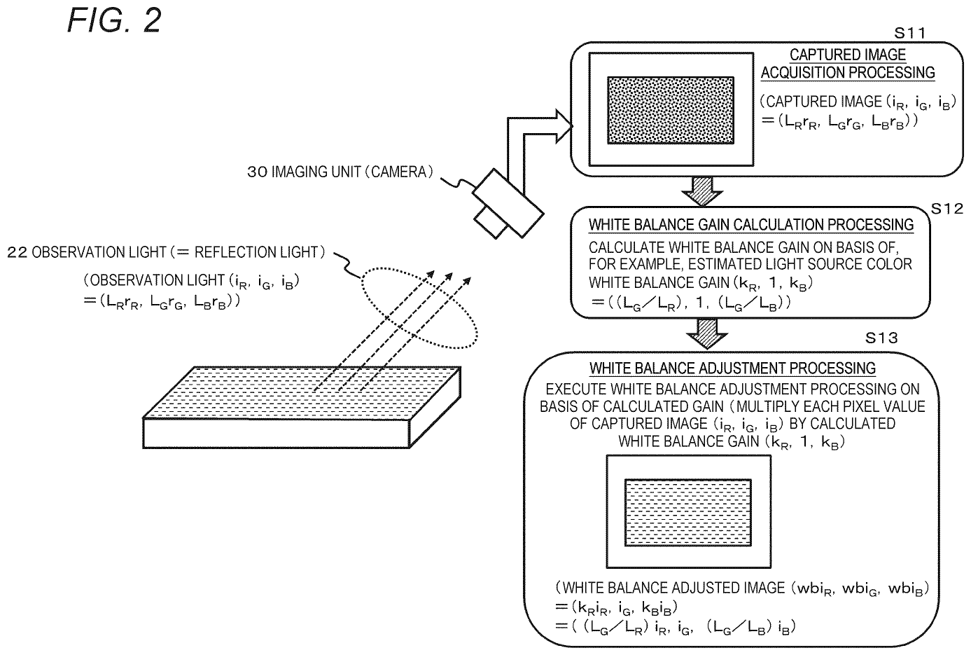

An example of the white balance adjustment processing will be described with reference to FIG. 2.

FIG. 2 illustrates processing steps S11 to S13.

Hereinafter, processing of each step is sequentially described.

### (Step S11)

Processing step S11 is captured image acquisition processing performed by the imaging unit (camera) 30.

As described above with reference to FIG. 1, the color characteristic (captured image (i_{R}, i_{G}, i_{B})) of R (red), G (green), and B (blue) of each pixel of the captured image is similar to the color characteristic (observation light (i_{R}, i_{G}, i_{B})) of the observation light 22 obtained from constituent points of the subject 20 corresponding to the pixel, and is calculated according to the following (Expression 2).

$$Captured image ( {i}_{R} , {i}_{G} , {i}_{B} ) = ( {L}_{R} {r}_{R} , {L}_{G} {r}_{G} , {L}_{B} {r}_{B} ) \qquad ( Expression 2 )$$

As described above, the pixel value of the image captured by the imaging unit (camera) 30 is a value depending on the color characteristic of the light source color (L_{R}, L_{G}, L_{B}) of the light source 10, and may be a pixel value with which the original color of the subject 20 is not reproduced.

### (Step S12)

Step S12 is the white balance gain calculation processing.

A white balance gain is a pixel value adjustment parameter for correcting the pixel value of the captured image acquired in step S11 to the original color of the subject 20.

There are various techniques for a processing mode of this white balance gain calculation processing.

For example, in a gray world technique, assuming that an average value of pixel values of the entire captured image is substantially achromatic, a pixel value adjustment parameter for uniformalizing an average value of individual RGB colors of the captured image is calculated as a white balance gain.

In many cases, a color (light source color) of the light source 10 is estimated, and the white balance gain calculation processing is performed using the estimated light source color.

The white balance gain calculated by this technique is defined as
white balance gain (k_{R}, 1, k_{B}).

Each element of the white balance gain (k_{R}, 1, k_{B}) corresponds to a multiplication parameter for the pixel value (R, G, B) of each color of the image captured by the imaging unit (camera) 30.

A white balance gain (multiplication parameter) corresponding to G (green)=1, which means that the pixel value of G (green) of the captured image is used as a reference and the G pixel value is not changed.

A white balance gain corresponding to R (red)=k_{R}, and the R pixel value is corrected by multiplying the pixel value of R (red) of the captured image by the white balance gain k_{R}.

A white balance gain corresponding to B (blue)=k_{B}, and the B pixel value is corrected by multiplying the pixel value of B (blue) of the captured image by the white balance gain k_{B}.

Through these processes, the white balance adjustment processing of the captured image is executed.

The white balance gain (k_{R}, 1, k_{B}) calculated on the basis of the light source color (L_{R}, L_{G}, L_{B}) of the light source 10 is as the following (Expression 3).

$$White balance gain ( {k}_{R} , 1 , {k}_{B} ) = ( ( {L}_{G} / {L}_{R} ) , 1 , ( {L}_{G} / {L}_{B} ) ) \qquad ( Expression 3 )$$

### (Step S13)

In step S13, which is the final step, the white balance adjustment processing is executed.

That is, the pixel value (R, G, B) of each color of the image captured by the imaging unit (camera) 30 is corrected using the white balance gain (k_{R}, 1, k_{B}) calculated in step S12 described above.

The pixel value (R, G, B) of the image captured by the imaging unit (camera) 30 is corrected as follows.

A captured image including RGB pixel values of the captured image before white balance adjustment is defined as a captured image (i_{R}, i_{G}, i_{B}), and an image including RGB pixel values after white balance adjustment is defined as a white balance adjusted image (wbi_{R}, wbi_{G}, wbi_{B}).

The white balance adjusted image (wbi_{R}, wbi_{G}, wbi_{B}) is generated according to the following (Expression 4).

$$White balance adjusted image ( {wbi}_{R} , {wbi}_{G} , {wbi}_{B} ) = ( {k}_{R} {i}_{R} , {i}_{G} , {k}_{B} {i}_{B} ) = ( ( {L}_{G} / {L}_{R} ) {i}_{R} , {i}_{G} , ( {L}_{G} / {L}_{B} ) {i}_{B} ) \qquad ( Expression 4 )$$

That is, a pixel value of each pixel constituting the white balance adjusted image (wbi_{R}, wbi_{G}, wbi_{B}) is calculated by multiplying the pixel value (i_{R}, i_{G}, i_{B}) of each pixel constituting the captured image (i_{R}, i_{G}, i_{B}) by the white balance gain (k_{R}, 1, k_{B}) (=((L_{G}/L_{R}), 1, (L_{G}/L_{B}))).

The white balance adjusted image (wbi_{R}, wbi_{G}, wbi_{B}) calculated according to (Expression 4) described above is an image including pixel values reflecting the color of the subject's last name independent of the color characteristic of the light source 10.

However, the processing described above can be executed only in a case where color (light source color) estimation processing of the light source 10 can be performed with high accuracy.

For example, the processing described above can be performed in a case where the camera includes a sensor for color analysis of ambient light and has a configuration for performing color analysis of the ambient light on the basis of a detection value of the sensor, but the light source color cannot be estimated with high accuracy in a case where the camera does not include such a sensor.

Furthermore, in the white balance gain calculation processing using the gray world technique described above, assuming that an average value of pixel values of the entire captured image is substantially achromatic, a pixel value adjustment parameter for uniformalizing an average value of individual RGB colors of the captured image is calculated as a white balance gain.

In this processing, in a case where the average color of the subject is not achromatic, this assumption is not established, and the accuracy of the white balance adjustment processing decreases.

The processing of the present disclosure solves such a problem, and is capable of highly accurate white balance gain calculation and white balance adjustment processing, by applying polarization information obtained from a polarization color image to perform highly accurate light source color estimation.

### 2. About Outline of Processing Executed by Image Processing Device of Present Disclosure

Next, an outline of processing executed by an image processing device of the present disclosure will be described.

The image processing device of the present disclosure performs the white balance gain calculation processing by using a polarized image, and executes white balance adjustment processing of a captured image by using the calculated white balance gain.

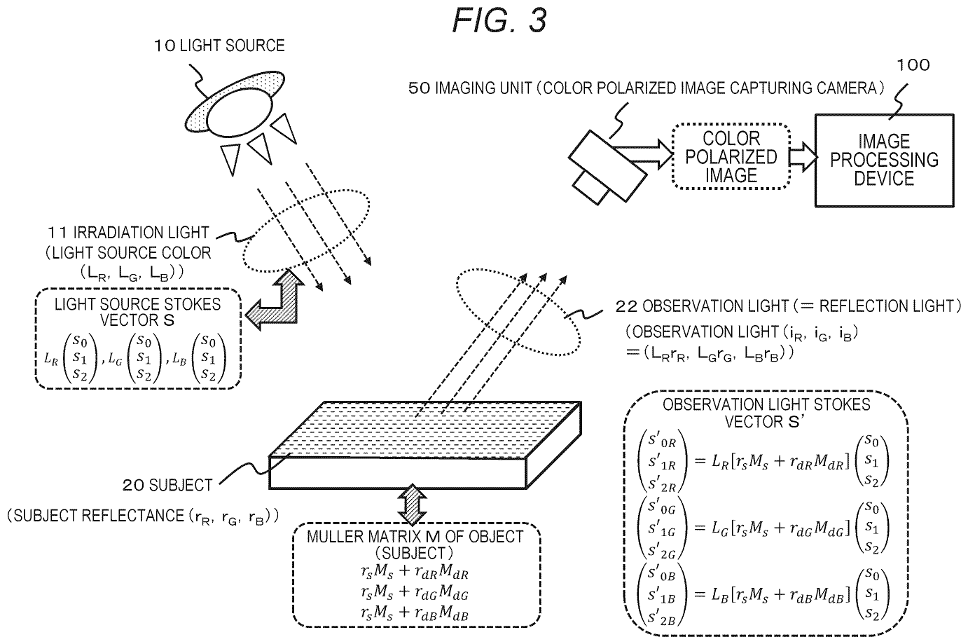

An outline of processing executed by the image processing device of the present disclosure will be described with reference to FIG. 3 and subsequent figures.

FIG. 3 illustrates the light source 10 and the subject 20 similar to those in FIG. 1 described above, and further illustrates an imaging unit (color polarized image capturing camera) 50 and an image processing device 100.

The irradiation light 11 of the light source 10 is reflected by the subject 20, and the imaging unit (color polarized image capturing camera) 50 captures an image of only a specific polarization component from the observation light 22 including the reflection light, and inputs the captured color polarized image to the image processing unit 100.

The image processing unit 100 calculates a white balance gain by using the color polarized image captured by the imaging unit (color polarized image capturing camera) 50, and executes the white balance adjustment processing by using the calculated white balance gain.

By using an intensity ratio (relative intensity) of R (red), G (green), and B (blue), which are three primary colors of colors, a light source color (color characteristic) of the irradiation light 11 of the light source 10 is indicated as
light source color (L_{R}, L_{G}, L_{B}).
(L_{R}, L_{G}, L_{B}) described above indicates that the intensity ratio of R (red), G (green), and B (blue) of the irradiation light 11 of the light source 10 is L_{R}:L_{G}:L_{B}.

Moreover, a light source Stokes vector of each of RGB colors indicating a polarization state of each of RGB colors of the irradiation light 11 of the light source 10 can be expressed by the following Expression (11).

$$[ Formula 1 ]$$

$${L}_{R} ( \begin{matrix}{s}_{0} \\ {s}_{1} \\ {s}_{2}\end{matrix} ) , {L}_{G} ( \begin{matrix}{s}_{0} \\ {s}_{1} \\ {s}_{2}\end{matrix} ) , {L}_{B} ( \begin{matrix}{s}_{0} \\ {s}_{1} \\ {s}_{2}\end{matrix} ) \qquad ( Expression 11 )$$

The Stokes vector is a vector indicating a polarization state of light, and includes four types of parameters (Stokes parameters) s₀ to s₄.

The Stokes parameter s₀ is an unpolarized light intensity signal,
the Stokes parameter s₁ is a difference signal of a horizontal/vertical linear polarization component,
the Stokes parameter s₂ is a difference signal of a 45 degree linear polarization component, and
the Stokes parameter s₃ is a difference signal of a left and right circularly polarized light component.

Note that, in the processing of the present disclosure, since the color polarized image is acquired using a linear polarizer as a polarizer, the white balance gain is calculated using three types of the Stokes parameters s₀ to s₂ among the four types of Stokes parameters s₀ to s₃.

The imaging unit (color polarized image capturing camera) 50 captures three different types of polarized images in order to acquire the three types of Stokes parameters.

Hereinafter, a processing example in which the three Stokes parameters s₀ to s₂ are used will be described.

FIG. 3 illustrates a processing example in which the three Stokes parameters s₀ to s₂ are used.

Each of RGB colors of the irradiation light 11 of the light source 10 has a polarization state defined by the light source Stokes vector shown in (Expression 11) described above, and reflection light is output from the subject 20 when the subject 20 is irradiated with the irradiation light 11.

Note that the reflection light is different for each constituent part of the subject 20.

The reflection light output from each part of the subject 20 is input to the imaging unit (color polarized image capturing camera) 50 as the observation light 22, and an image is captured in which a pixel value based on the observation light 22 is set.

The pixel value of the captured image is set on the basis of the reflection light (=observation light 22) output from each part of the subject 20.

As a result, each pixel value of the image captured by the imaging unit (color polarized image capturing camera) 50 is a pixel value reflecting the color characteristic of the observation light 22.

Here, a reflectance of each color of R (red), G (green), and B (blue) at a certain point P of the subject 20 is defined as
subject reflectance (r_{R}, r_{G}, r_{B}).

Note that the subject reflectance (r_{R}, r_{G}, r_{B}) is a value different for each constituent part of the subject 20. Here, as an example, a subject reflectance of one point P of the subject 20 will be described as (IR, r_{G}, r_{B}).

Note that, as described above, in a case where the reflection characteristic of the subject 20 satisfies a dichroic reflection model (reflectance=diffuse reflectance+specular reflectance), each element of the subject reflectance (r_{R}, r_{G}, r_{B}) is indicated as a sum of the specular reflectance Is common to each color of R (red), G (green), and B (blue) and the diffuse reflectances r_{dR}, L_{dG}, and r_{dB} different for each color of R (red), G (green), and B (blue).

That is, the following is satisfied.

$${r}_{R} = {r}_{s} + {r}_{dR}$$

$${r}_{G} = {r}_{s} + {r}_{dG}$$

$${r}_{B} = {r}_{s} + {r}_{dB}$$

Moreover, a polarization state of the irradiation light 11 changes when the irradiation light is emitted on the subject 20 and becomes reflection light. That is, a polarization state of the observation light (reflection light) 22 illustrated in the figure is different from the polarization state of the irradiation light 11.

The change in the polarization state varies depending on the reflection characteristic of the subject 20.

For example, when a Stokes vector indicating the polarization state of the irradiation light 11 is S=(s₀, s₁, s₂) and a Stokes vector indicating the polarization state of the observation light (reflection light) 22 is s′=(s′₀, s′₁, s′₂), a relational expression between the two Stokes vectors S and S′ can be described as a relational expression using one transformation matrix M, that is,

S′=MS.

M is called a Muller matrix.

The Muller matrix M is a transformation matrix reflecting the reflection characteristic of the subject 20.

The Muller matrix M can be simply expressed by a linear sum of a matrix Ms indicating specular reflection and a matrix Md indicating diffuse reflection of the subject 20.

The reflection characteristic of the subject 20 varies for each of RGB colors. For example, the Muller matrix corresponding to each of RGB colors of one point P of the subject 20 is expressed by a linear sum of the matrix Ms indicating specular reflection and the matrix Md indicating diffuse reflection of the point P of the subject 20, that is, by the following expressions (Expression 12a) to (Expression 12c).

Muller matrix of R (red light)=rₛMₛ+r_{dR}M_{dR} (Expression 12a)

Muller matrix of G (green light)=rₛMₛ+r_{dG}M_{dG} (Expression 12b)

Muller matrix of B (blue light)=rₛMₛ+r_{dB}M_{dB} (Expression 12c)

Note that, in (Expression 12a) to (Expression 12c) described above,
rₛ represents the specular reflectance rₛ common to each color of R (red), G (green), and B (blue), and
r_{dR}, r_{dG}, and r_{dB} are the diffuse reflectances r_{dR}, r_{dG}, and r_{dB} different for each of colors of R (red), G (green), and B (blue).

Furthermore, the Stokes vector S′ of each color indicating polarization states of R (red), G (green), and B (blue) of the observation light (reflection light) 22 corresponding to one point P of the subject 20 can be expressed as

(Expression 13a) to (Expression 13c) shown below, in accordance with the following relational expression.

S′=MS.

$$[ Formula 2 ]$$

$$( \begin{matrix}{s}_{0 R}^{′} \\ {s}_{1 R}^{′} \\ {s}_{2 R}^{′}\end{matrix} ) = {L}_{R} [ {r}_{s} {M}_{s} + {r}_{dR} {M}_{dR} ] ( \begin{matrix}{s}_{0} \\ {s}_{1} \\ {s}_{2}\end{matrix} ) \qquad ( Expression 13 a )$$

$$( \begin{matrix}{s}_{0 G}^{′} \\ {s}_{1 G}^{′} \\ {s}_{2 G}^{′}\end{matrix} ) = {L}_{G} [ {r}_{s} {M}_{s} + {r}_{dG} {M}_{dG} ] ( \begin{matrix}{s}_{0} \\ {s}_{1} \\ {s}_{2}\end{matrix} ) \qquad ( Expression 13 b )$$

$$( \begin{matrix}{s}_{0 B}^{′} \\ {s}_{1 B}^{′} \\ {s}_{2 B}^{′}\end{matrix} ) = {L}_{B} [ {r}_{s} {M}_{s} + {r}_{dB} {M}_{dB} ] ( \begin{matrix}{s}_{0} \\ {s}_{1} \\ {s}_{2}\end{matrix} ) \qquad ( Expression 13 c )$$

The imaging unit (color polarized image capturing camera) 50 captures multiple color polarized images for acquiring Stokes parameters constituting Stokes vectors of the individual colors indicating polarization states of R (red), G (green), and B (blue) of the observation light (reflection light) 22, that is,

S′_{R}=(s′_{0R},s′_{1R},s′_{2R})^{T},

S′_{G}=(s′_{0G},s′_{1G},s′_{2G})^{T}, and

s′_{B}=(s′_{0B},s′_{1B},s′_{2B})^{T},
and outputs the multiple captured color polarized images to the image processing device 100.

Note that the imaging unit (color polarized image capturing camera) 50 has a configuration for capturing these multiple color polarized images.

For example, a configuration using multiple cameras including different polarizing plates can be used. Alternatively, a configuration may be adopted in which a single camera having an imaging element including a polarizing element in unit of pixel is used.

Note that a specific configuration example of the imaging unit 50 that captures multiple different polarized images will be described in detail later.

The image processing device 100 is input with multiple color polarized images captured by the imaging unit (color polarized image capturing camera) 50, acquires Stokes parameters constituting the above-described Stokes vectors S′_{R}, S′_{G}, and S′B, calculates white balance gains corresponding to each of colors of RGB, and executes the white balance adjustment processing to which the calculated white balance gains are applied.

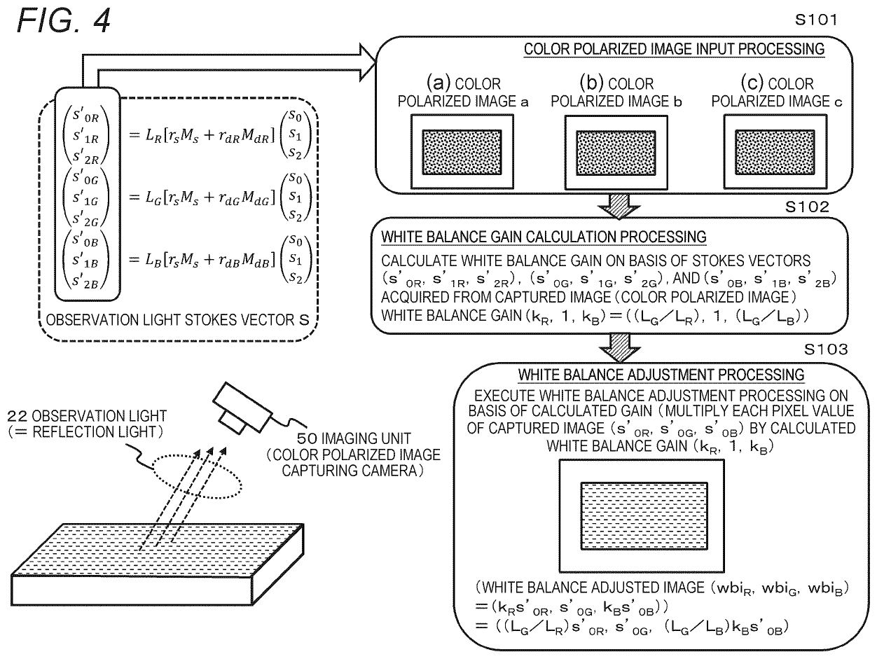

An example of processing executed by the image processing device 100 will be described with reference to FIG. 4.

FIG. 4 illustrates processing steps S101 to S103 of the processing executed by the image processing device 100.

Hereinafter, processing of each step is sequentially described.

### (Step S101)

Processing step S101 is input processing for multiple color polarized images captured by the imaging unit (color polarized image capturing camera) 50.

The imaging unit (color polarized image capturing camera) 50 captures three types of images in order to acquire three types of Stokes parameters S′₀ to S′₂ of the observation light 22.

The three types of images are the following three types of images shown in step S101 of FIG. 4.
(a) Color polarized image a
(b) Color polarized image b
(c) Color polarized image c

### (Step S102)

Step S102 is the white balance gain calculation processing.

In step S102, from the three types of images acquired in step S101, the following Stokes parameters are acquired, that is,
(a) a Stokes parameter (s′_{0R}, s′_{0G}, s′_{0B}) corresponding to an unpolarized light intensity signal (luminance signal) corresponding to each of RGB colors in the observation light 22,
(b) a Stokes parameter (s′_{1R}, s′_{1G}, s′_{1B}) corresponding to a difference signal of a horizontal/vertical linear polarization component corresponding to each of RGB colors in the observation light 22, and
(c) a Stokes parameter (s′_{2R}, s′_{2G}, s′_{2B}) corresponding to a difference signal of a 45 degree linear polarization component corresponding to each of RGB colors in the observation light 22,
these three types of Stokes parameters are acquired, and a white balance gain, which is a pixel value adjustment parameter for correcting the pixel value of the captured image to the original color of the subject 20, is calculated using the acquired Stokes parameters.

Details of the white balance gain calculation processing using these three types of Stokes parameters will be described in detail in the next item [3. Details of white balance gain calculation processing using polarization information].

The white balance gain calculated in step S102 is defined as
white balance gain (k_{R}, 1, k_{B}).

Each element of the white balance gain (k_{R}, 1, k_{B}) corresponds to a multiplication parameter for the pixel value (R, G, B) of each color of the image captured by the imaging unit (camera) 30.

By using the pixel value of G (green) of the captured image as a reference without changing the G pixel value, the pixel value of R (red) of the captured image is multiplied by the gain k_{R}, and the pixel value of B (blue) of the captured image is multiplied by the gain k_{B}, thereby a corrected pixel value after white balance adjustment can be calculated.

The white balance gain (k_{R}, 1, k_{B}) can be expressed by the following (Expression 14) by using the light source color (L_{R}, L_{G}, L_{B}) of the light source 10.

$$White balance gain ( {k}_{R} , 1 , {k}_{B} ) = ( ( {L}_{G} / {L}_{R} ) , 1 , ( {L}_{G} / {L}_{B} ) ) \qquad ( Expression 14 )$$

### (Step S103)

In step S103, which is the final step, the white balance adjustment processing is executed.

In step S103, the pixel value (R, G, B) of each color of the image captured by the imaging unit (camera) 30 is corrected using the white balance gain (k_{R}, 1, k_{B}) calculated in step S102 described above.

Note that the Stokes parameter (s′_{0R}, s′_{0G}, s′_{0B}) acquired from the multiple color polarized images acquired in step S101 corresponds to a light intensity signal (luminance signal) corresponding to each of RGB colors and corresponds to an RGB color image. That is, the RGB color image is a color image including a light intensity signal (luminance signal) corresponding to each of RGB colors, that is, the signals (s′0R, s′_{0G}, s′_{0B}).

The Stokes parameter (s′_{0R}, s′_{0G}, s′_{0B}) corresponds to an RGB pixel value constituting an RGB color image.

That is, the following is satisfied.

R pixel value=s′_{0R}

G pixel value=s′_{0G}

B pixel value=s′_{0B}

An RGB image as a white balance adjusted image can be generated by multiplying an image (s′_{0R}, s′_{0G}, s′_{0B}) including luminance signals corresponding to these RGB pixel values by the white balance gain (k_{R}, 1, k_{B}) calculated in step S102 described above.

Note that the image processing device 100 of the present disclosure can also execute white balance adjustment on a polarized image acquired by the imaging unit 50 to generate a white balance-adjusted polarized image.

A description is given to a change in pixel values before and after adjustment in a case where white balance adjustment is performed on the image (s′_{0R}, s′_{0G}, s′_{0B}) including luminance signals corresponding to RGB pixel values.

A captured image including RGB pixel values before white balance adjustment is defined as a captured image (i_{R}, i_{G}, i_{B}) (=(s′_{0R}, s′_{0G}, s′_{0B})), and an image including RGB pixel values after white balance adjustment is defined as a white balance adjusted image (wbi_{R}, wbi_{G}, wbi_{B}).

The white balance adjusted image (wbi_{R}, wbi_{G}, wbi_{B}) is generated according to the following (Expression 15).

$$White balance adjusted image ( {wbi}_{R} , {wbi}_{G} , {wbi}_{B} ) = ( {k}_{R} {s}_{OR}^{′} , {s}_{OG}^{′} , {k}_{B} {s}_{OB}^{′} ) = ( ( {L}_{G} / {L}_{R} ) {s}_{OR}^{′} , {s}_{OG}^{′} , ( {L}_{G} / {L}_{B} ) {s}_{OB}^{′} ) \qquad ( Expression 15 )$$

That is, a pixel value of each pixel constituting the white balance adjusted image (wbi_{R}, wbi_{G}, wbi_{B}) is calculated by multiplying the pixel value (s′_{0R}, s′_{0G}, s′_{0B}) by the white balance gain (k_{R}, 1, k_{B}) (=((L_{G}/L_{R}), 1, (L_{G}/L_{B}))).

The white balance adjusted image (wbi_{R}, wbi_{G}, wbi_{B}) calculated according to (Expression 15) described above is an image including pixel values reflecting the color of the subject's last name independent of the color characteristic of the light source 10.

### 3. About Details of White Balance Gain Calculation Processing Using Polarization Information

Next, white balance gain calculation processing using polarization information will be described in detail.

The image processing device 100 of the present disclosure calculates a white balance gain by using polarization information.

The polarization information to be applied to the calculation processing of the white balance gain is information that can be acquired from a color polarized image that is an image captured by the imaging unit (color polarized image capturing camera) 50.

Specifically, the polarization information is information such as a Stokes parameter and a degree of linear polarization (DoLP) that can be calculated with the Stokes parameter.

Note that the linear polarization degree (DoLP) is a ratio (%) of linearly polarized light included in the observation light (reflection light) 22, and details will be described later.

Hereinafter, a description will be made on details of the processing of step S102 described with reference to FIG. 4, that is, the calculation processing of the white balance gain using the Stokes parameter.

As described above, in step S102, the following Stokes parameters are acquired from the three color polarized images acquired in step S101. That is,
(a) a Stokes parameter (s′_{0R}, s′_{0G}, s′_{0B}) corresponding to an unpolarized light intensity signal (luminance signal) corresponding to each of RGB colors in the observation light 22,
(b) a Stokes parameter (s′_{1R}, s′_{1G}, s′_{1B}) corresponding to a difference signal of a horizontal/vertical linear polarization component corresponding to each of RGB colors in the observation light 22, and
(c) a Stokes parameter (s′_{2R}, s′_{2G}, s′_{2B}) corresponding to a difference signal of a 45 degree linear polarization component corresponding to each of RGB colors in the observation light 22.

Moreover, by using the acquired three types of Stokes parameters, calculation is performed to obtain a white balance gain, which is a pixel value adjustment parameter for correcting the pixel value of the captured image to the original color of the subject 20.

Hereinafter, two processing examples of a specific processing example of the calculation processing of the white balance gain using the Stokes parameter will be sequentially described.

### 3-1. White Balance Gain Calculation Processing Example 1 Using Polarization Information

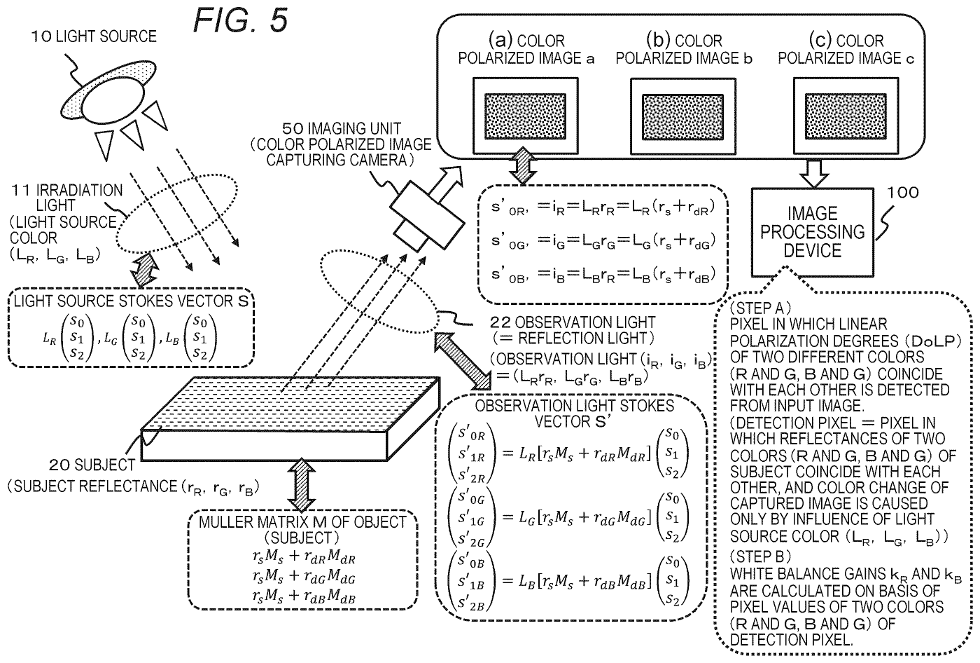

First, with reference to FIG. 5, White balance gain calculation processing example 1 using polarization information will be described.

The image processing device 100 of the present disclosure calculates a white balance gain by using polarization information acquired from a polarized image input from the imaging unit 50. The image processing device 100 of the present disclosure calculates an optimum white balance gain by using the polarization information of a chromatic area even in a case where an achromatic area cannot be detected from the captured image.

White balance gain calculation processing example 1 described below is a processing example in which the image processing device 10 executes the following processing steps A to B to calculate the white balance gain, as illustrated as processing of the image processing device 100 in FIG. 5.
(Step A) A pixel in which linear polarization degrees (DoLP) of two different colors (R and G, B and G) coincide with each other is detected from an input image.
(Detection pixel=a pixel in which reflectances of the two colors (R and G, B and G) of the subject coincide with each other, and a color change of the captured image is caused only by an influence of the light source color (L_{R}, L_{G}, L_{B}))
(Step B) White balance gains k_{R} and k_{B} are calculated on the basis of pixel values of the two colors (R and G, B and G) of the detection pixel.

Hereinafter, with reference to FIG. 5, this White balance gain calculation processing example 1 will be described in detail.

Similarly to the description with reference to FIGS. 3 and 4, FIG. 5 illustrates the light source 10 and the subject 20, and further illustrates the imaging unit (color polarized image capturing camera) 50 and the image processing device 100.

The irradiation light 11 of the light source 10 is reflected by the subject 20, and the imaging unit (color polarized image capturing camera) 50 captures an image of only a specific polarization component from the observation light 22 including the reflection light, and inputs the captured color polarized image to the image processing unit 100.

The image processing unit 100 calculates a white balance gain by using the color polarized image captured by the imaging unit (color polarized image capturing camera) 50, and executes the white balance adjustment processing by using the calculated white balance gain.

A light source Stokes vector of each of RGB colors indicating a polarization state of each of RGB colors of the irradiation light 11 of the light source 10 is expressed by the following expression (Expression 11) as described above.

$$[ Formula 3 ]$$

$${L}_{R} ( \begin{matrix}{s}_{0} \\ {s}_{1} \\ {s}_{2}\end{matrix} ) , {L}_{G} ( \begin{matrix}{s}_{0} \\ {s}_{1} \\ {s}_{2}\end{matrix} ) , {L}_{B} ( \begin{matrix}{s}_{0} \\ {s}_{1} \\ {s}_{2}\end{matrix} ) \qquad ( Expression 11 )$$

Note that, as described above, the Stokes vector is a vector indicating a polarization state of light, and includes four types of parameters (Stokes parameters) of s₀ to s₃. However, the image processing device 100 of the present disclosure calculates a white balance gain by using the following three types of Stokes parameters so to s₂.

Stokes parameter s₀=unpolarized light intensity signal

Stokes parameter s₁=difference signal of horizontal/vertical linear polarization component

Stokes parameter s₂=difference signal of 45 degree linearly polarized component

When the subject 20 is irradiated with the irradiation light 11 of the light source 10 having the polarization state indicated by the light source Stokes vectors of the individual colors of RGB shown in (Expression 11) described above, the observation light 22 which is reflection light from the subject 20 is input to the imaging unit (color polarized image capturing camera) 50.

As described above with reference to FIG. 3, the polarization state of the irradiation light 11 of the light source 10 changes when the irradiation light is emitted on the subject 20 and becomes reflection light.

When a Stokes vector of the irradiation light 11 is S=(s₀, s₁, s₂), and
the Stokes vector of the observation light (reflection light) 22 is s′=(s′₀, s′₁, s′₂), a relational expression between the two Stokes vectors S and s′ can be expressed as a relational expression using the Muller matrix M, that is

s′=MS.

The Muller matrix M can be simply expressed by a linear sum of the matrix Ms indicating specular reflection and the matrix Md indicating diffuse reflection of the subject 20, and the Muller matrix corresponding to each of RGB colors is expressed by the following expressions (Expression 12a) to (Expression 12c).

$$Muller matrix of R ( red light ) = {r}_{s} {M}_{s} + {r}_{dR} {M}_{dR} \qquad ( Expression 12 a )$$

$$Muller matrix of G ( green light ) = {r}_{s} {M}_{s} + {r}_{dG} {M}_{dG} \qquad ( Expression 12 b )$$

$$Muller matrix of B ( blue light ) = {r}_{s} {M}_{s} + {r}_{dB} {M}_{dB} \qquad ( Expression 12 c )$$

Note that,
rₛ represents the specular reflectance Is common to each color of R (red), G (green), and B (blue), and
r_{dR}, r_{dG}, and r_{dB} are the diffuse reflectances r_{dR}, r_{dG}, and r_{dB} different for each of colors of R (red), G (green), and B (blue).

Furthermore, the Stokes vector S′ of each color indicating polarization states of R (red), G (green), and B (blue) of the observation light (reflection light) 22 corresponding to one point P of the subject 20 can be expressed as
(Expression 13a) to (Expression 13c) shown below, in accordance with the following relational expression.

S′=MS.

$$[ Formula 4 ]$$

$$( \begin{matrix}{s}_{0 R}^{′} \\ {s}_{1 R}^{′} \\ {s}_{2 R}^{′}\end{matrix} ) = {L}_{R} [ {r}_{s} {M}_{s} + {r}_{dR} {M}_{dR} ] ( \begin{matrix}{s}_{0} \\ {s}_{1} \\ {s}_{2}\end{matrix} ) \qquad ( Expression 13 a )$$

$$( \begin{matrix}{s}_{0 G}^{′} \\ {s}_{1 G}^{′} \\ {s}_{2 G}^{′}\end{matrix} ) = {L}_{G} [ {r}_{s} {M}_{s} + {r}_{dG} {M}_{dG} ] ( \begin{matrix}{s}_{0} \\ {s}_{1} \\ {s}_{2}\end{matrix} ) \qquad ( Expression 13 b )$$

$$( \begin{matrix}{s}_{0 B}^{′} \\ {s}_{1 B}^{′} \\ {s}_{2 B}^{′}\end{matrix} ) = {L}_{B} [ {r}_{s} {M}_{s} + {r}_{dB} {M}_{dB} ] ( \begin{matrix}{s}_{0} \\ {s}_{1} \\ {s}_{2}\end{matrix} ) \qquad ( Expression 13 c )$$

The imaging unit (color polarized image capturing camera) 50 captures multiple color polarized images for acquiring Stokes parameters constituting Stokes vectors of the individual colors indicating polarization states of R (red), G (green), and B (blue) of the observation light (reflection light) 22, that is,

S′_{R}=(s′_{0R},s′_{1R},s′_{2R})^{T},

S′_{G}=(s′_{0G},s′_{1G},s′_{2G})^{T}, and

S′_{B}=(s′_{0B},s′_{1B},s′_{2B})^{T},
and outputs the multiple captured color polarized images to the image processing device 100.

That is, the color polarized images are the following three types of images illustrated in FIG. 5.
(a) Color polarized image a
(b) Color polarized image b
(c) Color polarized image c

Note that the Stokes parameter s₀ is an unpolarized light intensity signal, and the image (s′_{0R}, s′_{0G}, s′_{0B}) is an image including a light intensity signal (luminance signal) corresponding to each of RGB colors. Therefore, if the white balance adjustment processing is executed using the image (s′_{0R}, s′_{0G}, s′_{0B}) including the Stokes parameter s₀ as the white balance adjustment target image, an RGB image accurately reflecting the color of the subject 20 can be acquired.

In the captured image (s′_{0R}, s′_{0G}, s′_{0B}), the captured image including the RGB pixel values before the white balance adjustment is an image including the same RGB pixel values as the observation light (i_{R}, i_{G}, i_{B}) corresponding to each constituent point of the subject 20.

However, the observation light (i_{R}, i_{G}, i_{B}) corresponding to each constituent point of the subject 20 is a multiplication value of the light source color (L_{R}, L_{G}, L_{B}) of the light source 10 and the subject reflectance (r_{R}, r_{G}, r_{B}) of each constituent point of the subject 20, that is, light calculated according to the following (Expression 1) described above.

$$Observation light ( {i}_{R} , {i}_{G} , {i}_{B} ) = ( {L}_{R} {r}_{R} , {L}_{G} {r}_{G} , {L}_{B} {r}_{B} ) \qquad ( Expression 1 )$$

That is, the captured image (s′_{0R}, s′_{0G}, s′_{0B}) including the Stokes parameter s₀, and each value thereof is calculated according to the following (Expression 16).

$$Captured image ( {s}_{OR}^{′} , {s}_{OG}^{′} , {s}_{OB}^{′} ) = observation light ( {i}_{R} , {i}_{G} , {i}_{B} ) = ( {L}_{R} {r}_{R} , {L}_{G} {r}_{G} , {L}_{B} {r}_{B} ) \qquad ( Expression 16 )$$

As understood from (Expression 16) described above, the pixel value of the captured image (s′_{0R}, s′_{0G}, s′_{0B}) is a pixel value that changes in proportion to the light source color (L_{R}, L_{G}, L_{B}) and the subject reflectance (r_{R}, r_{G}, k_{B}).

That is, the pixel value of the captured image (s′_{0R}, s′_{0G}, s′_{0B}) is to be an image including a pixel value of a color different from the original color of the subject 20 due to a color change according to the light source color (L_{R}, L_{G}, L_{B}) of the light source 10 or the subject reflectance (r_{R}, r_{G}, r_{B}).

Note that, as described above, in a case where the reflection characteristic of the subject 20 satisfies a dichroic reflection model (reflectance=diffuse reflectance+specular reflectance), each element of the subject reflectance (r_{R}, r_{G}, r_{B}) is indicated as a sum of the specular reflectance Is common to each color of R (red), G (green), and B (blue) and the diffuse reflectances r_{dR}, r_{dG}, and r_{dB} different for each color of R (red), G (green), and B (blue).

That is, the following is satisfied.

$${r}_{R} = {r}_{s} + {r}_{dR}$$

$${r}_{G} = {r}_{s} + {r}_{dG}$$

$${r}_{B} = {r}_{s} + {r}_{dB}$$

Therefore, each value of the captured image (s′_{0R}, s′_{0G}, s′_{0B}) can be expressed as the following (Expression 17).

$$Captured image ( {s}_{OR}^{′} , {s}_{OG}^{′} , {s}_{OB}^{′} ) = observation light ( {i}_{R} , {i}_{G} , {i}_{B} ) = ( {L}_{R} {r}_{R} , {L}_{G} {r}_{G} , {L}_{B} {r}_{B} ) = ( {L}_{R} ( {r}_{s} + {r}_{dR} ) , {L}_{G} ( {r}_{s} + {r}_{dG} ) , {L}_{B} ( {r}_{s} + {r}_{dB} ) ) \qquad ( Expression 17 )$$

As can be understood from (Expression 17) described above, an influence of a color change on the RGB pixel values (s′_{0R}, s′_{0G}, s′_{0B}) of the captured image (s′_{0R}, s′_{0G}, s′_{0B}) is
the light source color (L_{R}, L_{G}, L_{B}), and
the subject reflectance (r_{R}, r_{G}, r_{B})=((rₛ+r_{dR}), (rₛ+r_{dG}), (rₛ+r_{dB})).

In order to calculate a white balance gain for eliminating a color change caused by the light source color (L_{R}, L_{G}, L_{B}), the image processing device 100 of the present disclosure detects a pixel having no color change due to the reflectance (r_{R}, r_{G}, r_{B})=((rₛ+r_{dR}), (rₛ+r_{dG}), (rₛ+r_{dB})) of the subject 20, from the image captured by the imaging unit 50.

That is, a pixel estimated to have undergone a color change based only on the light source color (L_{R}, L_{G}, L_{B}) is detected from the image captured by the imaging unit 50.

The processing executed as this processing is the processing (step A) of the image processing device 100 illustrated in FIG. 5. That is, the processing is as follows.

(Step A) A pixel in which linear polarization degrees (DoLP) of two different colors (R and G, B and G) coincide with each other is detected from an input image.

The detection pixel detected in the processing of step A is a pixel in which the reflectances of the two colors (R and G, B and G) of the subject coincide with each other, and a cause of a color change of the captured image is only the influence of the light source color (L_{R}, L_{G}, L_{B}).

Note that, as described above, the white balance gains (k_{R}, 1, k_{B}) include two types of white balance gains:
a white balance gain corresponding to R (red)=k_{R};
and a white balance gain corresponding to B (blue)=k_{B}, and
the image processing device 100 calculates these two types of white balance gains k_{R} and k_{B}.

As processing for calculating the white balance gain k_{R} corresponding to R (red), the image processing device 100 detects a pixel in which linear polarization degrees (DoLP_{R} and DoLP_{G}) of two different colors (R and G) coincide with each other, from the image captured by the imaging unit 50.

The pixel (DoLP_{R}=DoLP_{G}) detected by this processing is a pixel in which the reflectances of the two colors (R and G) of the subject coincide with each other, and a color change of the captured image is caused only by the influence of the light source color (L_{R}, L_{G}, L_{B}).

Moreover, as processing for calculating the white balance gain k_{B} corresponding to B (blue), the image processing device 100 detects a pixel in which linear polarization degrees (DoLP_{B} and DoLP_{G}) of two different colors (B and G) coincide with each other, from the image captured by the imaging unit 50.

The pixel (DoLP_{B}=DoLP_{G}) detected by this processing is a pixel in which reflectances of the two colors (B and G) of the subject coincide with each other, and a color change of the captured image is caused only by the influence of the light source color (L_{R}, L_{G}, L_{B}).

As described above, the reflectance (r_{R}, r_{G}, r_{B}) Of the subject 20 is indicated as a sum of the specular reflectance Is common to each color of R (red), G (green), and B (blue) and the diffuse reflectances r_{dR}, r_{dG}, and r_{dB} different for each color of R (red), G (green), and B (blue).

That is, the following is satisfied.

$${r}_{R} = {r}_{s} + {r}_{dR} \\ {r}_{G} = {r}_{s} + {r}_{dG} \\ {r}_{B} = {r}_{s} + {r}_{dB}$$

A pixel position where the reflectance IR of R (red) and the reflectance r_{G} of G (green) coincide with each other is a pixel position where the following expression is established.

r_{R}=r_{G}

Furthermore, a pixel position where the reflectance r_{B} of B (blue) and the reflectance r_{G} of G (green) coincide with each other is a pixel position where the following expression is established.

r_{B}=r_{G}

Assuming that an RGB color image including the Stokes parameter s₀ that can be acquired from a polarized image input from the imaging unit 50 is the captured image (s′_{0R}, s′_{0G}, s′_{0B}), consideration is given to a pixel value at the pixel position where the reflectance IR of R (red) and the reflectance r_{G} of G (green) coincide with each other, that is, the pixel position where

r_{R}=r_{G}
is established.

At the pixel position where the reflectance IR of R (red) and the reflectance r_{G} of G (green) coincide with each other, that is, the pixel position where

r_{R}=r_{G}
is established,

$$captured image ( {s}_{0 R}^{′} , {s}_{0 G}^{′} , {s}_{0 B}^{′} ) = observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{G} , {L}_{G} {r}_{G} , {L}_{B} {r}_{B} ) \qquad ( Expression 18 )$$

is satisfied.

That is, since L_{R}r_{R}=L_{G}r_{G} is established, L_{R}r_{R} can be replaced with L_{R}r_{G}.

From (Expression 18) described above, the following (Expression 19) is obtained.

$$( {i}_{G} / {i}_{R} ) = ( ( {L}_{G} {r}_{G} ) / ( {L}_{R} {r}_{G} ) ) = ( {L}_{G} / {L}_{R} ) \qquad ( Expression 19 )$$

The final term (L_{G}/L_{R}) in (Expression 19) described above
corresponds to an intensity ratio of G (green) to R (red) of the light source color (L_{R}, L_{G}, L_{B}).

Therefore, a relational expression between the white balance gain (k_{R}, 1, k_{B}) for eliminating the influence of the light source color (L_{R}, L_{G}, L_{B}) and the light source color (L_{R}, L_{G}, L_{B}) is to be a relational expression expressed by the following (Expression 20).

$$White balance gain ( {k}_{R} , 1 , {k}_{B} ) = ( ( {L}_{G} / {L}_{R} ) , 1 , ( {L}_{G} / {L}_{B} ) ) \qquad ( Expression 20 )$$

As shown in (Expression 20) described above, (L_{G}/L_{R}) calculated according to (Expression 19) described above
corresponds to the white balance gain k_{R}.

That is, (L_{G}/L_{R}) calculated according to (Expression 19) described above is the white balance gain k_{R} to be applied to correction of the pixel value (intensity) of R (red) when the pixel value (intensity) of G (green) is used as a reference.

In this way, if it is possible to detect the pixel position where the reflectance IR of R (red) and the reflectance r_{G} of G (green) coincide with each other in the subject 20, that is, the pixel position where

r_{R}=r_{G}
is established, the following expression,

$$captured image ( {s}_{0 R}^{′} , {s}_{0 G}^{′} , {s}_{0 B}^{′} ) = observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{G} , {L}_{G} {r}_{G} , {L}_{B} {r}_{B} )$$

is established, and
the white balance gain k_{R} to be applied to correction of the pixel value (intensity) of R (red), that is,

$${k}_{R} = ( {L}_{G} / {L}_{R} )$$

can be calculated from the R pixel value (s′_{0R}=L_{R}r_{G}) and the G pixel value (s′_{0G}=L_{G}r_{G}) at this pixel position.

Similarly, at the pixel position where the reflectance r_{B} of B (blue) and the reflectance r_{G} of G (green) coincide with each other, that is, the pixel position where

r_{B}=r_{G}
is established,

$$captured image ( {s}_{0 R}^{′} , {s}_{0 G}^{′} , {s}_{0 B}^{′} ) = observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{R} , {L}_{G} {r}_{G} , {L}_{B} {r}_{G} ) \qquad ( Expression 21 )$$

is satisfied.

That is, since L_{B}r_{B}=Lars is established, L_{B}r_{B} can be replaced with L_{B}r_{G}.

From (Expression 21) described above, the following (Expression 22) is obtained.

$$( {i}_{G} / {i}_{B} ) = ( ( {L}_{G} {r}_{G} ) / ( {L}_{B} {r}_{G} ) ) = ( {L}_{G} / {L}_{B} ) \qquad ( Expression 22 )$$

The final term (L_{G}/L_{B}) in (Expression 22) described above
corresponds to an intensity ratio of G (green) to B (blue) of the light source color (L_{R}, L_{G}, L_{B}).

Therefore, a relational expression between the white balance gain (k_{R}, 1, k_{B}) for eliminating the influence of the light source color (L_{R}, L_{G}, L_{B}) and the light source color (L_{R}, L_{G}, L_{B}) is to be a relational expression expressed by the following (Expression 23).

$$White balance gain ( {k}_{R} , 1 , {k}_{B} ) = ( ( {L}_{G} / {L}_{R} ) , 1 , ( {L}_{G} / {L}_{B} ) ) \qquad ( Expression 23 )$$

As shown in (Expression 23) described above, (L_{G}/L_{B}) calculated according to (Expression 22) described above
corresponds to the white balance gain k_{B}.

That is, (L_{G}/L_{B}) calculated according to (Expression 22) described above is the white balance gain k_{B} to be applied to correction of the pixel value (intensity) of B (blue) when the pixel value (intensity) of G (green) is used as a reference.

In this way, from the image captured by the imaging unit 50, if it is possible to detect a pixel position where the B (blue) reflectance r_{B} and the G (green) reflectance r_{G} coincide with each other, that is, a pixel position where

r_{B}=r_{G}
is established, the following expression,

$$captured image ( {s}_{0 R}^{′} , {s}_{0 G}^{′} , {s}_{0 B}^{′} ) = observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{R} , {L}_{G} {r}_{G} , {L}_{B} {r}_{G} )$$

is established, and
the white balance gain k_{B} to be applied to correction of the pixel value (intensity) of B (blue), that is,

$${k}_{B} = ( {L}_{G} / {L}_{B} )$$

can be calculated from the R pixel value (s′_{0B}=L_{B}r_{G}) and the G pixel value (s′_{0G}=L_{G}r_{G}) at this pixel position.

As described above, as the processing for calculating the white balance gain k_{R} corresponding to R (red), the image processing device 100 detects a pixel in which the reflectances of the two colors (R and G) of the subject coincide with each other, and a color change of the captured image is caused only by the influence of the light source color (L_{R}, L_{G}, L_{B}).

Furthermore, as the processing for calculating the white balance gain k_{B} corresponding to B (blue), a pixel is detected in which the reflectances of the two colors (B and G) of the subject coincide with each other, and a color change of the captured image is caused only by the influence of the light source color (L_{R}, L_{G}, L_{B}).

The image processing device 100 of the present disclosure executes the processing of (Step A) illustrated in FIG. 5, in order to detect a pixel position where the reflectances of the two colors (R and G) of the subject coincide with each other and a pixel position where the reflectances of the two colors (B and G) of the subject coincide with each other.

That is, the processing of “(Step A) a pixel in which linear polarization degrees (DoLP) of two different colors (R and G, B and G) coincide with each other is detected from an input image” is executed.

For example, in order to detect a pixel position where

r_{R}=r_{G}

is established, which is required to calculate the white balance gain k_{R} corresponding to R (red), the image processing device 100 detects a pixel in which linear polarization degrees (DoLP_{R} and DoLP_{G}) of R (red) and G (green) coincide with each other, from the image captured by the imaging unit 50.

Furthermore, in order to detect a pixel position where

r_{B}=r_{G}
is established, which is required to calculate the white balance gain k_{B} corresponding to B (blue), the image processing device 100 detects a pixel in which linear polarization degrees (DoLP_{B} and DoLP_{G}) of B (blue) of G (green) coincide with each other, from the image captured by the imaging unit 50.

The degree of linear polarization (DoLP) is a ratio (%) of linear polarization included in the observation light (reflection light) 22.

Hereinafter, a description will be given to processing executed by the image processing device 100 in order to detect a pixel position where

r_{R}=r_{G}
is established, which is required to calculate the white balance gain k_{R} corresponding to R (red), that is, processing of detecting a pixel in which linear polarization degrees (DoLP_{R} and DoLP_{G}) of R (red) and G (green) coincide with each other, from the image captured by the imaging unit 50.

The linear polarization degrees (DoLP) of R (red) and G (green) in the observation light (reflection light) 22 are calculated according to the following (Expression 24a) and (Expression 24b).

$$\begin{matrix}[ Formula 5 ] & \\ {DoLP}_{R} = \frac{\sqrt{{s}_{1 R}^{′2} + {s}_{2 R}^{′2}}}{{s}_{0 R}^{′}} & ( Expression 24 a ) \\ {DoLP}_{G} = \frac{\sqrt{{s}_{1 G}^{′2} + {s}_{2 G}^{′2}}}{{s}_{0 G}^{′}} & ( Expression 24 b )\end{matrix}$$

In (Expression 24a) and (Expression 24b) described above, s′_{0R}, s′_{1R}, s′_{2R}, s′_{0G}, s′_{1G}, and s′_{2G} are Stokes parameters of R (red) and G (green) in the observation light (reflection light) 22, and
s′_{0R} and s′_{0G} are light intensity signals of R (red) and G (green) unpolarized light in the observation light (reflection light) 22,
s′_{1R} and s′_{1G} are difference signals of horizontal/vertical linear polarization components of R (red) and G (green) in the observation light (reflection light) 22, and
s′_{2R} and s′_{2G} are difference signals of 45 degree linear polarization components of R (red) and G (green) in the observation light (reflection light) 22.

All of these Stokes parameters are parameters that can be acquired from three images captured by the imaging unit 50 illustrated in FIG. 5, that is, each of the following images.
(a) Color polarized image a
(b) Color polarized image b
(c) Color polarized image c

At the pixel position where the reflectance IR of R (red) and the reflectance r_{G} of G (green) coincide with each other, that is, the pixel position where

r_{R}=r_{G}

is established, the linear polarization degrees (DoLP) of R (red) and G (green) in the observation light (reflection light) 22 coincide with each other. Therefore, in order to detect the pixel position where r_{R}=r_{G} is established, it is only required to detect a pixel in which the linear polarization degree (DoLP_{R}) of R (red) and the linear polarization degree (DoLP_{G}) of G (green) in the observation light (reflection light) 22 coincide with each other.

Hereinafter, a description is given to the reason why the linear polarization degrees (DoLP_{R} and DoLP_{G}) of R (red) and G (green) in the observation light (reflection light) 22 coincide with each other at the pixel position where r_{R}=r_{G} is established.

As described above with reference to FIG. 5, among the Stokes vector S′ of each color indicating polarization states of R (red), G (green), and B (blue) of the observation light (reflection light) 22 corresponding to one point P of the subject 20, the Stokes vector S indicating a polarization state of the irradiation light 11, and the Muller matrix M which is the transformation matrix reflecting the reflection characteristic of the subject 20, the following relational expression is established.

S′=MS

Therefore, the following relational expressions (Expression 13a) to (Expression 13c) described above are also established for individual colors of RGB.

$$\begin{matrix}[ Formula 6 ] & \\ ( \begin{matrix}{s}_{0 R}^{′} \\ {s}_{1 R}^{′} \\ {s}_{2 R}^{′}\end{matrix} ) = {L}_{R} [ {r}_{s} {M}_{s} + {r}_{dR} {M}_{dR} ] ( \begin{matrix}{s}_{0} \\ {s}_{1} \\ {s}_{2}\end{matrix} ) & ( Expression 13 a ) \\ ( \begin{matrix}{s}_{0 G}^{′} \\ {s}_{1 G}^{′} \\ {s}_{2 G}^{′}\end{matrix} ) = {L}_{G} [ {r}_{s} {M}_{s} + {r}_{dG} {M}_{Dg} ] ( \begin{matrix}{s}_{0} \\ {s}_{1} \\ {s}_{2}\end{matrix} ) & ( Expression 13 b ) \\ ( \begin{matrix}{s}_{0 B}^{′} \\ {s}_{1 B}^{′} \\ {s}_{2 B}^{′}\end{matrix} ) = {L}_{B} [ {r}_{s} {M}_{s} + {r}_{dB} {M}_{dB} ] ( \begin{matrix}{s}_{0} \\ {s}_{1} \\ {s}_{2}\end{matrix} ) & ( Expression 13 c )\end{matrix}$$

Note that, in (Expression 13a) to (Expression 13c) described above,
[rₛMₛ+r_{dR}M_{dR}] is the Muller matrix of R (red light),
[rₛMₛ+r_{dG}M_{dG}] is the Muller matrix of G (green light), and
[rₛMₛ+r_{dB}M_{dB}] is the Muller matrix of B (blue light),
and
rₛ represents the specular reflectance rₛ common to each color of R (red), G (green), and B (blue), and
r_{dR}, r_{dG}, and r_{dB} are the diffuse reflectances r_{dR}, r_{dG}, and r_{dB} different for each of colors of R (red), G (green), and B (blue).

Here, in a case where

r_{R}=r_{G},
is established,

$$[ {r}_{s} {M}_{s} + {r}_{dR} {M}_{dR} ] = [ {r}_{s} {M}_{s} + {r}_{dG} {M}_{dG} ]$$

is established. Therefore, the Muller matrix [rₛMₛ+r_{dR}M_{dR}] of R (red light) in (Expression 13a) described above can be replaced with the Muller matrix [rₛMₛ+r_{dG}M_{dG}] of G (green light) in (Expression 13b).

By this replacement, (Expression 13a) and (Expression 13b) can be rewritten as the following (Expression 25a) and (Expression 25b).

$$\begin{matrix}[ Formula 7 ] & \\ \begin{matrix}( \begin{matrix}{s}_{0 R}^{′} \\ {s}_{1 R}^{′} \\ {s}_{2 R}^{′}\end{matrix} ) = {L}_{R} [ {r}_{s} {M}_{s} + {r}_{dR} {M}_{dR} ] ( \begin{matrix}{s}_{0} \\ {s}_{1} \\ {s}_{2}\end{matrix} ) \\ = {L}_{R} [ {r}_{s} {M}_{s} + {r}_{dG} {M}_{dG} ] ( \begin{matrix}{s}_{0} \\ {s}_{1} \\ {s}_{2}\end{matrix} ) \\ = {L}_{R} ( ( \begin{matrix}{s}_{0 G}^{′} \\ {s}_{1 G}^{′} \\ {s}_{2 G}^{′}\end{matrix} ) / {L}_{G} ) = {L}_{R} ( {L}_{G} ( \begin{matrix}{s}_{0}^{′} \\ {s}_{1}^{′} \\ {s}_{2}^{′}\end{matrix} ) / {L}_{G} ) \\ = {L}_{R} ( \begin{matrix}{s}_{0}^{′} \\ {s}_{1}^{′} \\ {s}_{2}^{′}\end{matrix} )\end{matrix} & ( Expression 25 a ) \\ \begin{matrix}( \begin{matrix}{s}_{0 G}^{′} \\ {s}_{1 G}^{′} \\ {s}_{2 G}^{′}\end{matrix} ) = {L}_{G} [ {r}_{s} {M}_{s} + {r}_{dG} {M}_{dG} ] ( \begin{matrix}{s}_{0} \\ {s}_{1} \\ {s}_{2}\end{matrix} ) \\ = {L}_{G} ( ( \begin{matrix}{s}_{0 G}^{′} \\ {s}_{1 G}^{′} \\ {s}_{2 G}^{′}\end{matrix} ) / {L}_{G} ) = {L}_{G} ( {L}_{G} ( \begin{matrix}{s}_{0}^{′} \\ {s}_{1}^{′} \\ {s}_{2}^{′}\end{matrix} ) / {L}_{G} ) \\ = {L}_{G} ( \begin{matrix}{s}_{0}^{′} \\ {s}_{1}^{′} \\ {s}_{2}^{′}\end{matrix} )\end{matrix} & ( Expression 25 b )\end{matrix}$$

From (Expression 25a) and (Expression 25b) described above,
the following relational expressions are derived.

$${s}_{0 R}^{′} = {L}_{R} \cdot {s}_{0}^{′} \\ {s}_{1 R}^{′} = {L}_{R} \cdot {s}_{1}^{′} \\ {s}_{2 R}^{′} = {L}_{R} \cdot {s}_{2}^{′} \\ {s}_{0 G}^{′} = {L}_{G} \cdot {s}_{0}^{′} \\ {s}_{1 G}^{′} = {L}_{G} \cdot {s}_{1}^{′} \\ {s}_{2 G}^{′} = {L}_{G} \cdot {s}_{2}^{′}$$

According to these relational expressions, (Expression 24a) and (Expression 24b) described above, that is, the linear polarization degree (DoLP_{R}) of R (red) and the linear polarization degree (DoLP_{G}) of G (green) in the observation light (reflection light) 22 can be rewritten as the following (Expression 26a) and (Expression 26b).

$$\begin{matrix}[ Formula 8 ] & \\ {DoLP}_{R} = \frac{\sqrt{{s}_{1 R}^{′2} + {s}_{2 R}^{′2}}}{{s}_{0 R}^{′}} = \frac{\sqrt{{L}_{R}^{2} \cdot {s}_{1}^{′2} + {L}_{R}^{2} \cdot {s}_{2}^{′2}}}{{l}_{R} {s}_{0}^{′}} = \frac{\sqrt{{s}_{1}^{′2} + {s}_{2}^{′2}}}{{s}_{0}^{′}} & ( Expression 26 a ) \\ {DoLP}_{G} = \frac{\sqrt{{s}_{1 G}^{′2} + {s}_{2 G}^{′2}}}{{s}_{0 G}^{′}} = \frac{\sqrt{{L}_{G}^{2} \cdot {s}_{1}^{′2} + {L}_{G}^{2} \cdot {s}_{2}^{′2}}}{{l}_{G} {s}_{0}^{′}} = \frac{\sqrt{{s}_{1}^{′2} + {s}_{2}^{′2}}}{{s}_{0}^{′}} & ( Expression 26 b )\end{matrix}$$

The final terms of (Expression 26a) and (Expression 26b) described above coincide with each other.

This indicates that the linear polarization degree (DoLP_{R}) of R (red) and the linear polarization degree (DoLP_{G}) of G (green) in the observation light (reflection light) 22 coincide with each other.

In this way, at the pixel position where the reflectance r_{R} of R (red) and the reflectance r_{G} of G (green) coincide with each other, that is, the pixel position where

r_{R}=r_{G}
is established, the linear polarization degrees (DoLP) of R (red) and G (green) in the observation light (reflection light) 22 coincide with each other. That is, the following relational expression is established.

(DoLP_{R})=(DoLP_{G})

As described above, in order to detect the pixel position where the reflectance r_{R} of R (red) and the reflectance r_{G} of G (green) coincide with each other, that is, the pixel position where

r_{R}=r_{G}
is established, it is only required to detect a pixel position at which the linear polarization degree (DoLP_{R}) of R (red) and the linear polarization degree (DoLP_{G}) of G (green) in the observation light (reflection light) 22 coincide with each other.

The image processing device 100 of the present disclosure is input with the following three images from the imaging unit 50, that is, input with these three types of images illustrated in FIG. 5.
(a) Color polarized image a
(b) Color polarized image b
(c) Color polarized image c

From these images, the image processing device 100 can acquire the Stokes parameters required for calculating the linear polarization degree (DoLP_{R}) of R (red) and the linear polarization degree (DoLP_{G}) of G (green) in the observation light (reflection light) 22.

That is, the image processing device 100 acquires the Stokes parameters (s′_{0R}, s′_{1R}, s′_{2R}, s′_{0G}, s′_{1G}, s′_{2G}) required for calculating the linear polarization degree (DoLP_{R}) of R (red) and the linear polarization degree (DoLP_{G}) of G (green) illustrated in (Expression 24a) and (Expression 24b) described above, from the color polarized image input from the imaging unit 50.

By using the three images input from the imaging unit 50, that is, the images (a) to (c) illustrated in FIG. 5, the image processing device 100 of the present disclosure calculates the linear polarization degree (DoLP_{R}) of R (red) and the linear polarization degree (DoLP_{G}) of G (green) in accordance with (Expression 24a) and (Expression 24b) described above for each pixel position of the input image, and detects a pixel position where these linear polarization degrees coincide with each other.

The pixel position where the linear polarization degree (DoLP_{R}) of R (red) and the linear polarization degree (DoLP_{G}) of G (green) coincide with each other is the pixel position where the reflectance r_{R} of R (red) and the reflectance r_{G} of G (green) coincide with each other, that is, the pixel position where

r_{R}=r_{G}
is established.

In this way, the image processing device 100 of the present disclosure detects the pixel position where the reflectance r_{R} of R (red) and the reflectance r_{G} of G (green) coincide with each other, that is, the pixel position where r_{R}=r_{G} is established, from the image captured by the imaging unit 50.

At the pixel position where r_{R}=r_{G} is established, as described above, the following expression,

$$observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{G} , {L}_{G} {r}_{G} , {L}_{B} {r}_{B} )$$

is established, and
the white balance gain k_{R} to be applied to correction of the pixel value (intensity) of R (red), that is,

$${k}_{R} = ( {L}_{G} / {L}_{R} )$$

can be calculated from the R pixel value (L_{R}r_{G}) and the G pixel value (=L_{G}r_{G}) at this pixel position.

Note that, as described above, the Stokes parameter so that can be acquired from the three types of color polarized images input from the imaging unit 50 illustrated in FIG. 5 is an unpolarized light intensity signal, and the image (s′_{0R}, s′_{0G}, s′_{0B}) is an image including a light intensity signal (luminance signal) corresponding to each of RGB colors. This image can be regarded as the captured image (s′_{0R}, s′_{0G}, s′_{0B}) of the observation light (i_{R}, i_{G}, i_{B}). Accordingly,

$$captured image ( {s}_{0 R}^{′} , {s}_{0 G}^{′} , {s}_{0 B}^{′} ) = observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{G} , {L}_{G} {r}_{G} , {L}_{B} {r}_{B} )$$

is satisfied.

Accordingly,

$${k}_{R} = ( {L}_{G} / {L}_{R} ) = ( {L}_{G} {r}_{G} ) / ( {L}_{R} {r}_{G} ) = ( {s}_{0 G}^{′} , ) / ( {s}_{0 R}^{′} )$$

is satisfied, so that the white balance gain k_{R} to be applied to correction of the pixel value (intensity) of R (red) can be calculated using the RGB pixel values (s′_{0R}, s′_{0G}, s′_{0B}) of the captured image (s′_{0R}, s′_{0G}, s′_{0B}) acquired from multiple color polarized images input from the imaging unit 50 illustrated in FIG. 5.

Note that, as described above, in the present processing example, the white balance gain is set such that, by using the pixel value of G (green) of the captured image as a reference without changing the G pixel value, the white balance gain to be multiplied by the pixel value of R (red) of the captured image is k_{R}, and the white balance gain to be multiplied by the pixel value of B (blue) of the captured image is k_{B}.

The processing described above is an example of calculation processing of the white balance gain k_{R} to be applied to correction of one white balance gain among the white balance gains (k_{R}, 1, k_{B}), that is, the pixel value (intensity) of R (red)

As described above, the processing example described above is a calculation processing example of the white balance gain k_{R} to be applied to correction of the pixel value (intensity) of R (red), but the calculation processing of the white balance gain k_{B} to be applied to correction of the pixel value (intensity) of B (blue) can be similarly executed.

In a case of calculating the white balance gain k_{B} to be applied to correction of the pixel value (intensity) of B (blue), a pixel position where the reflectance r_{B} of B (blue) and the reflectance r_{G} of G (green) coincide with each other, that is, a pixel position where

r_{B}=r_{G}

is established is detected. For this purpose, a pixel position is detected where the linear polarization degree (DoLP_{B}) of B (blue) and the linear polarization degree (DoLP_{G}) of G (green) in the observation light (reflection light) 22 coincide with each other.

At the pixel position where r_{B}=r_{G} is established, as described above, the following expression,

$$observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{R} , {L}_{G} {r}_{G} , {L}_{B} {r}_{G} )$$

is established, and
the white balance gain k_{B} to be applied to correction of the pixel value (intensity) of G (blue), that is,

$${k}_{B} = ( {L}_{G} / {L}_{B} )$$

can be calculated from the B pixel value (L_{B}r_{G}) and the G pixel value (=L_{G}r_{G}) at this pixel position.

As described above, the RGB pixel values (s′_{0R}, s′_{0G}, s′_{0B}) of the captured image (s′_{0R}, s′_{0G}, s′_{0B}) acquired from the multiple color polarized images input from the imaging unit 50 illustrated in FIG. 5 can be regarded as the observation light (i_{R}, i_{G}, i_{B}) Accordingly,

$$captured image ( {s}_{0 R}^{′} , {s}_{0 G}^{′} , {s}_{0 B}^{′} ) = observation light ( {i}_{R} , {i}_{G} , {i}_{B} ) = ( {L}_{R} {r}_{R} , {L}_{G} {r}_{G} , {L}_{B} {r}_{B} ) = ( {L}_{R} {r}_{G} , {L}_{G} {r}_{G} , {L}_{B} {r}_{G} )$$

is satisfied.

Accordingly,

$${k}_{B} = ( {L}_{G} / {L}_{B} ) = ( {L}_{G} {r}_{G} ) / ( {L}_{B} {r}_{G} ) = ( {s}_{0 G}^{′} , ) / ( {s}_{0 B}^{′} )$$

is satisfied, so that the white balance gain k_{B} to be applied to correction of the pixel value (intensity) of B (blue) can be calculated using the RGB pixel values (s′_{0R}, s′_{0G}, s′_{0B}) of the captured image (s′_{0R}, s′_{0G}, s′_{0B}) acquired from multiple color polarized images input from the imaging unit 50 illustrated in FIG. 5.

As described above, the white balance gain (k_{R}, 1, k_{B}) can be defined as follows using the light source color (L_{R}, L_{G}, L_{B}) of the light source 10.

$$White balance gain ( {k}_{R} , 1 , {k}_{B} ) = ( ( {L}_{G} / {L}_{R} ) , 1 , ( {L}_{G} / {L}_{B} ) )$$

The captured image (s′_{0R}, s′_{0G}, s′_{0B}) acquired from the multiple color polarized images input from the imaging unit 50 illustrated in FIG. 5 has the pixel value (s′_{0R}, s′_{0G}, s′_{0B}) including a luminance signal corresponding to an RGB pixel value. By multiplying this pixel value by the calculated white balance gain (k_{R}, 1, k_{B}), the white balance adjustment processing is executed, and an image after white balance adjustment can be generated.

In the embodiment described above,
a coincident pixel of the linear polarization degree (DoLP_{R}) of R (red) and the linear polarization degree (DoLP_{G}) of G (green) in the observation light (reflection light) 22 has been detected, a coincident pixel of reflectances r_{R} and r_{G} of R (red) and G (green) has been detected, and further,
a coincident pixel of the linear polarization degree (DoLP_{B}) of B (blue) and the linear polarization degree (DoLP_{G}) of G (green) in the observation light (reflection light) 22 has been detected, and a coincident pixel of the reflectances r_{B} and r_{G} of B (blue) and G (green) has been detected.

That is, by detecting a coincident pixel of linear polarization degrees (DoLP) of different colors, the detection processing has been performed for the pixel position where the reflectances of the two colors in RGB of the subject 20 coincide with each other and only the influence of the light source color (L_{R}, L_{G}, L_{B}) occurs.

Specifically, in the captured image (s′_{0R}, s′_{0G}, s′_{0B}), the detection processing of the pixel position where only the influence of the light source color (L_{R}, L_{G}, L_{B}) occurs has been performed.

For such pixel position detection processing, it is also possible to apply other methods instead of the processing of detecting a coincident pixel of the linear polarization degree (DoLP).

For example, the image processing device 100 can also perform the detection processing of the pixel position where a color change of the captured image is caused only by the influence of the light source color (L_{R}, L_{G}, L_{B}), by calculating “n-th component (parameter)/m-th component (parameter) (n #m)” by using two different components (parameters) among Stokes parameters obtained from images input from the imaging unit 50, that is, the following three types of images illustrated in FIG. 5.
(a) Color polarized image a
(b) Color polarized image b
(c) Color polarized image c

Specifically, first, each component ratio (parameter ratio) of the Stokes parameter is calculated according to (Expression 27a), (Expression 27b), and (Expression 27c) shown below.

$$\begin{matrix}[ Formula 9 ] & \\ 0 - th {component}_{R} / First {component}_{R} = \frac{{L}_{R} {s}_{0}^{′}}{{L}_{R} {s}_{1}^{′}} = \frac{{s}_{0}^{′}}{{s}_{1}^{′}} & ( Expression 27 a ) \\ 0 - th {component}_{G} / First {component}_{G} = \frac{{L}_{G} {s}_{0}^{′}}{{L}_{G} {s}_{1}^{′}} = \frac{{s}_{0}^{′}}{{s}_{1}^{′}} & ( Expression 27 b ) \\ 0 - th {component}_{B} / First {component}_{B} = \frac{{L}_{B} {s}_{0}^{′}}{{L}_{B} {s}_{1}^{′}} = \frac{{s}_{0}^{′}}{{s}_{1}^{′}} & ( Expression 27 c )\end{matrix}$$

Moreover, a pixel position where (Expression 28a) or (Expression 28b) below is established is detected.

$$\begin{matrix}[ Formula 10 ] & \\ 0 - th {component}_{R} / First {component}_{R} = 0 - th {component}_{G} / First {component}_{G} & ( Expression 28 a ) \\ 0 - th {component}_{B} / First {component}_{B} = 0 - th {component}_{G} / First {component}_{G} & ( Expression 28 b )\end{matrix}$$

The pixel position where (Expression 28a) described above is established is a pixel position where the reflectances of R (red) and G (green) coincide with each other, and a color change is caused only by the influence of the light source color (L_{R}, LG, L_{B}) for R (red) and G (green) of the image (s′_{0R}, s′_{0G}, s′_{0B})

Furthermore, the pixel position where (Expression 28b) described above is established is a pixel position where the reflectances of G (blue) and G (green) coincide with each other, and a color change is caused only by the influence of the light source color (L_{R}, L_{G}, L_{B}) for B (blue) and G (green) of the image (s′_{0R}, s′_{0G}, s′_{0B})

By using such a technique, processing may be performed in which the pixel position where a color change of the captured image is caused only by the influence of the light source color (L_{R}, L_{G}, L_{B}) is detected, and the white balance gains k_{R} and k_{B} are calculated from the pixel values set these pixel positions.

### 3-2. White Balance Gain Calculation Processing Example 2 Using Polarization Information

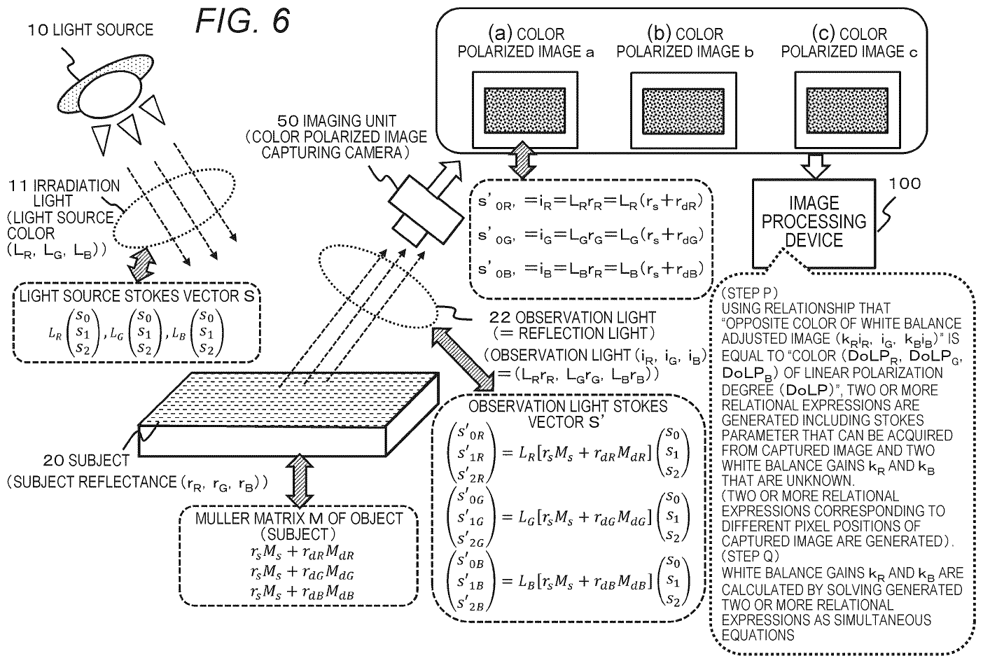

Next, with reference to FIG. 6 and subsequent figures, White balance gain calculation processing example 2 using polarization information will be described.

As illustrated in FIG. 6, White balance gain calculation processing example 2 is a processing example in which the image processing device 100 executes the following processing steps P and Q to calculate a white balance gain.

### (Step P) Relational Expression Generation Processing

Using a relationship that “an opposite color of the white balance adjusted image (k_{R}i_{R}, i_{G}, k_{B}i_{B})” is equal to “a color (DoLP_{R}, DoLP_{G}, DoLP_{B}) of the linear polarization degree (DoLP)”, two or more relational expressions are generated including a Stokes parameter that can be acquired from the captured image and two white balance gains k_{R} and k_{B} that are unknown. (Two or more relational expressions corresponding to different pixel positions of the captured image are generated).

(Step Q) The white balance gains k_{R} and k_{B} are calculated by solving the two or more relational expressions generated in step P as simultaneous equations.

Hereinafter, with reference to FIG. 6, this White balance gain calculation processing example 2 will be described in detail.

Similarly to the description with reference to FIG. 5, FIG. 6 illustrates the light source 10 and the subject 20, and further illustrates the imaging unit (color polarized image capturing camera) 50 and the image processing device 100.

The irradiation light 11 of the light source 10 is reflected by the subject 20, and the imaging unit (color polarized image capturing camera) 50 captures an image of only a specific polarization component from the observation light 22 including the reflection light, and inputs the captured color polarized image to the image processing unit 100.

The image processing unit 100 calculates a white balance gain by using the color polarized image captured by the imaging unit (color polarized image capturing camera) 50, and executes the white balance adjustment processing by using the calculated white balance gain.

Configurations of the light source 10, the subject 20, and the imaging unit (color polarized image capturing camera) 50 are similar to those in FIG. 5 described above, and thus will be described in a simplified manner.

As illustrated in FIG. 6, a light source Stokes vector S indicating a polarization state of each of RGB colors of the irradiation light 11 of the light source 10 is similar to FIG. 5 described above, and is expressed by the above-described expression (Expression 11).

As illustrated in FIG. 6, a Muller matrix M indicating a reflection characteristic of the subject 20 is also similar to FIG. 5 described above, and is expressed by (Expression 12a) to (Expression 12c) described above.

A Stokes vector S′ indicating a polarization state of the observation light (reflection light) 22 corresponding to one point P of the subject 20 is to be a Stokes vector according to the following relational expression.

S′=MS

As illustrated in FIG. 6, the Stokes vector S′ of each color of R (red), G (green), and B (blue) of the observation light (reflection light) 22 is similar to FIG. 5 described above, and can be expressed as (Expression 13a) to (Expression 13c) described above.

The imaging unit (color polarized image capturing camera) 50 captures multiple color polarized images for acquiring Stokes parameters constituting Stokes vectors of the individual colors indicating polarization states of R (red), G (green), and B (blue) of the observation light (reflection light) 22, that is,

S′_{R}=(s′_{0R},s′_{1R},s′_{2R})^{T},

S′_{G}=(s′_{0G},s′_{1G},s′_{2G})^{T},

S′_{B}=(s′_{0B},s′_{1B},s′_{2B})^{T},
and outputs the multiple captured color polarized images to the image processing device 100.

That is, the color polarized images are the following three types of images illustrated in FIG. 6.
(a) Color polarized image a
(b) Color polarized image b
(c) Color polarized image c

The image processing device 100 is input with these three types of images and executes white balance gain calculation processing. Furthermore, the white balance adjustment processing of the captured image is executed using the calculated white balance gain.

Note that the white balance gain corresponds to a multiplication parameter for the pixel value (R, G, B) of each color of the captured image.

By using the pixel value of G (green) of the captured image as a reference without changing the G pixel value, the pixel value of R (red) of the captured image is multiplied by the gain k_{R}, and the pixel value of B (blue) of the captured image is multiplied by the gain k_{B}, thereby a corrected pixel value after white balance adjustment can be calculated.

As described above, a relational expression between the white balance gain (k_{R}, 1, k_{B}) for eliminating the influence of the light source color (L_{R}, L_{G}, L_{B}) and the light source color (L_{R}, L_{G}, L_{B}) is to be the following relational expression.

$$White balance gain ( {k}_{R} , 1 , {k}_{B} ) = ( ( {L}_{G} / {L}_{R} ) , 1 , ( {L}_{G} / {L}_{B} ) )$$

Details of the white balance gain calculation processing performed by the image processing device 100 will be described.

As described above, the image processing device 100 executes the white balance gain calculation processing by executing the following steps P and Q.

### (Step P) Relational Expression Generation Processing

Using a relationship that “an opposite color of the white balance adjusted image (k_{R}i_{R}, i_{G}, k_{B}i_{B})” is equal to “a color (DoLP_{R}, DoLP_{G}, DoLP_{B}) of the linear polarization degree (DoLP)”, two or more relational expressions are generated including a Stokes parameter that can be acquired from the captured image and two white balance gains k_{R} and k_{B} that are unknown. Two or more relational expressions corresponding to different pixel positions of the captured image are generated.

(Step Q) The white balance gains k_{R} and k_{B} are calculated by solving the two or more relational expressions generated in step P as simultaneous equations.

Before the description of the processing steps P and Q described above, first, a description will be given to the reason why the relationship that “an opposite color of the white balance adjusted image (k_{R}i_{R}, i_{G}, k_{B}i_{B})” is equal to “a color (DoLP_{R}, DoLP_{G}, DoLP_{B}) of the linear polarization degree (DoLP)” is established.

Note that “an opposite color of the white balance adjusted image (k_{R}i_{R}, i_{G}, k_{B}i_{B})” is an opposite color of the white balance adjusted image (k_{R}i_{R}, i_{G}, k_{B}i_{B}) generated by applying the white balance gain (k_{R}, 1, k_{B}) to the captured image (i_{R}, i_{G}, i_{B}) of the observation light (=reflection light) 22 illustrated in FIG. 6. The opposite color is a color located at an opposite position in the hue circle. When two colors having an opposite color relationship are mixed, the color becomes achromatic.

“Opposite color (R, G, B) of white balance adjusted image (k_{R}i_{R}, i_{G}, k_{B}i_{B})”=“color (DoLP_{R}, DoLP_{G}, DoLP_{B}) of linear polarization degree (DoLP)”

The reason why this relationship is established is that phases of specular polarized light and diffused polarized light generated by reflection on the subject 20 are shifted from each other, and further, in a case where intensity of the specular polarized light and intensity of the diffused polarized light are compared, the intensity of the specular polarized light is large, that is, the specular polarization degree >the diffusion polarization degree is satisfied.

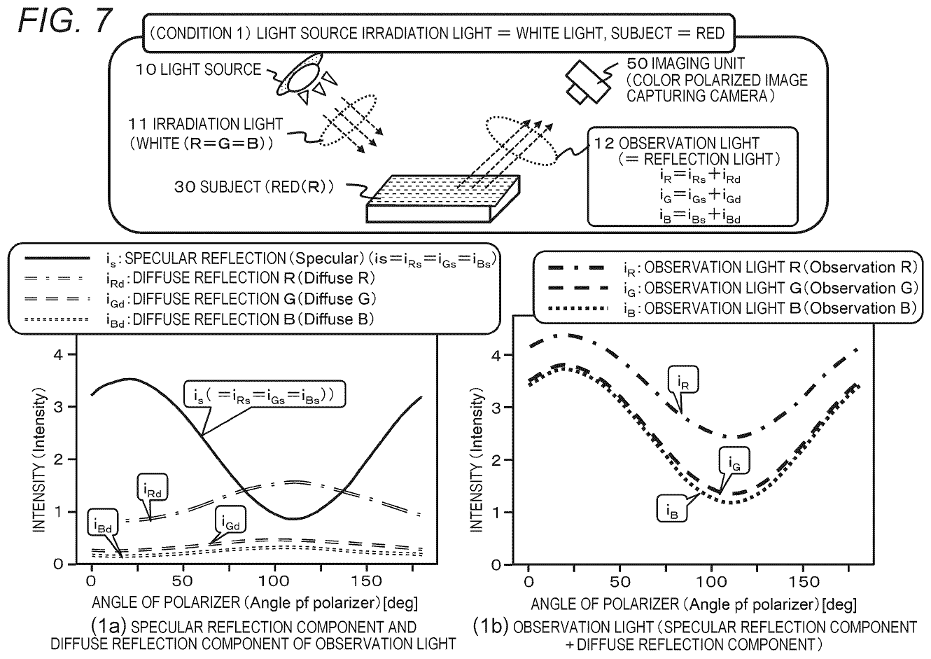

The reason why this relationship is established will be described later with reference to FIG. 7 and subsequent figures.

Hereinafter, on the premise that this relationship is established, the processing step executed by the image processing device 100 of the present disclosure, that is, the following is executed.

### (Step P) Relational Expression Generation Processing

Using a relationship that “an opposite color of the white balance adjusted image (k_{R}i_{R}, i_{G}, k_{B}i_{B})” is equal to “a color (DoLP_{R}, DoLP_{G}, DoLP_{B}) of the linear polarization degree (DoLP)”, two or more relational expressions are generated including a Stokes parameter that can be acquired from the captured image and two white balance gains k_{R} and k_{B} that are unknown. (Two or more relational expressions corresponding to different pixel positions of the captured image are generated).

(Step Q) The white balance gains k_{R} and k_{B} are calculated by solving the two or more relational expressions generated in step P as simultaneous equations.

Details of the processing steps P and Q described above will be described.

First, by using the relationship that “an opposite color of the white balance adjusted image (k_{R}i_{R}, i_{G}, k_{B}i_{B})” is equal to “a color (DoLP_{R}, DoLP_{G}, DoLP_{B}) of the linear polarization degree (DoLP)”, the image processing device 100 generates two or more relational expressions including a Stokes parameter that can be acquired from the captured image and two white balance gains k_{R} and k_{B} that are unknown. Two or more relational expressions corresponding to different pixel positions of the captured image are generated.

As described above, “an opposite color of the white balance adjusted image (k_{R}i_{R}, i_{G}, k_{B}i_{B})” is an opposite color of the white balance adjusted image (k_{R}i_{R}, i_{G}, k_{B}i_{B}) generated by applying the white balance gain (k_{R}, 1, k_{B}) to the captured image (i_{R}, i_{G}, i_{B}) of the observation light (=reflection light) 22 (i_{R}, i_{G}, i_{B}) illustrated in FIG. 6.

Each value (luminance value) of RGB constituting “an opposite color (RGB) of the white balance adjusted image (k_{R}i_{R}, i_{G}, k_{B}i_{B})” is defined by the following (Expression 31).

$$[ Formula 11 ] \\ Opposite color ( R , G , B ) of white balance image$$

$$R = - \frac{{k}_{R} {i}_{R} - \overline{I}}{\sqrt{{( {k}_{R} {i}_{R} - \overline{I} )}^{2} {( {i}_{G} - \overline{I} )}^{2} + {( {k}_{B} {i}_{B} - \overline{I} )}^{2}}} \\ G = - \frac{{i}_{G} - \overline{I}}{\sqrt{{( {k}_{R} {i}_{R} - \overline{I} )}^{2} {( {i}_{G} - \overline{I} )}^{2} + {( {k}_{B} {i}_{B} - \overline{I} )}^{2}}} \\ B = - \frac{{k}_{B} {i}_{B} - \overline{I}}{\sqrt{{( {k}_{R} {i}_{R} - \overline{I} )}^{2} {( {i}_{G} - \overline{I} )}^{2} + {( {k}_{B} {i}_{B} - \overline{I} )}^{2}}} \qquad ( Expression 31 )$$

$$Where , \overline{I} = \frac{{i}_{R} + {i}_{G} + {i}_{B}}{3}$$

Furthermore, “color (DoLP_{R}, DoLP_{G}, DoLP_{B}) of linear polarization degree (DoLP)” corresponds to a color of a linear polarization component included in the observation light (=reflection light) 22 (i_{R}, i_{G}, i_{B}) illustrated in FIG. 6.

Each value (luminance value) of RGB constituting “color (DoLP_{R}, DoLP_{G}, DoLP_{B}) of linear polarization degree (DoLP)” is defined by the following (Expression 32).

$$[ Formula 12 ] \\ Color ( {DoLP}_{R} , {DoLP}_{G} , {DoLP}_{B} ) of linear polarization degree ( DoLP )$$

$${DoLP}_{R} = \frac{{DoLP}_{R} - \overline{DoLP}}{\sqrt{{( {DoLP}_{R} - \overline{DoLP} )}^{2} + {( {DoLP}_{G} - \overline{DoLP} )}^{2} + {( {DoLP}_{B} - \overline{DoLP} )}^{2}}} \\ {DoLP}_{G} = \frac{{DoLP}_{G} - \overline{DoLP}}{\sqrt{{( {DoLP}_{R} - \overline{DoLP} )}^{2} + {( {DoLP}_{G} - \overline{DoLP} )}^{2} + {( {DoLP}_{B} - \overline{DoLP} )}^{2}}} \\ {DoLP}_{B} = \frac{{DoLP}_{B} - \overline{DoLP}}{\sqrt{{( {DoLP}_{R} - \overline{DoLP} )}^{2} + {( {DoLP}_{G} - \overline{DoLP} )}^{2} + {( {DoLP}_{B} - \overline{DoLP} )}^{2}}} \qquad ( Expression 32 )$$

$$Where , \overline{DoLP} = \frac{{DoLP}_{R} + {DoLP}_{G} + {DoLP}_{B}}{3}$$

Note that (Expression 31) and (Expression 32) described above are both calculation expressions for RGB values after normalization (mean=0, norm=1) processing. Expressions indicated as denominators of (Expression 31) and (Expression 32) correspond to coefficients for the normalization processing.

The relational expression that “an opposite color (RGB) of the white balance adjusted image (k_{R}i_{R}, i_{G}, k_{B} i_{B})” expressed by the above-described (Expression 31) is equal to “a color (DoLP_{R}, DoLP_{G}, DoLP_{B}) of the linear polarization degree (DoLP)” expressed by the above-described (Expression 32) is expressed by the following (Expression 33).

$$\begin{matrix}[ Formula 13 ] & \\ - \frac{{k}_{R} {i}_{R} - \overline{I} , {i}_{G} - \overline{I} , {k}_{B} {i}_{B} - \overline{I}}{\sqrt{{( {k}_{R} {i}_{R} - \overline{I} )}^{2} + {( {i}_{G} - \overline{I} )}^{2} + {( {k}_{B} {i}_{B} - \overline{I} )}^{2}}} = \frac{{DoLP}_{R} - \overline{DoLP} , {DoLP}_{G} - \overline{DoLP} , {DoLP}_{B} - \overline{DoLP}}{\sqrt{{( {DoLP}_{R} - \overline{DoLP} )}^{2} + {( {DoLP}_{G} - \overline{DoLP} )}^{2} + {( {DoLP}_{B} - \overline{DoLP} )}^{2}}} & ( Expression 33 )\end{matrix}$$

$$Where , \overline{I} = \frac{{i}_{R} + {i}_{G} + {i}_{B}}{3} , \overline{DoLP} = \frac{{DoLP}_{R} + {DoLP}_{G} + {DoLP}_{B}}{3}$$

Note that the left side of the above-described (Expression 33) is an expression collectively indicating “an opposite color (RGB) of the white balance adjusted image (k_{R}i_{R}, i_{G}, k_{B}i_{B})” as one.

The right side of the above-described (Expression 33) is an expression collectively indicating “a color of the linear polarization degree (DoLP) (DoLP_{R}, DoLP_{G}, DoLP_{B})”.

When the above-described (Expression 33) is rearranged, the following (Expression 34) can be obtained.

$$\begin{matrix}[ Formula 14 ] & \\ ( {DoLP}_{R} - {DoLP}_{B} ) {i}_{G} + ( {DoLP}_{B} - {DoLP}_{G} ) {i}_{R} {k}_{R} + ( {DoLP}_{G} - {DoLP}_{R} ) {i}_{B} {k}_{B} = 0 & ( Expression 34 )\end{matrix}$$

DoLP_{R}, DoLP_{G}, and DoLP_{B} in (Expression 34) described above are values that can be calculated using a Stokes parameter that can be acquired from a color polarized image captured by the imaging unit 50, as shown in (Expression 35a) to (Expression 35c) below.

$$\begin{matrix}[ Formula 15 ] & \\ {DoLP}_{R} = \frac{\sqrt{{s}_{1 R}^{′2} + {s}_{2 R}^{′2}}}{{s}_{0 R}^{′}} & ( Expression 35 a ) \\ {DoLP}_{G} = \frac{\sqrt{{s}_{1 G}^{′2} + {s}_{2 G}^{′2}}}{{s}_{0 G}^{′}} & ( Expression 35 b ) \\ {DoLP}_{B} = \frac{\sqrt{{s}_{1 B}^{′2} + {s}_{2 B}^{′2}}}{{s}_{0 B}^{′}} & ( Expression 35 c )\end{matrix}$$

Furthermore, (i_{R}, i_{G}, i_{B}) in the above-described (Expression 34) can be replaced with the pixel value (s′_{0R}, s′_{0G}, s′_{0B}) of an image including the Stokes parameter so that can be acquired from multiple color polarized images captured by the imaging unit 50.

As described above, the Stokes parameter s′₀ corresponds to a light intensity signal (luminance signal) of unpolarized light in the observation light 22, and the image (s′_{0R}, s′_{0G}, s′_{0B}) is a signal having an intensity ratio similar to that of the observation light (i_{R}, i_{G}, i_{B})

As a result, unknowns included in the relational expression shown in (Expression 34) described above are only the two white balance gains k_{R} and k_{B}.

Therefore, by generating and solving two or more relational expressions shown in (Expression 34) described above as simultaneous equations, the two white balance gains k_{R} and k_{B} can be calculated.

That is, the two white balance gains k_{R} and k_{B} can be calculated by generating the relational expression shown in (Expression 34) described above for two or more pixel positions.

The image processing device 100 applies the white balance gains k_{R} and k_{B} calculated by these processes to the image captured by the imaging unit 50, to execute the white balance adjustment processing.

Note that, as described above, the white balance gain (k_{R}, 1, k_{B}) can be defined as follows using the light source color (L_{R}, L_{G}, L_{B}) of the light source 10.

$$White balance gain ( {k}_{R} , 1 , {k}_{B} ) = ( ( {L}_{G} / {L}_{R} ) , 1 , ( {L}_{G} / {L}_{B} ) )$$

As described above, it is possible to generate the captured image (s′_{0R}, s′_{0G}, s′_{0B}) including luminance signals corresponding to RGB pixel values on the basis of a color polarized image which is an image captured by the imaging unit 50 illustrated in FIG. 6. By multiplying the pixel value of the captured image (s′_{0R}, s′_{0G}, s′_{0B}) by the white balance gain (k_{R}, 1, k_{B}) calculated by the above-described processing, the white balance adjustment processing is executed, and an image after white balance adjustment can be generated.

Next, with reference to FIG. 7 and subsequent figures, the reason why the relationship as the premise of the above-described processing, that is, the reason why this relationship

“opposite color (R,G,B) of white balance adjusted image (k_{R}i_{R},i_{G},k_{B}i_{B})”=“color(DoLP_{R},DoLP_{G},DoLP_{B}) of linear polarization degree (DoLP)”
is established will be described.

As described above, the reason why the relationship described above is established is that phases of specular polarized light and diffused polarized light generated by reflection on the subject 20 are shifted from each other, and further, in a case where intensity of the specular polarized light and intensity of the diffused polarized light are compared, the intensity of the specular polarized light is large, that is, the specular polarization degree >the diffusion polarization degree is satisfied.

A specific example will be described with reference to FIG. 7 and subsequent figures.

FIG. 7 is a diagram illustrating an analysis processing example of the observation light 12 (i_{R}, i_{G}, i_{B}) in a case where the irradiation light 11 of the light source 10 is white (R=G=B) and the subject 20 is red, as illustrated in the upper part of FIG. 7 (Condition 1).

In the setting of (Condition 1), since the irradiation light 11 of the light source 10 is white (R=G=B), an image captured by the imaging unit (camera) 50 is to be an image in which a color change due to the light source color does not occur. That is, an image that does not require white balance adjustment reflecting the color of the subject 20 (=white balance adjusted image) is captured.

Two graphs illustrated in the lower part of FIG. 7 are analysis processing data of the observation light (i_{R}, i_{G}, i_{B}), and are individual pieces of the following analysis data.
(1a) Polarizer-angle-corresponding intensity data of a specular reflection component and a diffuse reflection component of observation light
(1b) Polarizer-angle-corresponding intensity data of observation light (specular reflection component+diffuse reflection component)

In each graph, the horizontal axis represents a deflection angle (deg), and the vertical axis represents intensity.

Note that the specular reflection component of the observation light reflects a color component of the light source, and the diffuse reflection component reflects a color component of the subject.

The condition setting illustrated in FIG. 7 is, as illustrated in the upper part (Condition 1) of FIG. 7, setting in which the irradiation light 11 of the light source 10 is white (R=G=B), and the subject 20 is red.

Therefore, in “(1a) Polarizer-angle-corresponding intensity data of a specular reflection component and a diffuse reflection component of observation light”, the specular reflection component (is) of the observation light is illustrated as one graph common to RGB, and the diffuse reflection component (i_{Rd}, i_{Gd}, i_{Bd}) is illustrated as three individual graphs of RGB. Among the diffuse reflection components (i_{Rd}, i_{Gd}, i_{Bd}), the diffuse reflection component (i_{Rd}) of B (red) is the largest, which reflects the color (red) of the subject.

As described above, the graph illustrated in “(1a) polarizer-angle-corresponding intensity data of a specular reflection component and a diffuse reflection component of observation light” is a graph individually illustrating each intensity of the specular reflection component is (=i_{Rs}=i_{G}, =i_{Bs}) and the diffuse reflection component (i_{Rd}, i_{Gd}, i_{Bd}) according to an angle of the polarizer of each of RGB colors of the observation light (i_{R}, i_{G}, i_{B}).

In this graph, it is understood that formation positions of peaks and valleys of the specular reflection component iₛ(=i_{Rs}=i_{G}, =i_{Bs}) and the diffuse reflection component (i_{Rd}, i_{Gd}, i_{Bd}) are shifted, and phases of the specular polarized light and the diffuse polarized light are shifted. Furthermore, it is understood that, in a case where the intensity of the specular polarized light and the intensity of the diffused polarized light are compared, the intensity of the specular polarized light is high, that is, the specular polarization degree >the diffusion polarization degree is satisfied.

Moreover, the graph illustrated in “(1b) polarizer-angle-corresponding intensity data of observation light (specular reflection component+diffuse reflection component)” is a graph illustrating total intensity obtained by adding the specular reflection component and the diffuse reflection component according to an angle of the polarizer of each of RGB colors of the observation light (i_{R}, i_{G}, i_{B}).

Note that the specular reflection component according to the angle of the polarizer of each of RGB colors is solid line data (iₛ) in the graph of (1a), and the diffuse reflection component is three pieces of data (i_{Rd}, i_{Gd}, i_{Bd}) corresponding to RGB such as a dotted line illustrated in the graph of (1a).

That is, an intensity signal i_{R} of R (red) illustrated in the graph of (1b) corresponds to a sum of iₛ(=i_{R}s) and i_{Rd} illustrated in the graph of (1a).

Similarly, an intensity signal i_{G} of G (green) corresponds to a sum of iₛ(=i_{Gs}) and i_{Gd} illustrated in the graph of (1a).

Similarly, an intensity signal i_{B} of B (blue) corresponds to a sum of iₛ(=i_{Bs}) and i_{Bd} illustrated in the graph of (1a).

A color of an image captured by the imaging unit (camera) 50 is set according to the observation light (i_{R}, i_{G}, i_{B}) intensity of the graph illustrated in this “(1b) observation light (specular reflection component+diffuse reflection component)”.

As understood from the graph illustrated in “(1a) a specular reflection component and a diffuse reflection component of observation light”, when the intensity is compared among the diffuse reflection components (i_{Rd}, i_{Gd}, i_{Bd}) of the individual colors of RGB, the diffuse reflection component (i_{Rd}) of R (red) is larger than the diffuse reflection components (i_{Gd}, i_{Bd}) of G (green) and B (blue).

As a result, regarding the intensity of the observation light (i_{R}, i_{G}, i_{B}) of the graph indicated by “(1b) observation light (specular reflection component+diffuse reflection component)” as well, the observation light (i_{R}) of R (red) is larger than the observation light (i_{G}, i_{B}) of G (green) and B (blue).

This is because the irradiation light 11 of the light source 10 is white (R=G=B), and the subject 20 is red. In this case, the image captured by the imaging unit (camera) 50 is an image in which a color according to the observation light (i_{R}, i_{G}, i_{B}) intensity of the graph illustrated in this “(1b) observation light (specular reflection component+diffuse reflection component)” is set, that is, an image accurately reflecting the color (red) of the subject 20.

In the setting of (Condition 1) illustrated in FIG. 7, the irradiation light 11 of the light source 10 is white (R=G=B). Therefore, an image captured by the imaging unit (camera) 50 is an image in which a color change due to the light source color does not occur, and an image (=image with white balance adjustment) that does not require white balance adjustment reflecting the color of the subject 20 is captured.

Note that, in the graph illustrated in “(1b) observation light (specular reflection component+diffuse reflection component)” in FIG. 7, an amplitude of the intensity reflects magnitude of the polarization degree (DoLP). That is, the larger the amplitude of the intensity, the larger the polarization degree (DoLP).

Using the white balance gains k_{R} and k_{B} and the observation light (i_{R}, i_{G}, i_{B}) observed in (Condition 1) illustrated in FIG. 7, that is, in the setting in which the irradiation light 11 of the light source 10 is white (R=G=B) and the subject 20 is red, each RGB value is calculated according to each of the expressions (Expression 31) and (Expression 32) described above.

That is, individual RGB values of the following are calculated.

$$( Expression 31 ) = “ opposite color ( R , G , B ) of white balance adjusted image ( {k}_{R} {i}_{R} , {i}_{G} , {k}_{B} {i}_{B} ) ” \\ ( Expression 32 ) = “ color ( {DoLP}_{R} , {DoLP}_{G} , {DoLP}_{B} ) of linear polarization degree ( DoLP ) ”$$

Note that, (Condition 1) illustrated in FIG. 7 has setting in which the irradiation light 11 of the light source 10 is white (R=G=B), and an image that does not require white balance adjustment is captured. Therefore, both the white balance gains k_{R} and k_{B} are calculated as k_{R}=k_{B}=1.

As calculation results of this, the following has been obtained.

$$( Expression 31 ) = “ opposite color ( R , G , B ) of white balance adjusted image ( {k}_{R} {i}_{R} , {i}_{G} , {k}_{B} {i}_{B} ) ” = ( - 0.81 , 0.29 , 0.51 ) \\ ( Expression 32 ) = “ color ( {DoLP}_{R} , {DoLP}_{G} , {DoLP}_{B} ) of linear polarization degree ( DoLP ) ” = ( - 0.81 , 0.32 , 0.49 )$$

From the above-described results, it is proved that (Expression 31)≈(Expression 32), that is,
“opposite color (R, G, B) of white balance adjusted image (k_{R}i_{R}, i_{G}, k_{B}i_{B})”
≈“color (DoLP_{R}, DoLP_{G}, DoLP_{B}) of linear polarization degree (DoLP)” is established.

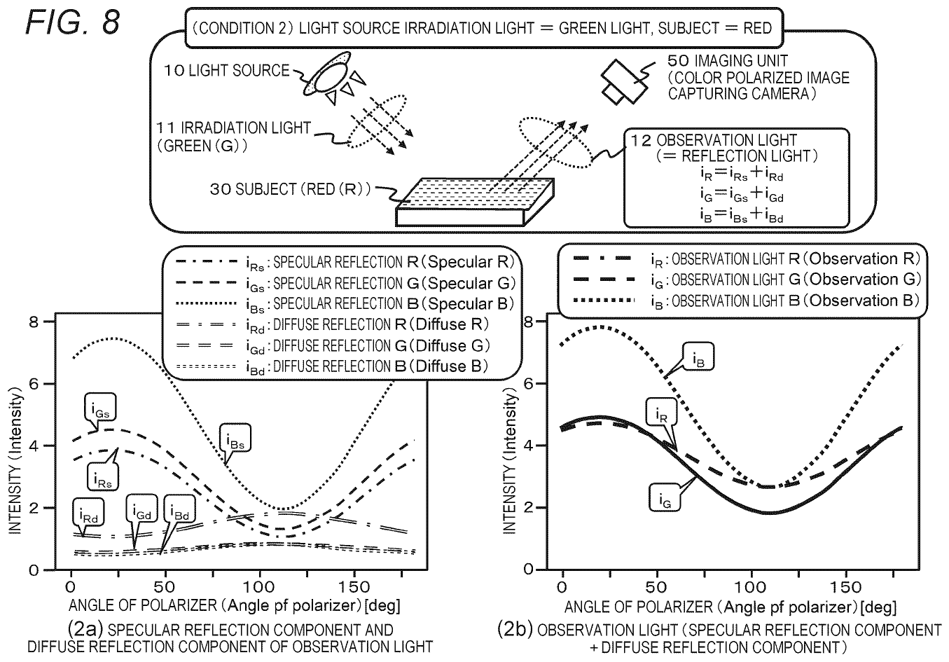

FIG. 8 illustrates an example of a condition setting different from (Condition 1) illustrated in FIG. 7, that is, a case where the light source 10 is not white (R=G=B) and the image captured by the imaging unit 50 is not an image (=image after white balance adjustment) highly accurately reflecting the color of the subject 20.

FIG. 8 illustrates an analysis processing example of the observation light 12 (i_{R}, i_{G}, i_{B}) in a case where the irradiation light 11 of the light source 10 is green (G) and the subject 20 is red, as illustrated in the upper part of FIG. 8 (Condition 2).

In the setting of (Condition 2), since the irradiation light 11 of the light source 10 is green (G), an image captured by the imaging unit (camera) 50 is an image in which a color change due to the light source color occurs. That is, an image that requires white balance adjustment reflecting the color of the subject 20 is captured.

Similarly to FIG. 7, the lower part of FIG. 8 illustrates each piece of the following analysis data.
(2a) Polarizer-angle-corresponding intensity data of a specular reflection component and a diffuse reflection component of observation light
(2b) Polarizer-angle-corresponding intensity data of observation light (specular reflection component+diffuse reflection component)

In each graph, the horizontal axis represents a deflection angle (deg), and the vertical axis represents intensity.

The graph illustrated in “(2a) a specular reflection component and a diffuse reflection component of observation light” is a graph individually illustrating each intensity of the specular reflection component (i_{Rs}, i_{G}, i_{Bs}) and the diffuse reflection component (i_{Rd}, i_{Gd}, i_{Bd}) according to an angle of the polarizer of each of RGB colors of the observation light (i_{R}, i_{G}, i_{B}). In the present example, unlike the example illustrated in FIG. 7, the specular reflection component (i_{Rs}, i_{G}, i_{Bs}) according to the angle of the polarizer of each of RGB colors is different for each of RGB colors.

This is because, as described above, the specular reflection component of the observation light reflects a color component of the light source, and the diffuse reflection component reflects a color component of the subject. Further, in the condition setting illustrated in FIG. 8, as illustrated in the upper part (Condition 2) of FIG. 8, since the irradiation light 11 of the light source 10 is not white (R=G=B) but green (G), the specular reflection component (i_{Rs}, i_{G}, i_{Bs}) reflecting the color component of the light source is different for each of RGB colors.

The graph illustrated in “(2b) observation light (specular reflection component+diffuse reflection component)” is a graph illustrating total intensity obtained by adding the specular reflection component and the diffuse reflection component according to an angle of the polarizer of each of RGB colors of the observation light (i_{R}, i_{G}, i_{B}).

The color of the image captured by the imaging unit (camera) 50 is set according to the observation light (i_{R}, i_{G}, i_{B}) intensity of the graph illustrated in this “(2b) observation light (specular reflection component+diffuse reflection component)”.

The intensity signal i_{R} of R (red) illustrated in the graph of (2b) corresponds to a sum of iₛ(=i_{Rs}) and i_{Rd} illustrated in the graph of (2a).

Similarly, the intensity signal i_{G} of G (green) corresponds to a sum of iₛ(=i_{G}) and i_{Gd} illustrated in the graph of (2a).

Similarly, the intensity signal i_{B} of B (blue) corresponds to a sum of iₛ(=i_{Bs}) and i_{Bd} illustrated in the graph of (2a).

In the graph illustrated in “(2a) a specular reflection component and a diffuse reflection component of observation light”, when the intensity is compared among the specular reflection components (i_{Rs}, i_{G}, i_{Bs}) of each of RGB colors, the specular reflection component (i_{Bs}) of B (blue) is larger than the specular reflection components (i_{Gs}, i_{Rs}) of G (green) and R (red).

As a result, regarding the intensity of the observation light (i_{R}, i_{G}, i_{B}) in the graph indicated by “(2b) observation light (specular reflection component+diffuse reflection component)” as well, the observation light (i_{B}) of B (blue) is larger than the observation light (i_{G}, i_{R}) of G (green) and R (red).

This is a result of the irradiation light 11 of the light source 10 being green (G) and the subject 20 being red. In this case, the image captured by the imaging unit (camera) 50 is an image in which a color according to the observation light (i_{R}, i_{G}, i_{B}) intensity of the graph illustrated in this “(2b) observation light (specular reflection component+diffuse reflection component)” is set, that is, an image that does not accurately reflect the color (red) of the subject 20.

In the setting of (Condition 2) illustrated in FIG. 8, the irradiation light 11 of the light source 10 is green (G). Therefore, an image captured by the imaging unit (camera) 50 is an image in which a color change due to the light source color occurs, and an image that does not reflect the color of the subject 20 and requires white balance adjustment is captured.

Using the white balance gains k_{R} and k_{B} and the observation light (i_{R}, i_{G}, i_{B}) observed in (Condition 2) illustrated in FIG. 8, that is, the setting in which the irradiation light 11 of the light source 10 is green (G) and the subject 20 is red, each RGB value is calculated according to each of the expressions (Expression 31) and (Expression 32) described above.

That is, individual RGB values of the following are calculated.

$$( Expression 31 ) = “ opposite color ( R , G , B ) of white balance adjusted image ( {k}_{R} {i}_{R} , {i}_{G} , {k}_{B} {i}_{B} ) ” \\ ( Expression 32 ) = “ color ( {DoLP}_{R} , {DoLP}_{G} , {DoLP}_{B} ) of linear polarization degree ( DoLP ) ”$$

Note that, (Condition 2) illustrated in FIG. 8 has setting in which the irradiation light 11 of the light source 10 is white (R=G=B) and an image requiring white balance adjustment is captured. Therefore, a value calculated in advance is used as the white balance gains k_{R} and k_{B}.

The calculation result is as follows.

$$( Expression 31 ) = “ opposite color ( R , G , B ) of white balance adjusted image ( {k}_{R} {i}_{R} , {i}_{G} , {k}_{B} {i}_{B} ) ” = ( - 0.81 , 0.29 , 0.51 ) \\ ( Expression 32 ) = “ color ( {DoLP}_{R} , {DoLP}_{G} , {DoLP}_{B} ) of linear polarization degree ( DoLP ) ” = ( 0.28 , 0.52 , - 0.8 )$$

From the above-described results, (Expression 31) #(Expression 32), that is,
“opposite color (R, G, B) of white balance adjusted image (k_{R}i_{R}, i_{G}, k_{B}i_{B})”
≠“color (DoLP_{R}, DoLP_{G}, DoLP_{B}) of linear polarization degree (DoLP)” is satisfied.

As described with reference to FIGS. 7 and 8, in a case where illumination light is white (R=G=B) that does not require white balance adjustment, the following relational expression is established.
“opposite color (R, G, B) of white balance adjusted image (k_{R}i_{R}, i_{G}, k_{B}i_{B})”
=“color (DoLP_{R}, DoLP_{G}, DoLP_{B}) of linear polarization degree (DoLP)”

That is, the white balance gains k_{R} and k_{B} can be calculated by using the relational expressions illustrated in (Expression 33) and (Expression 34) described above.

In this way, by generating and solving two or more relational expressions shown in (Expression 34) described above as simultaneous equations, the two white balance gains k_{R} and k_{B} can be calculated.

### 4. About Configuration Example of Image Processing Device of Present Disclosure

Next, a configuration example of the image processing device of the present disclosure will be described.

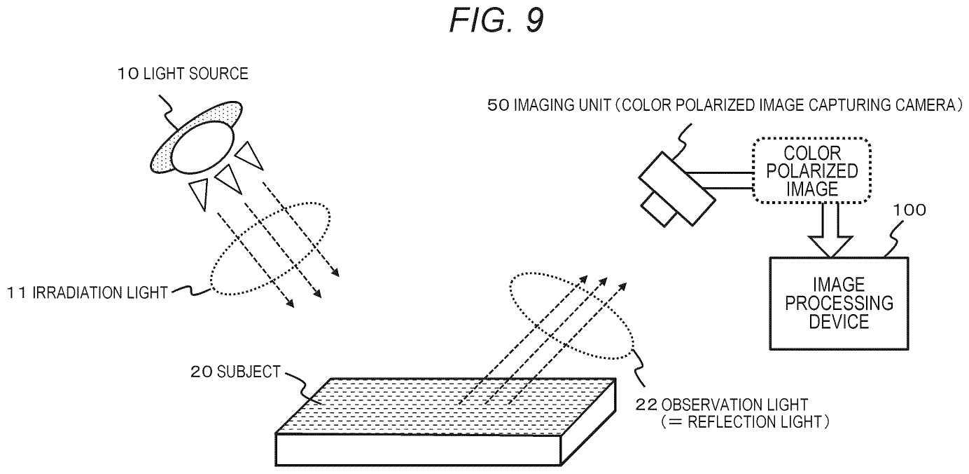

FIG. 9 is a diagram illustrating a usage example of the image processing device 100 of the present disclosure.

Irradiation light is emitted from the light source 10, and the observation light 22 which is reflection light reflected by the subject 20 is input to the imaging unit (color polarized image capturing camera) 50.

The imaging unit (color polarized image capturing camera) 50 captures multiple different color polarized images, and the captured multiple color polarized images are input to the image processing device 100.

The image processing device 100 calculates a white balance gain by using the multiple color polarized images input from the imaging unit (color polarized image capturing camera) 50, and executes the white balance adjustment processing using the calculated white balance gain.

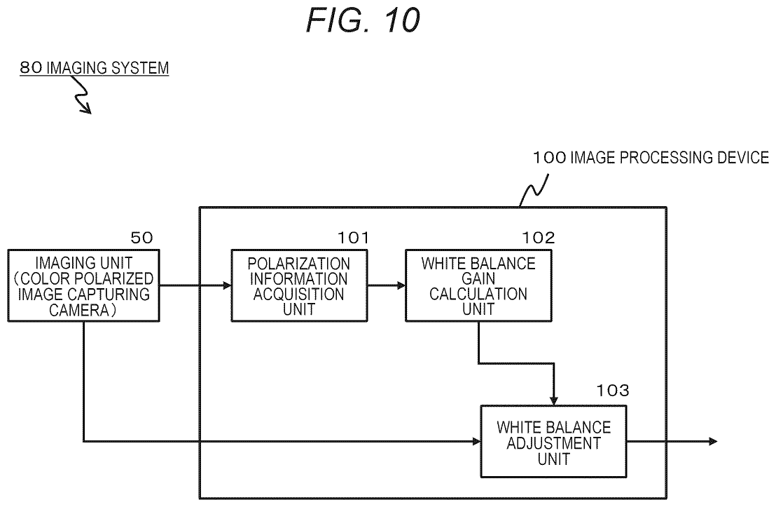

FIG. 10 is a diagram illustrating a configuration example of an imaging system 80 including the imaging unit (color polarized image capturing camera) 50 and the image processing device 100.

The imaging unit (color polarized image capturing camera) 50 captures a polarized image by using a polarizing filter (polarizing element).

As described above with reference to FIGS. 4 to 6, the imaging unit (color polarized image capturing camera) 50 captures three types of images (color polarized images) in order to acquire the three types of Stokes parameters s′₀ to s′₂ of the observation light 22 including reflection light of the subject 20.

The three types of images are the following three types of images illustrated in FIGS. 4 to 6.
(a) Color polarized image a
(b) Color polarized image b
(c) Color polarized image c

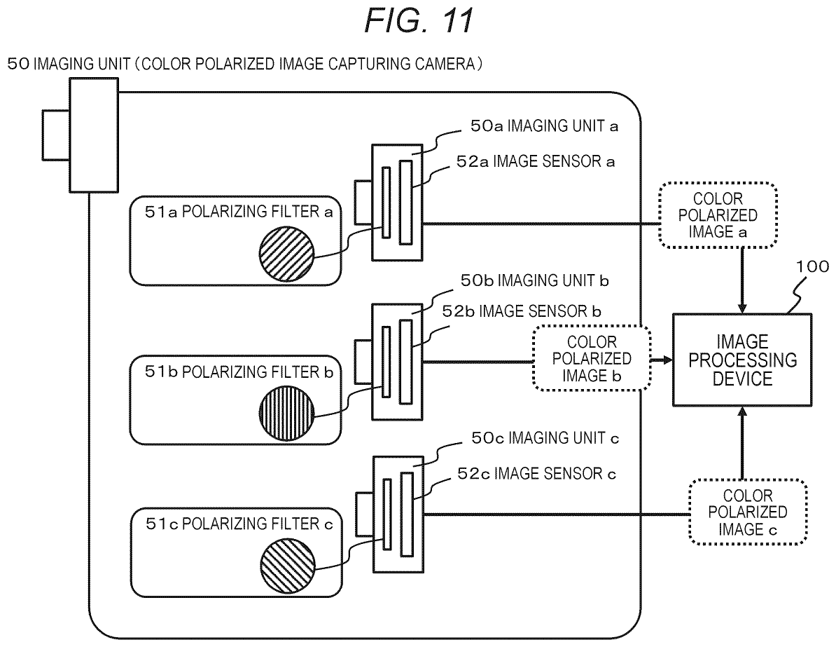

A plurality of specific configuration examples of the imaging unit (color polarized image capturing camera) 50 will be described with reference to FIG. 11 and subsequent figures.

FIG. 11 illustrates an example in which the imaging unit 50 includes multiple imaging units 50a to 50c.

The imaging units 50a to 50c each include polarizing filters a, 51a to c, 51c having different polarization directions.

Different polarized images through the polarizing filters a, 51a to c, 51c are captured by image sensors a, 52a to c, 52c.

Three color polarized images a to c captured by the three imaging units 50a to 50c are input to the image processing device 100.

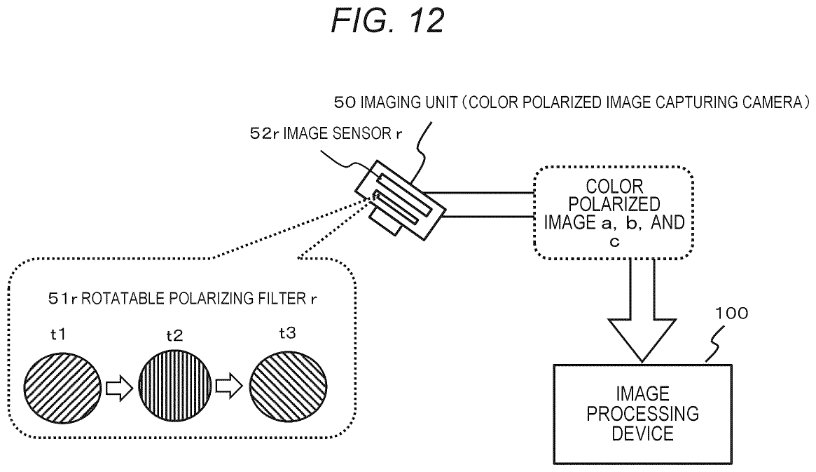

FIG. 12 is a configuration example in which one imaging unit 50 is used. The imaging unit 50 includes a rotatable polarizing filter 51r having a rotatable configuration.

By rotating the rotatable polarizing filter 51r, multiple different polarized images can be captured.

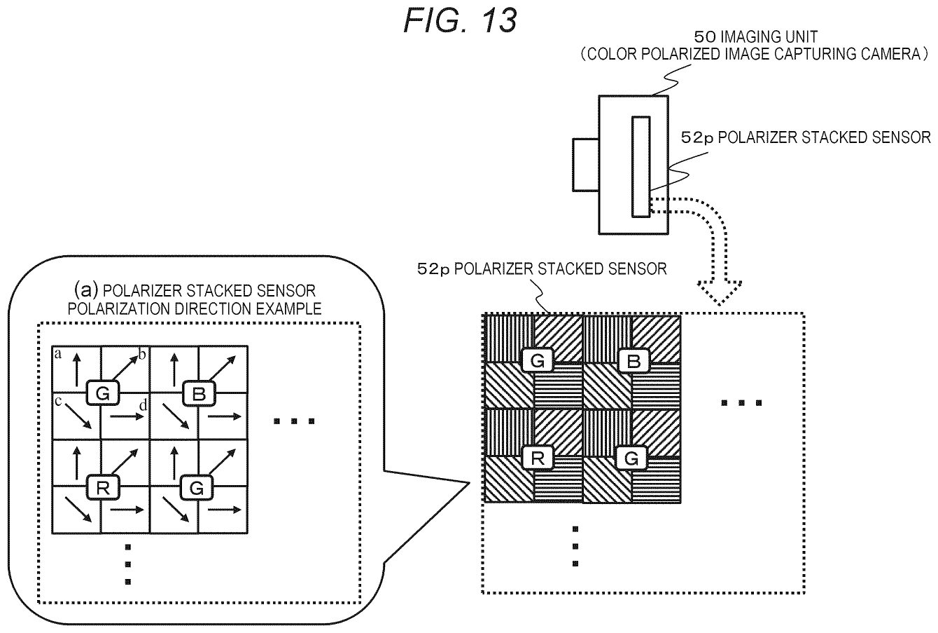

FIG. 13 is a configuration in which a polarizer stacked sensor is used as the image sensor.

The image sensor inside the imaging unit 50 is configured as a polarizer stacked sensor 52p associated with a polarizer (polarizing filter) corresponding to each pixel. Light (polarized light) via the polarizer (polarizing filter) is input to each pixel of the polarizer stacked sensor 52p.

Specifically, for example, polarizers (polarizing filters) in multiple polarization directions are arranged in association with an image sensor such as a complementary metal oxide semiconductor (CMOS) or a charge coupled device (CCD).

For example, as illustrated in (a) a polarizer stacked sensor polarization direction example at the lower left of FIG. 13, polarizers in four different polarization directions (a, b, c, d) are associated with individual pixels set in unit of four pixels for each of RGB.

Polarized images in individually different polarization directions are captured for these four pixels.

In this configuration, multiple polarized images can be acquired by one time of capturing processing, and high-speed processing can be performed.

Note that the polarizer (polarizing filter) only needs to take out linearly polarized light from subject light, and for example, a wire grid, photonic liquid crystal, or the like can be used. Note that, in a case of acquiring a color polarized image, a color filter is provided on an incident surface side of the sensor.

Note that, for example, in a configuration using the multiple imaging units a, 50a to c, 50c as illustrated in FIG. 11, a viewpoint position with respect to the subject is shifted.

If a position interval of the imaging units a, 50a to c, 50c is negligibly short with respect to a distance to the subject, parallax can be ignored in multiple polarized images having different polarization directions. In this case, it is possible to acquire an image equivalent to an unpolarized normal luminance image by averaging luminance of the polarized images having different polarization directions.

Whereas, in a case where the parallax cannot be ignored, an image equivalent to an unpolarized normal luminance image can be acquired by aligning the polarized images having different polarization directions in accordance with a parallax amount and averaging luminance of the aligned polarized images.

Furthermore, in a case of a configuration illustrated in FIG. 13, an image equivalent to an unpolarized normal luminance image can be acquired by averaging luminance of polarized images having different polarization directions for every pixel.

The image equivalent to an unpolarized normal luminance image acquired by these processes corresponds to, for example, an image including a Stokes parameter (s′_{0R}, s′_{0G}, s′_{0B}) corresponding to an unpolarized light intensity signal (luminance signal) corresponding to each of RGB colors in the observation light 22 illustrated in FIGS. 3 to 6. By performing the white balance adjustment processing using the unpolarized normal luminance image as the white balance adjustment target image, the image processing device 100 can acquire an RGB image reflecting the color of the subject with high accuracy.

Note that the white balance adjustment target image is not limited to such an unpolarized normal luminance image. The image processing device 100 may execute the white balance adjustment processing by using a polarized image acquired by the imaging unit 50 as an adjustment target image, to generate the white balance-adjusted polarized image.

In the configuration using the polarizer stacked sensor 52p associated with the polarizer (polarizing filter) corresponding to each pixel described above with reference to FIG. 13, various variations of a combination of the pixel and the polarizer (polarizing filter) are possible.

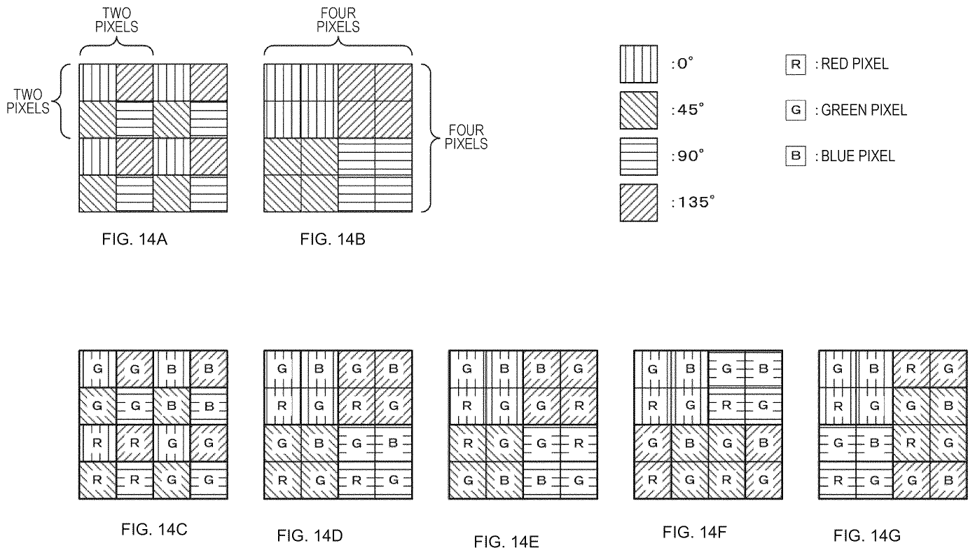

FIGS. 14 to 16 are diagrams illustrating pixel configuration examples of multiple polarization directions.

The configuration illustrated in each figure is repeated in the horizontal direction and the vertical direction. (a) and (b) of FIG. 14 illustrate arrangement of polarization pixels. Note that (a) of FIG. 14 illustrates a case where a polarization pixel block of 2×2 pixels includes, for example, polarization pixels having polarization directions (angle of the polarizers) of 0 degrees, 45 degrees, 90 degrees, and 135 degrees.

Furthermore, (b) of FIG. 14 illustrates a case where a polarization pixel block of 4×4 pixels includes, for example, polarization pixels having polarization directions of 0 degrees, 45 degrees, 90 degrees, and 135 degrees, with 2×2 pixels as a unit of the polarization direction. Note that, in a case where the polarization component unit of the polarizing filter is 2×2 pixels as illustrated in (b) of FIG. 14, a ratio of leakage of a polarization component from an area of a different adjacent polarization component unit to a polarization component obtained for each polarization component unit is smaller than that of the 1×1 pixel illustrated in (a) of FIG. 14.

Furthermore, in a case where a wire grid is used as the polarizing filter, polarized light in which an electric field component is perpendicular to a direction of grating (wire direction) is transmitted, and transmittance increases as the wire is longer. Therefore, in a case where the polarization component unit is 2×2 pixels, the transmittance is higher than that of 1×1 pixels. Therefore, in a case where the polarization component unit is 2×2 pixels, the transmittance is higher than that of 1×1 pixels, and an extinction ratio can be improved.
(c) to (g) of FIG. 14 illustrate pixel configurations in a case of acquiring a color polarized image. (c) of FIG. 14 illustrates a case where the polarization pixel block of 2×2 pixels illustrated in (a) of FIG. 14 is set as one color unit, and three primary color pixels (a red pixel, a green pixel, and a blue pixel) are provided in a Bayer array.
(d) of FIG. 14 illustrates a case where three primary color pixels are provided in a Bayer array for each pixel block of 2×2 pixels in the same polarization direction illustrated in (b) of FIG. 14.
(e) of FIG. 14 illustrates a case where three primary color pixels are provided in a Bayer array for each pixel block of 2×2 pixels in the same polarization direction, and blocks of 2×2 pixels having different polarization directions are set as pixels of the same color.
(f) of FIG. 14 illustrates a case where, for a pixel block of 2×2 pixels in the same polarization direction of a Bayer array, a phase difference in the polarization direction from a pixel block adjacent in the horizontal direction is 90 degrees, and a phase difference in the polarization direction from a pixel block adjacent in the vertical direction is ±45 degrees.
(g) of FIG. 14 illustrates a case where, for a pixel block of 2×2 pixels in the same polarization direction of a Bayer array, a phase difference in the polarization direction from a pixel block adjacent in the vertical direction is 90 degrees, and a phase difference in the polarization direction from a pixel block adjacent in the horizontal direction is ±45 degrees.

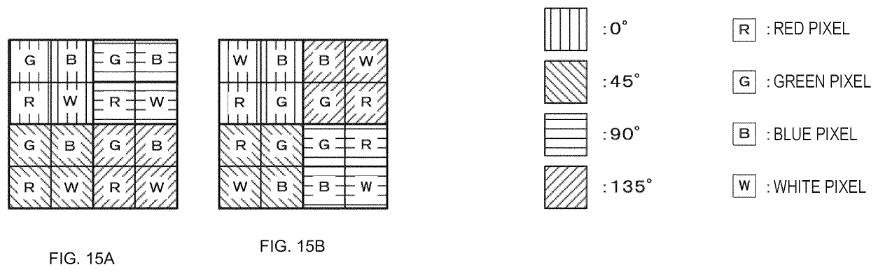

FIG. 15 illustrates a case where three primary color pixels and white pixels are provided. For example, (a) of FIG. 15 illustrates a case where one green pixel is set as a white pixel in a pixel block of 2×2 pixels in the same polarization direction of a Bayer array illustrated in (b) of FIG. 14.
(b) of FIG. 15 illustrates a case where one green pixel is set as a white pixel in a pixel block of 2×2 pixels in the same polarization directions of a Bayer array illustrated in (c) of FIG. 14, and blocks of 2×2 pixels having different polarization directions are set as pixels having the same color.

By providing the white pixel in this way, as disclosed in Patent Document “WO 2016/136085 A”, a dynamic range in generating normal line information can be expanded as compared with a case where the white pixel is not provided. Furthermore, since the white pixel has a favorable S/N ratio, the white pixel is less likely to be affected by noise in calculation of a color difference or the like.

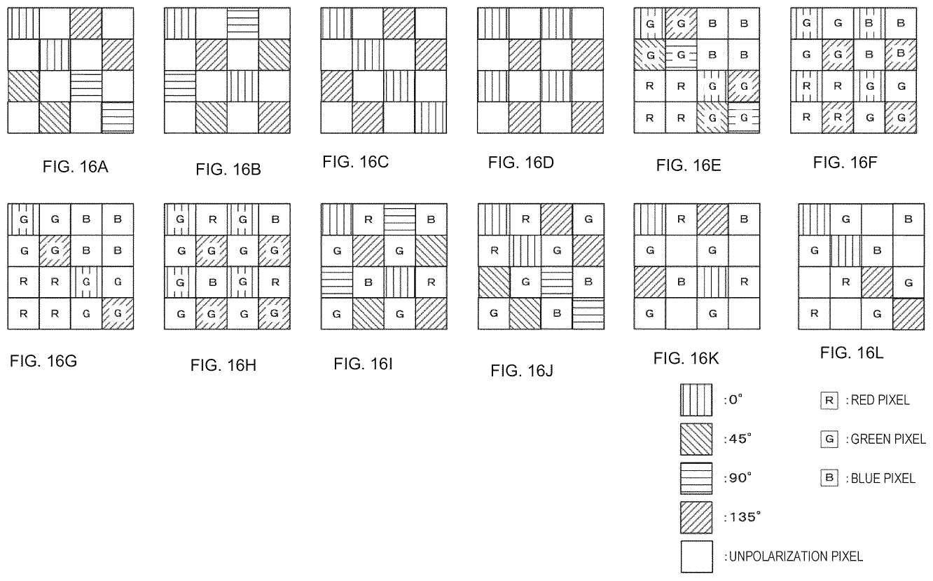

FIG. 16 illustrates a case where unpolarization pixels are provided, and a polarization direction and display of color pixels are similar to those in FIG. 14.
(a) of FIG. 16 illustrates a case where a pixel block of 4×4 pixels is configured by using two pixel blocks of 2×2 pixels in four different polarization directions and two pixel blocks of 2×2 pixels including unpolarization pixels, and a pixel block of a polarization pixel is set as a green pixel, a pixel block of an unpolarization pixel is set as a red pixel or a blue pixel, and pixel blocks (2×2 pixels) of the same color are provided as a Bayer array.
(b) of FIG. 16 illustrates a case where polarization pixels having a phase difference of 45 degrees are provided in a pixel block of 2×2 pixels in an oblique direction, and a polarization direction of the polarization pixel is set to two directions having a phase difference of 45 degrees, and illustrates a case where a pixel block including two polarized images in different polarization directions and two unpolarization pixels is set as a color unit, and pixel blocks of three primary colors are provided as a Bayer array.
(c) of FIG. 16 illustrates a case where a pixel block of 2×2 pixels is set as a color unit, pixel blocks of three primary colors are provided as a Bayer array, and two polarization pixels in different polarization directions are provided in a pixel block of a green pixel.
(d) of FIG. 16 illustrates a case where polarization pixels are provided similarly to (b) of FIG. 16, a pixel block including two polarized images in different polarization directions and two unpolarization pixels is set as three green pixels, one unpolarization pixel is set as a red pixel, and one unpolarization pixel is set as a blue pixel in adjacent pixel blocks.
(e) and (f) of FIG. 16 illustrate a case where unpolarization pixels are set as color pixels, and pixels of three primary colors are provided in a pixel block of 4×4 pixels. Furthermore, (g) and (h) of FIG. 16 illustrate a case where some of unpolarization pixels are set as color pixels, and pixels of three primary colors are provided in a pixel block of 4×4 pixels.

Note that the configurations illustrated in FIGS. 14 to 16 are examples, and other configurations may be used. Furthermore, in order to enable high-sensitivity imaging even at night or the like, a configuration may be adopted in which infrared (IR) pixels are mixed and repeated.

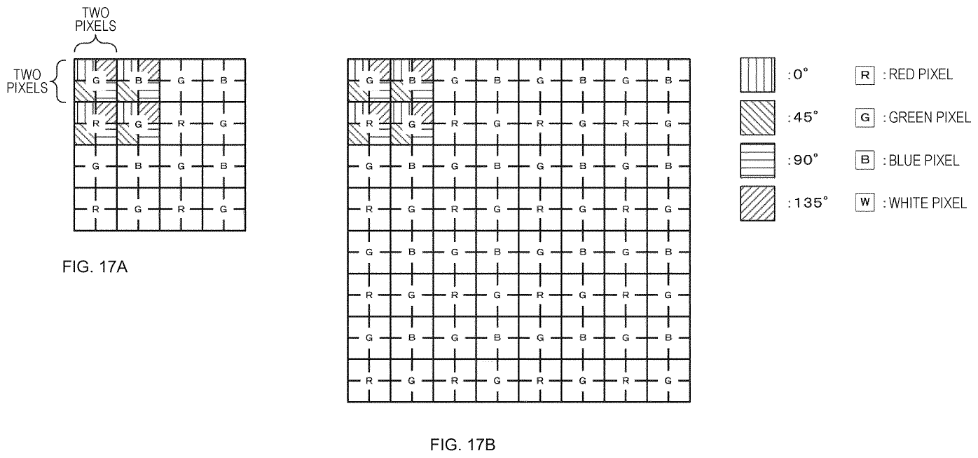

FIG. 17 illustrates a case where polarization pixel blocks are thinned out to be provided. (a) of FIG. 17 illustrates a case where a polarization pixel block of 4×4 pixels is repeatedly provided for each block of 8×8 pixels. In this case, the number of pixels having the same color and polarization direction is eight pixel cycles in each of the horizontal direction and the vertical direction.
(b) of FIG. 17 illustrates a case where a polarization pixel block of 4×4 pixels is repeatedly provided for each block of 16×16 pixels. In this case, the number of pixels having the same color and polarization direction is 16 pixel cycles in each of the horizontal direction and the vertical direction. Note that the polarization pixel block may be provided such that pixels having the same color and polarization direction have 32 pixel cycles or 64 pixel cycles in each of the horizontal direction and the vertical direction. Moreover, a repetition period of the pixels having the same color and polarization direction may be different between the horizontal direction and the vertical direction, or may be different between a central portion and an end portion of the image sensor.

Note that the imaging unit (color polarized image capturing camera) 50 that acquires a color polarized image is not limited to the above-described configuration, and may have another configuration as long as the imaging unit (color polarized image capturing camera) 50 can acquire a color polarized image from which the polarization information such as the Stokes parameter to be used for the white balance gain calculation processing can be obtained.

Furthermore, the color polarized image to be used in the image processing device 100 is not limited to the case of being output from the imaging unit (color polarized image capturing camera) 50 to the image processing device 100. For example, in a case where a color polarized image generated by the imaging unit (color polarized image capturing camera) 50 or the like is recorded on a recording medium, the color polarized image recorded on the recording medium may be read and output to the image processing device 100.

Returning to FIG. 10, the configuration of the image processing device 100 will be described.

The image processing device 100 includes a polarization information acquisition unit 101, a white balance gain calculation unit 102, and a white balance adjustment unit 103.

The polarization information acquisition unit 101 of the image processing device 100 acquires polarization information to be applied to white balance gain calculation, by using a color polarized image acquired by the imaging unit (color polarized image capturing camera) 50.

The polarization information acquisition unit 101 is input with, for example, multiple different polarized images from the imaging unit (color polarized image capturing camera) 50.

Specifically, for example, the following three types of images described above with reference to FIGS. 4 to 6 are input.
(a) Color polarized image a
(b) Color polarized image b
(c) Color polarized image c

From these images, the polarization information acquisition unit 101 acquires polarization information to be used for the white balance gain calculation processing. Specifically, processing is performed for calculating a Stokes parameter corresponding to each of RGB colors or for a linear polarization degree (DoLP) corresponding to each of RGB colors and calculated using the Stokes parameter.

The polarization information acquired by the polarization information acquisition unit 101 is output to the white balance gain calculation unit 102.

The white balance gain calculation unit 102 uses a color polarized image acquired by the imaging unit (color polarized image capturing camera) 50 and the polarization information acquired by the polarization information acquisition unit 101, to calculate a white balance gain to be applied to white balance adjustment.

For example, the white balance gain k_{R} to be multiplied by the R (red) pixel value of the captured image and the white balance gain k_{B} to be multiplied by the B (blue) pixel value of the captured image are calculated.

Each element of the white balance gain (k_{R}, 1, k_{B}) corresponds to a multiplication parameter for the pixel value (R, G, B) of each color of the captured image.

By using the pixel value of G (green) of the captured image as a reference without changing the G pixel value, the pixel value of R (red) of the captured image is multiplied by the white balance gain k_{R}, and the pixel value of B (blue) of the captured image is multiplied by the white balance gain k_{B}, thereby a corrected image after white balance adjustment can be generated.

The white balance gain calculated by the white balance gain calculation unit 102 is output to the white balance adjustment unit 103.

The white balance adjustment unit 103 executes the white balance adjustment processing on a color image acquired by the imaging unit (color polarized image capturing camera) 50.

For example, by multiplying the R (red) pixel value of the color image by the white balance gain k_{R}, and multiplying the B (blue) pixel value by the white balance gain k_{B}, a corrected image after the white balance adjustment is generated.

The white balance adjusted image generated by the white balance adjustment unit 103 is output to an external device, for example, a display device, a recording device, or the like.

### 5. About Sequence of Processing Executed by Image Processing Device of Present Disclosure

Next, a sequence of processing executed by the image processing device of the present disclosure will be described.

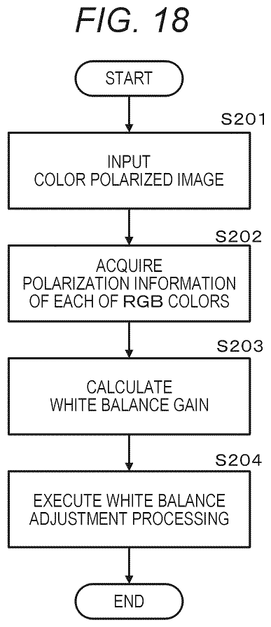

With reference to FIG. 18, a sequence of processing executed by the image processing device 100 of the present disclosure will be described.

Note that the image processing device 100 of the present disclosure has a program execution function such as a CPU, for example, and processing according to flowcharts illustrated in FIG. 18 and subsequent figures can be executed according to a program stored in a storage unit in the image processing device 100.

Hereinafter, processing of each step of the flowchart illustrated in FIG. 18 will be described.

### (Step S201)

First, in step S201, the image processing device 100 is input with a color polarized image.

A color polarized image captured by the imaging unit (color polarized image capturing camera) 50 illustrated in FIG. 10 is input.

Specifically, for example, the following three types of color polarized images described above with reference to FIGS. 4 to 6 are input.
(a) Color polarized image a
(b) Color polarized image b
(c) Color polarized image c

### (Step S202)

Next, in step S202, the image processing device 100 acquires polarization information to be applied to white balance gain calculation, by using the color polarized image input in step S201.

This processing is processing executed by the polarization information acquisition unit 101 of the image processing device 100 illustrated in FIG. 10.

The polarization information acquisition unit 101 acquires polarization information to be used for the white balance gain calculation processing, from the color polarized image input from the imaging unit (color polarized image capturing camera) 50.

Specifically, processing is performed for calculating a Stokes parameter corresponding to each of RGB colors or for a linear polarization degree (DoLP) corresponding to each of RGB colors and calculated using the Stokes parameter.

From the color polarized image input from the imaging unit (color polarized image capturing camera) 50, the polarization information acquisition unit 101 acquires, for example, the following Stokes parameters, that is, three types of Stokes parameters of,
(a) a Stokes parameter (s′_{0R}, s′_{0G}, s′_{0B}) corresponding to an unpolarized light intensity signal (luminance signal) corresponding to each of RGB colors in the observation light,
(b) a Stokes parameter (s′_{1R}, s′_{1G}, s′_{1B}) corresponding to a difference signal of a horizontal/vertical linear polarization component corresponding to each of RGB colors in the observation light, and
(c) a Stokes parameter (s′_{2R}, s′_{2G}, s′_{2B}) corresponding to a difference signal of a 45 degree linear polarization component corresponding to each of RGB colors in the observation light.

Moreover, the linear polarization degree (DoLP) corresponding to each of RGB colors is calculated using the acquired Stokes parameters.

Note that, as described above, the linear polarization degree (DoLP) is a ratio (%) of linearly polarized light included in observation light (subject reflection light).

### (Step S203)

Next, in step S203, the image processing device 100 calculates a white balance gain by using polarization information acquired in step S202.

This processing is processing executed by the white balance gain calculation unit 102 of the image processing device 100 illustrated in FIG. 10.

The white balance gain calculation unit 102 calculates a white balance gain that is a pixel value adjustment parameter for correcting the pixel value of the captured image to the original color of the subject.

The white balance gain calculation unit 102 uses a color polarized image acquired by the imaging unit (color polarized image capturing camera) 50 and the polarization information acquired by the polarization information acquisition unit 101, to calculate a white balance gain to be applied to white balance adjustment.

For example, the white balance gain k_{R} to be multiplied by the R (red) pixel value of the captured image and the white balance gain k_{B} to be multiplied by the B (blue) pixel value of the captured image are calculated.

Each element of the white balance gain (k_{R}, 1, k_{B}) corresponds to a multiplication parameter for the pixel value (R, G, B) of each color of the captured image.

By using the pixel value of G (green) of the captured image as a reference without changing the G pixel value, the pixel value of R (red) of the captured image is multiplied by the white balance gain k_{R}, and the pixel value of B (blue) of the captured image is multiplied by the white balance gain k_{B}, thereby a corrected image after white balance adjustment can be generated.

The white balance gain calculation processing in step S203 is executed by applying any one of the following two processing examples described above with reference to FIGS. 5 and 6.
A. White balance gain calculation processing example 1 (FIG. 5)
B. White balance gain calculation processing example 2 (FIG. 6)

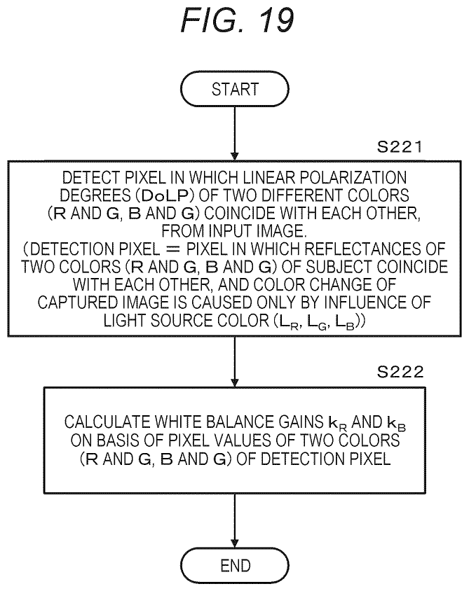

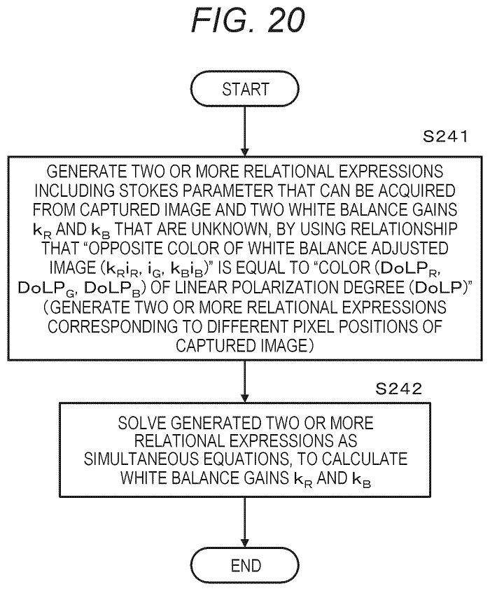

A detailed sequence of the above-described two white balance gain calculation processing examples will be described later with reference to flowcharts illustrated in FIGS. 19 and 20.

### (Step S204)

Finally, in step S204, the image processing device 100 executes the white balance adjustment processing to which the white balance gain calculated in step S203 is applied.

This processing is processing executed by the white balance adjustment unit 103 of the image processing device 100 illustrated in FIG. 10.

The white balance adjustment unit 103 executes the white balance adjustment processing on a captured image acquired by the imaging unit (color polarized image capturing camera) 50.

For example, by multiplying a R (red) pixel value of the captured image by the white balance gain k_{R} calculated in step S203, and multiplying a B (blue) pixel value by the white balance gain k_{B}, the white balance adjustment unit 103 generates a corrected image after white balance adjustment.

The white balance adjusted image generated by the white balance adjustment unit 103 is output to an external device, for example, a display device, a recording device, or the like.

Next, a detailed sequence of the white balance gain calculation processing in step S203 will be described. As described above, the white balance gain calculation processing in step S203 is executed by applying any one of the following two processing examples described above with reference to FIGS. 5 and 6.
A. White balance gain calculation processing example 1 (FIG. 5)
B. White balance gain calculation processing example 2 (FIG. 6)

First, with reference to the flowchart illustrated in FIG. 19, a detailed sequence of
A. White balance gain calculation processing example 1 (FIG. 5)
will be described. Processing of each step in the flow illustrated in FIG. 19 will be described.

Note that the processing in steps S221 to S222 of the flow illustrated in FIG. 19 is processing executed by the white balance gain calculation unit 102 of the image processing device 100 illustrated in FIG. 10.

### (Step S221)

In step S221, the white balance gain calculation unit 102 detects a pixel in which linear polarization degrees (DoLP) of two different colors (R and G, B and G) coincide with each other, from a captured image acquired by the imaging unit (color polarized image capturing camera) 50.

Note that the detection pixel is a pixel in which reflectances of two colors (R and G, B and G) of the subject coincide with each other, and a color change of the captured image is caused only by an influence of the light source color (L_{R}, L_{G}, L_{B}).

As described above with reference to FIG. 5, for example, at the pixel position where the reflectance r_{R} of R (red) and the reflectance r_{G} of G (green) coincide with each other, that is, the pixel position where

r_{R}=r_{G}
is established, the linear polarization degrees (DoLP) of R (red) and G (green) in the observation light (reflection light) 22 coincide with each other. That is, the following relational expression is established.

(DoLP_{R})=(DoLP_{G})

As described above, in order to detect the pixel position where the reflectance r_{R} of R (red) and the reflectance r_{G} of G (green) coincide with each other, that is, the pixel position where

r_{R}=r_{G}
is established, a pixel position is detected where the linear polarization degree (DoLP_{R}) of R (red) and the linear polarization degree (DoLP_{G}) of G (green) in the observation light (reflection light) 22 coincide with each other.

Similarly, in order to detect a pixel position where the reflectance r_{B} of B (blue) and the reflectance r_{G} of G (green) coincide with each other, that is, a pixel position where

r_{B}=r_{G}
is established, a pixel position is detected where the linear polarization degree (DoLP_{B}) of B (blue) and the linear polarization degree (DoLP_{G}) of G (green) in the observation light (reflection light) 22 coincide with each other.

### (Step S222)

Next, in step S222, the white balance gain calculation unit 102 calculates the white balance gains k_{R} and k_{B} on the basis of the pixel values of the two colors (R and G, B and G) of the detection pixel.

As described above with reference to FIG. 5, at the pixel position where the reflectance r_{R} of R (red) and the reflectance r_{G} of G (green) coincide with each other, that is,
the pixel position where r_{R}=r_{G} is established,

$$observation light ( {i}_{R} , {i}_{G} , {i}_{B} ) = ( {L}_{R} , {r}_{R} , {L}_{G} {r}_{G} , {L}_{B} {r}_{B} ) = ( {L}_{R} {r}_{G} , {L}_{G} {r}_{G} , {L}_{B} {r}_{B} )$$

is established, and
the white balance gain k_{R} to be applied to correction of the pixel value (intensity) of R (red), that is,

$${k}_{R} = ( {L}_{G} / {L}_{R} )$$

can be calculated from the R pixel value (L_{R}r_{G}) and the G pixel value (=L_{G}r_{G}) at this pixel position.

Similarly, at the pixel position where the reflectance r_{B} of B (blue) and the reflectance r_{G} of G (green) coincide with each other, that is,
at the pixel position where r_{B}=r_{G} is established, as described above,

$$observation light ( {i}_{R} , {i}_{G} , {i}_{B} ) = ( {L}_{R} , {r}_{R} , {L}_{G} {r}_{G} , {L}_{B} {r}_{B} ) = ( {L}_{R} {r}_{R} , {L}_{G} {r}_{G} , {L}_{B} {r}_{B} )$$

is established, and
the white balance gain k_{B} to be applied to correction of the pixel value (intensity) of G (blue), that is,

$${k}_{B} = ( {L}_{G} / {L}_{B} )$$

can be calculated from the B pixel value (L_{B}r_{G}) and the G pixel value (=L_{G}r_{G}) at this pixel position.

As described above, the white balance gain (k_{R}, 1, k_{B}) can be defined as follows using the light source color (L_{R}, L_{G}, L_{B}) of the light source 10.

$$White balance gain ( {k}_{R} , 1 , {k}_{B} ) = ( ( {L}_{G} / {L}_{R} ) , 1 , ( {L}_{G} / {L}_{B} ) )$$

The image (s′_{0R}, s′_{0G}, s′_{0B}) acquired from the multiple color polarized images input from the imaging unit 50 has the pixel value (s′_{0R}, s′_{0G}, s′_{0B}) including a luminance signal corresponding to an RGB pixel value. By multiplying this pixel value by the calculated white balance gain (k_{R}, 1, k_{B}), the white balance adjustment processing is executed, and an image after white balance adjustment can be generated.

Next, with reference to a flowchart illustrated in FIG. 20, a detailed sequence of
“B. White balance gain calculation processing example 2”
will be described.

This “B. White balance gain calculation processing example 2” is the white balance gain calculation processing described above with reference to FIG. 6.

Note that the processing in steps S241 to S242 of the flow illustrated in FIG. 20 is processing executed by the white balance gain calculation unit 102 of the image processing device 100 illustrated in FIG. 10.

### (Step S241)

In step S241, the white balance gain calculation unit 102 executes the following processing.

Using a relationship that “an opposite color of the white balance adjusted image (k_{R}i_{R}, i_{G}, k_{B}i_{B})” is equal to “a color (DoLP_{R}, DoLP_{G}, DoLP_{B}) of the linear polarization degree (DoLP)”, two or more relational expressions are generated including a Stokes parameter that can be acquired from the captured image and two white balance gains k_{R} and k_{B} that are unknown. Two or more relational expressions corresponding to different pixel positions of the captured image are generated.

The relational expression serving as a base of this relational expression is the relational expression (Expression 33) described above with reference to FIG. 6. By organizing the relational expression (Expression 33), the relational expression (Expression 34) including the two white balance gains k_{R} and k_{B} as unknowns is derived.

As described above, the parameters included in (Expression 34), for example, DoLP_{R}, DoLP_{G}, and DoLP_{B} can be calculated by using Stokes parameters that can be acquired from a color polarized image captured by the imaging unit 50, as described above in (Expression 35).

All other parameters other than the white balance gains k_{R} and k_{B} included in (Expression 34) are known, and unknowns included in (Expression 34) are only the white balance gains k_{R} and k_{B}.

Therefore, by generating and solving two or more relational expressions shown in (Expression 34) as simultaneous equations, the two white balance gains k_{R} and k_{B} can be calculated.

That is, in step S241, the relational expression shown in (Expression 34) is generated for two or more pixel positions.

### (Step S242)

Next, in step S242, the white balance gain calculation unit 102 solves the two or more relational expressions generated in step S241, as simultaneous equations.

As a result of this processing, the two white balance gains k_{R} and k_{B}, which are two unknowns included in the relational expression shown in (Expression 34), are calculated.

The image processing device 100 applies the white balance gains k_{R} and k_{B} calculated by these processes to the image captured by the imaging unit 50, to execute the white balance adjustment processing.

### 6. About White Balance Gain Calculation and White Balance Adjustment Processing in Unit of Pixel or in Unit of Image Area

Next, white balance gain calculation and white balance adjustment processing in unit of pixel or in unit of image area will be described.

By applying the white balance gain calculated according to the processing described in the above-described embodiment to, for example, an unpolarized luminance image acquired from an image captured by the imaging unit 50, it is possible to acquire a white balance adjusted image, that is, an RGB image reflecting the color of the subject with high accuracy.

For example, an image including the Stokes parameter (s′_{0R}, s′_{0R}G, s′_{0B}) acquired from the image captured by the imaging unit 50 is an RGB image including an unpolarized light intensity signal (luminance signal). By performing the white balance adjustment processing on this image an RGB image reflecting the color of the subject with high accuracy can be acquired.

At this time, it is also possible to perform the white balance adjustment processing in which a uniform white balance gain is applied to the entire image. However, different white balance gains may be calculated in unit of pixel constituting the image or in unit of image area including multiple pixels, and individual white balance adjustment processing may be performed in unit of pixel or in unit of image area.

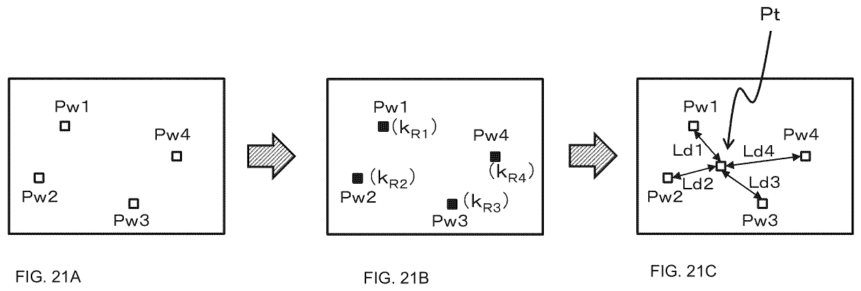

With reference to FIG. 21, a description is given to a specific example of processing of calculating different white balance gains in unit of pixel constituting an image or in unit of image area including multiple pixels.

As described above, in the image processing device 100 of the present disclosure illustrated in FIG. 10, the white balance gain calculation unit 102 executes one of the following two types of processing described with reference to FIGS. 5 and 6, to execute the white balance gain calculation processing.
A. White balance gain calculation processing example 1 (FIG. 5)
B. White balance gain calculation processing example 2 (FIG. 6)

“A. White balance gain calculation processing example 1” described with reference to FIG. 5 is for executing processing according to the flow illustrated in FIG. 19, and is for executing processing of calculating the white balance gains k_{R} and k_{B} on the basis of pixel values of two colors (R and G, B and G) at a pixel position where an influence of a difference in reflectance between the two different colors (R and G, B and G) does not occur but only an influence of the light source color (L_{R}, L_{G}, L_{B}) occurs, in pixel values of the captured image.

Furthermore, “B. White balance gain calculation processing example 2” described with reference to FIG. 6 is for executing processing according to the flow illustrated in FIG. 20, and is for executing processing of calculating the two white balance gains k_{R} and k_{B} by using the relationship that “an opposite color of the white balance adjusted image (k_{R}i_{R}, i_{G}, k_{B}i_{B})” is equal to “a color (DoLP_{R}, DoLP_{G}, DoLP_{B}) of the linear polarization degree (DoLP)”.

In both of these two processing examples, the white balance gain is calculated using the degree of linear polarization (DoLP) obtained from one pixel or two pixels in the image.

That is, it can be interpreted that the calculation processing of the white balance gain corresponding to the specific pixel is performed.

Such a white balance gain corresponding to a specific pixel may be applied to the entire image. However, for example, it is also possible to calculate a white balance gain corresponding to multiple pixels in accordance with “A. White balance gain calculation processing example 1” or “B. White balance gain calculation processing example 2” described above, and perform calculation of a white balance gain for each pixel or in unit of image area in the entire image, and white balance adjustment for each pixel or in unit of image area to which the calculation gain is applied, by using the white balance gains corresponding to the multiple pixels.

With reference to FIG. 21, a description is given to a processing example of calculating a white balance gain of a pixel for which a white balance gain has not been calculated, by performing interpolation processing on the basis of a white balance gain calculated in unit of multiple pixels.

It is assumed that four pixels Pw1 to Pw4 illustrated in FIG. 21(a) are pixels for which white balance gains corresponding to the pixels have been calculated in accordance with “A. White balance gain calculation processing example 1” or “B. White balance gain calculation processing example 2” described above.

The white balance gain calculation unit 102 of the image processing device 100 of the present disclosure illustrated in FIG. 10 calculates white balance gains of other pixels by performing interpolation processing based on a value of the white balance gain of each of the four white balance gain calculated pixels Pw1 to Pw4 illustrated in FIG. 21(a).

FIG. 21(b) illustrates, for example, the white balance gain k_{R} corresponding to R (red).

The white balance gain corresponding to R (red) of the pixel Pw1 is k_{R1}.

The white balance gain corresponding to R (red) of the pixel Pw2 is k_{R2}.

The white balance gain corresponding to R (red) of the pixel Pw3 is k_{R3}.

The white balance gain corresponding to R (red) of the pixel Pw4 is k_{R4}.

The white balance gain calculation unit 102 calculates a white balance gain of a pixel or an image area for which a white balance gain corresponding to the pixel has not been calculated, by performing interpolation processing using a weight corresponding to a distance from the pixels Pw1 to Pw4.

FIG. 21(c) illustrates an example of white balance gain calculation processing to which the interpolation processing is applied for a pixel Pt for which a white balance gain corresponding to the pixel has not been calculated.

FIG. 21(c) illustrates the pixel Pt for which the white balance gain corresponding to the pixel has not been calculated, the pixels Pw1 to Pw4 for which the white balance gains corresponding to the pixels have been calculated, and distances “Ld1” to” Ld4” between these pixels.

The white balance gain calculation unit 102 calculates a white balance gain k_{RP} corresponding to R (red) of the pixel Pt according to (Expression 41) shown below.

$$\begin{matrix}[ Formula 16 ] & \\ {k}_{RP} = {w}_{a} ( \frac{1}{{L}_{d 1}} ) \times {k}_{R 1} + {w}_{a} ( \frac{1}{{L}_{d 2}} ) \times {k}_{R 2} + {w}_{a} ( \frac{1}{{L}_{d 3}} ) \times {k}_{R 3} + {w}_{a} ( \frac{1}{{L}_{d 4}} ) \times {k}_{R 4} & ( Expression 41 )\end{matrix}$$

$$Where , {w}_{a} = 1 / ( ( \frac{1}{{L}_{d 1}} ) + ( \frac{1}{{L}_{d 2}} ) + ( \frac{1}{{L}_{d 3}} ) + ( \frac{1}{{L}_{d 4}} ) )$$

Note that a coefficient wa in (Expression 41) described above is a coefficient for normalizing the weight.

The white balance gain calculation unit 102 executes processing similar to the processing described above for each pixel, and calculates the white balance gains k_{R} corresponding to R (red) and the white balance gains k_{B} corresponding to B (blue) of all pixels constituting the image.

Note that the white balance gain may be calculated not in unit of pixel but in unit of image area including multiple pixels. In this case, for example, a barycentric position of the image area is set as a representative pixel, a white balance gain of the representative pixel is calculated by the above-described processing, and the calculated white balance gain is applied to the pixels of the entire image area in which the barycenter.

In this case, the white balance gain calculation unit 102 performs clustering to segment one image into multiple image areas, and sets a barycentric position and a representative value of the white balance gain for each image area (each class).

Thereafter, interpolation processing is performed using the barycentric position and the white balance gain representative value for each image area (class), and a white balance gain of each area is calculated. Note that the representative value of the white balance gain is a representative value in unit of image area (class), and for example, an average value, a median value, a mode value, or the like can be applied.

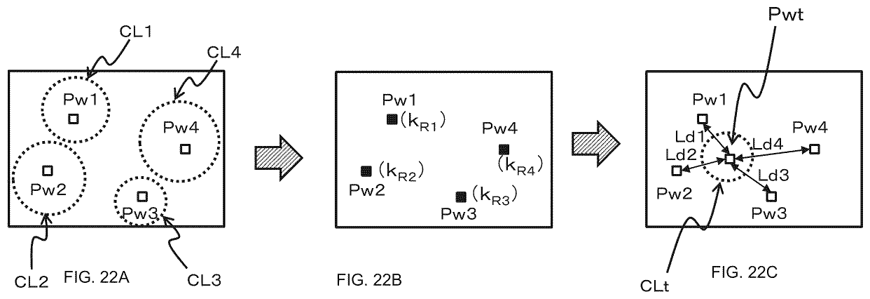

FIG. 22 illustrates an example in which clustering is performed as area segmentation processing of an image. FIG. 22(a) illustrates a clustering result in which multiple image areas (classes) CL1 to CL4 are set.

As illustrated in FIG. 22(B), it is assumed that a barycentric position of the class CL1 is “PW1”, and a representative value of the white balance gain corresponding to R (red) is “k_{R1}”. Furthermore, a barycentric position of the class CL2 is “PW2” and a white balance gain representative value corresponding to R (red) is “k_{R2}”, a barycentric position of the class CL3 is “PW3” and a white balance gain representative value corresponding to R (red) is “k_{R3}”, and a barycentric position of the class CL4 is “PW4” and a white balance gain representative value corresponding to R (red) is “k_{R4}”.

In such a case, white balance gains of other image areas can be set by performing interpolation processing similar to the case described above with reference to FIG. 21.

As illustrated in FIG. 22(C), the white balance gain of the image area (class) CLt having a barycentric position “PWt” can be calculated by the interpolation processing.

Furthermore, in a case where the white balance gain calculation unit 102 performs area segmentation of the color polarized image and performs the white balance gain setting in unit of segmented areas, area segmentation may be performed using graph cutting, deep learning (such as convolutional neural network (CNN), and recurrent neural network (RNN)), or the like, and a single white balance gain may be set for each color component in the segmented area.

In a case where the white balance gain calculation unit 102 performs the white balance gain calculation processing in unit of image area, for example, the following processing can be performed.

That is, it is possible to perform processing of identifying a type of an object that is a subject of an image, setting an image area in unit of identified object type, and performing the white balance gain calculation processing in unit of object type.

Note that, as the processing of identifying the type of the object that is the subject of the image, for example, a technique such as pattern matching or semantic segmentation can be applied.

The pattern matching is processing of, for example, storing pattern data including a shape and feature information of a person, a car, or the like in a storage unit, and identifying each subject by comparing the pattern data stored in the storage unit with a subject in an image area on the captured image.

The semantic segmentation is a technique of storing dictionary data (learned data) for object identification based on various kinds of actual object shape and other feature information in the storage unit, and performing object identification as to what the object in the image is, on the basis of a matching degree between the dictionary data and the object in the captured image. In the semantic segmentation, object identification is performed in unit of pixel of the captured image.

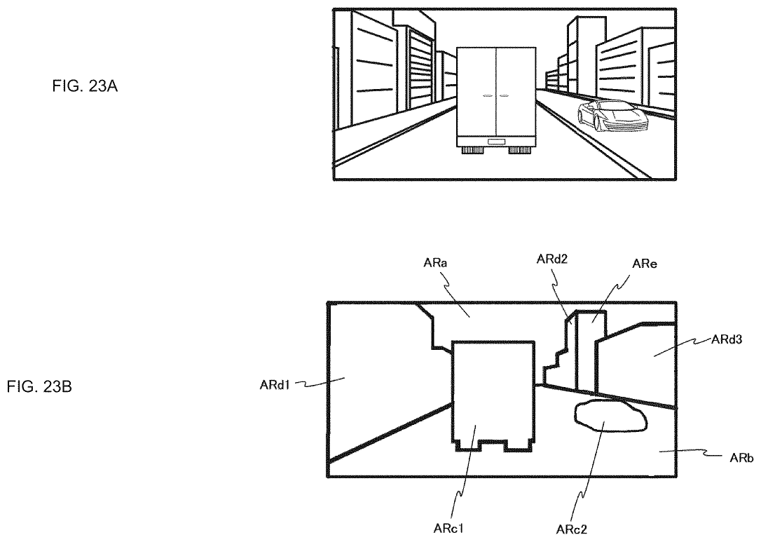

FIG. 23 is a diagram for explaining a processing example of performing area segmentation and calculating a white balance gain in unit of image area. FIG. 23(a) illustrates a color polarized image, and FIG. 23(b) illustrates an area segmentation result. Note that, in FIG. 23(b), an empty area ARa, a road area ARb, areas ARc1 and ARc2 indicating a vehicle, and areas ARd1, ARd2, ARd3, and ARe indicating a background are classified. A white balance gain is individually calculated in each of these units of each area.

Meanwhile, the white balance gain calculation unit 102 may select and use the above-described processing. For example, the white balance gain calculation unit 102 analyzes a dispersion degree of white balance gains of the same color components calculated in unit of pixel or in unit of image area, and switches the processing in accordance with the analyzed dispersion degree.

For example, a gain for the entire color polarized image is set in a case where a variation in the white balance gain for every unit of pixel or image area does not exceed a preset threshold, and a white balance gain is calculated and applied in unit of pixel or in unit of image area in a case where the gain exceeds the threshold.

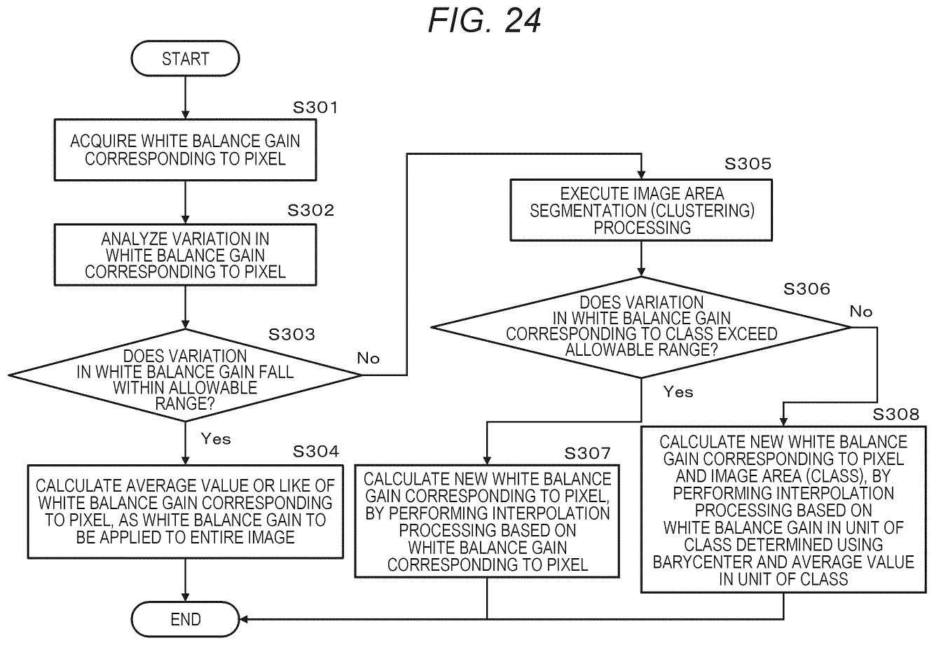

With reference to a flowchart illustrated in FIG. 24, a description is given to a sequence of white balance gain calculation processing in unit of pixel or in unit of image area executed by the white balance gain calculation unit 102.

Hereinafter, processing of each step of the flow of FIG. 24 will be sequentially described.

### (Step S301)

First, in step S301, the white balance gain calculation unit 102 calculates a white balance gain corresponding to a pixel.

The white balance gain calculation unit 102 executes one of the following two types of processing described above with reference to FIGS. 5 and 6, to execute the white balance gain calculation processing corresponding to a specific pixel.
A. White balance gain calculation processing example 1 (FIG. 5)
B. White balance gain calculation processing example 2 (FIG. 6)

Both of these two types of processing calculate a white balance gain by using a degree of linear polarization (DoLP) obtained from one or two pixels of an image. That is, the two types of processing are processing for calculating a white balance gain corresponding to a specific pixel.

### (Step S302)

Next, in step S302, the white balance gain calculation unit 102 analyzes a variation in the white balance gain in unit of pixel calculated in step S301.

Note that, it is assumed that a white balance gain corresponding to the pixel has been calculated for multiple pixels of the image in step S301.

In step S302, the white balance gain calculation unit 102 analyzes a variation in multiple white balance gains in unit of pixel calculated in step S301.

### (Step S303)

Next, in step S303, the white balance gain calculation unit 102 determines whether the variation in the white balance gain in unit of pixel analyzed in step S302 falls within an allowable range.

When it is determined that the variation in the white balance gain in unit of pixel falls within the preset allowable range, the processing proceeds to step S304.

Whereas, when it is determined that the variation in the white balance gain is not within the preset allowable range, the processing proceeds to step S305.

Note that the case where it is determined that the variation in the white balance gain in unit of pixel falls within the preset allowable range includes, for example, a case where it can be considered that illumination light is emitted from one light source or multiple light sources having a small difference in color temperature to a subject included in an image.

Whereas, the case where the variation in the white balance gain in unit of pixel exceeds the preset allowable range includes a case where it can be considered that illumination light is emitted from multiple light sources having different color temperatures to a subject included in an image.

### (Step S304)

When it is determined in step S303 that the variation in the white balance gains in unit of pixel falls within the preset allowable range, the processing proceeds to step S304.

In this case, in step S304, the white balance gain calculation unit 102 sets one white balance gain to be used in the entire area of the image.

The white balance gain calculation unit 102 calculates the white balance gain to be applied to the entire area of the image by performing statistical processing of the white balance gain in unit of pixel calculated in step S301, or the like.

For example, the white balance gain calculation unit 102 sets any one of an average value, a mode value, a median value, and the like of the white balance gains in unit of pixel calculated in step S301 as the white balance gain to be used in the entire image area.

### (Step S305)

Whereas, when it is determined in step S303 that the variation in the white balance gains in unit of pixel exceeds the preset allowable range, the processing proceeds to step S305.

In this case, in step S305, the white balance gain calculation unit 102 performs area segmentation processing on the image, that is, clustering processing. The white balance gain calculation unit 102 performs clustering as area segmentation processing based on a position of the image and an object type.

Next, in step S306, the white balance gain calculation unit 102 determines whether the variation in the white balance gain corresponding to the image area (class) generated by the area segmentation processing in step S305 exceeds an allowable range.

When it is determined that the variation in the white balance gain corresponding to the image area (class) exceeds the predetermined allowable range, the processing proceeds to step S307.

Whereas, when it is determined that the variation in the white balance gain corresponding to the image area (class) falls within the predetermined allowable range, the processing proceeds to step S308.

### (Step S307)

When it is determined in step S306 that the variation in the white balance gain corresponding to the image area (class) exceeds the predetermined allowable range, the processing proceeds to step S307.

In this case, in step S307, the white balance gain calculation unit 102 calculates a new white balance gain corresponding to the pixel by performing interpolation processing based on the white balance gain corresponding to the pixel calculated in step S301.

That is, the calculation processing of the new white balance gain corresponding to the pixel based on the interpolation processing described above with reference to FIG. 21 is executed.

### (Step S308)

Whereas, when it is determined in step S306 that the variation in the white balance gain corresponding to the image area (class) falls within the predetermined allowable range, the processing proceeds to step S308.

In this case, in step S308, the white balance gain calculation unit 102 calculates a new white balance gain corresponding to the pixel and the image area (class) by performing interpolation processing based on the white balance gain in unit of class determined using the barycenter and an average value in unit of each image area (class) generated by the area segmentation (clustering) processing executed in step S305.

That is, the calculation processing of the new white balance gain corresponding to the pixel and the image area (class) based on the interpolation processing described above with reference to FIG. 22 is executed.

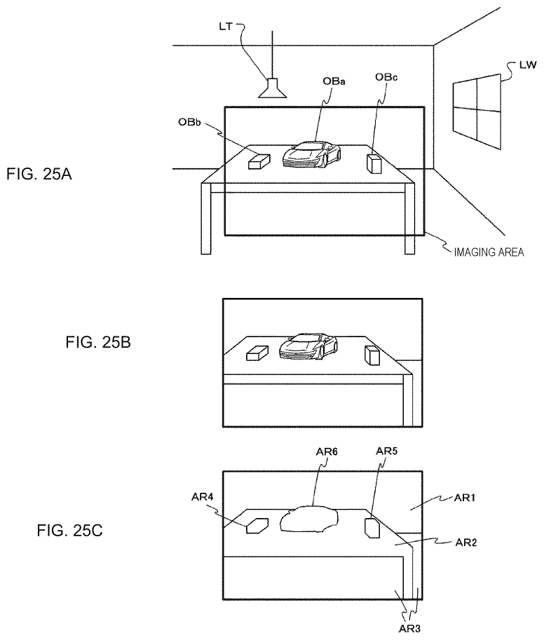

FIG. 25 illustrates a white balance gain calculation example corresponding to multiple image areas (classes). FIG. 25(a) illustrates an imaging scene. For example, a vehicle model OBa and achromatic objects OBc and OBd are provided on a table. Furthermore, the model OBa and the objects OBc and OBd on the table can be irradiated with illumination light from an illumination (for example, an incandescent lamp) LT provided inside the room. Furthermore, the model OBa and the objects OBc and OBd are irradiated with external light (for example, sunlight) incident from a window LW.

FIG. 25(b) illustrates a color polarized image of an imaging area of FIG. 25(a), and FIG. 25(c) illustrates an example of an area segmentation result.

Note that, in FIG. 25(c), a wall area AR1, a table area AR2, a floor area AR3, areas AR4 and AR5 indicating achromatic objects, and a model area AR6 are set as individual image areas (classes). The object in the image area AR4 (class AR4) is irradiated with illumination light from the illumination (for example, an incandescent lamp) LT provided inside the room, and the object in the image area AR5 (class AR5) is irradiated with external light (for example, sunlight) incident from the window.

In this case, a color temperature of the illumination light is different between the image area AR4 (class AR4) and the image area AR5 (class AR5), and for example, a variation exceeding the allowable range occurs between the white balance gain for the image area AR4 (class AR4) and the white balance gain for the image area AR5 (class AR5).

Therefore, for example, the gain of the image area AR6 (class AR6) is calculated by interpolation processing based on the white balance gain corresponding to the image area AR4 (class AR4), the white balance gain corresponding to the image area AR5 (class AR5), and a distance to the image area AR4 and a distance to the image area AR5.

Furthermore, gains are also set for the areas AR1 to AR3, similarly to the area AR6. Therefore, in the areas AR1 to AR3 and AR6, more natural white balance adjustment can be performed in consideration of the two types of illumination light. Note that, in a case where the illumination light is either light from the light source LT or external light, the gain for the entire color polarized image is set since the gains of the area AR4 and the area AR5 are substantially equal.

As described above, the image processing device 100 of the present disclosure calculates an optimum white balance gain for the captured image by using the polarization information.

Even in a case where an achromatic area cannot be detected from the captured image, the image processing device 100 of the present disclosure is capable of processing of calculating the optimum white balance gain for the captured image by using polarization information of a chromatic area.

Moreover, the image processing device 100 of the present disclosure can calculate the optimum white balance gain for each area in the imaging scene by using the polarization information. For example, in a case where multiple light sources having different color temperatures are provided, it is possible to perform processing of calculating the white balance gain in accordance with the color temperature of the illumination light with which the object is irradiated.

### 7. About Hardware Configuration Example of Image Processing Device

Next, a hardware configuration example of the image processing device 100 of the present disclosure will be described.

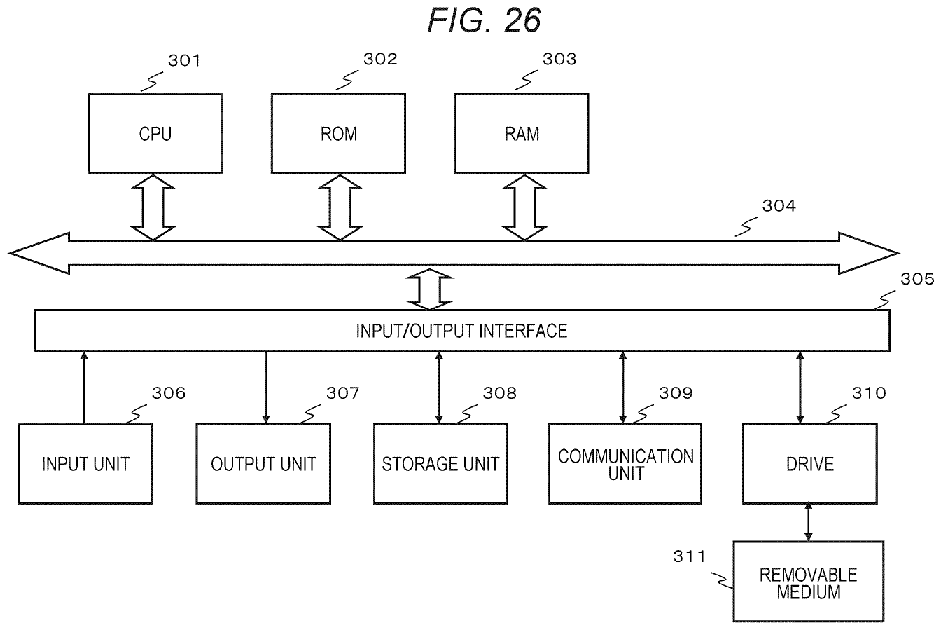

FIG. 26 is a diagram illustrating a hardware configuration example of the image processing device.

Each constituent part of the hardware configuration illustrated in FIG. 26 will be described.

A central processing unit (CPU) 301 functions as a data processing unit that executes various types of processing in accordance with a program stored in a read only memory (ROM) 302 or a storage unit 308. For example, the CPU 301 executes the processing according to the sequence described in the above embodiment.

A random access memory (RAM) 303 stores programs, data, or the like to be performed by the CPU 301. The CPU 301, the ROM 302, and the RAM 303 are connected to each other by a bus 304.

The CPU 301 is connected to an input/output interface 305 via the bus 304, and an input unit 306 including various operation units, switches, and the like, and an output unit 307 including a display as a display unit, a speaker, and the like are connected to the input/output interface 305, in addition to the camera.

The CPU 301 is input with a camera-captured image, operation information, and the like input from the input unit 306, executes various types of processing, and outputs a processing result to, for example, the output unit 307.

The storage unit 308 connected to the input/output interface 305 includes, for example, a hard disk, or the like and stores programs executed by the CPU 301 and various types of data. A communication unit 309 functions as a transmitter and receiver for data communication via a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and records or reads data.

### 8. Conclusion of Configuration of Present Disclosure

Hereinabove, the embodiments according to the present disclosure have been described in detail with reference to the specific embodiments. However, it is obvious that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology disclosed herein can have the following configurations.
(1) An image processing device including:
a polarization information acquisition unit configured to acquire polarization information from a color polarized image;
a white balance gain calculation unit configured to calculate a white balance gain by using polarization information acquired by the polarization information acquisition unit; and
a white balance adjustment unit configured to execute white balance adjustment processing to which a white balance gain calculated by the white balance gain calculation unit is applied, in which
the polarization information acquisition unit
calculates a color-corresponding polarization degree from the color polarized image, and
the white balance gain calculation unit
calculates a white balance gain by using color-corresponding polarization information of a pixel position where polarization degrees of two colors coincide with each other.
(2) The image processing device according to (1), in which
the white balance gain calculation unit
detects a pixel position where polarization degrees of two colors coincide with each other, as a pixel position where subject reflectances of the two colors coincide with each other, and
calculates a white balance gain by using polarization information of the pixel position where the subject reflectances of the two colors coincide with each other.
(3) The image processing device according to (1) or (2), in which
the polarization information acquisition unit
calculates a linear polarization degree (DoLP) corresponding to each color of R (red), G (green), and B (blue) from the color polarized image, and
the white balance gain calculation unit
detects a pixel position where linear polarization degrees (DoLP) of two colors selected from RGB coincide with each other, and
calculates a white balance gain by using a Stokes parameter of the two selected colors at the detected pixel position.
(4) The image processing device according to (3), in which
the white balance gain calculation unit
detects a pixel position where a linear polarization degree (DoLP_{R}) of R (red) and a linear polarization degree (DoLP_{G}) of G (green) coincide with each other, and
calculates a white balance gain k_{R} corresponding to R (red) by using a Stokes parameter of two colors of R (red) and G (green) at the detected pixel position.
(5) The image processing device according to (3) or (4), in which
the white balance gain calculation unit
detects a pixel position where a linear polarization degree (DoLP_{B}) of B (blue) and a linear polarization degree (DoLP_{G}) of G (green) coincide with each other, and
calculates a white balance gain k_{B} corresponding to B (blue) by using a Stokes parameter of two colors of B (blue) and G (green) at the detected pixel position.
(6) The image processing device according to any one of (1) to (5), in which
the polarization information acquisition unit
calculates a linear polarization degree (DoLP) corresponding to each color of R (red), G (green), and B (blue) from the color polarized image, and
the white balance gain calculation unit
calculates a white balance gain by using a relationship that an opposite color of a white balance adjusted image is equal to a color of a linear polarization degree (DoLP).
(7) The image processing device according to (6), in which
the white balance gain calculation unit
generates two relational expressions indicating a relationship that an opposite color of a white balance adjusted image is equal to a color of a linear polarization degree (DoLP), and
solves the two generated relational expressions as simultaneous equations to calculate two white balance gains that are unknowns included in the two relational expressions.
(8) The image processing device according to (7), in which
each of the relational expressions is
a relational expression including a Stokes parameter that can be acquired from a captured image and a white balance gain that is an unknown.
(9) The image processing device according to (7) or (8), in which
unknowns included in each of the relational expressions are:
a white balance gain k_{R} corresponding to R (red); and
a white balance gain k_{B} corresponding to B (blue)
(10) The image processing device according to any one of (1) to (9), in which
the white balance gain calculation unit
calculates a white balance gain to be applied to an entire image area.
(11) The image processing device according to any one of (1) to (10), in which
the white balance gain calculation unit
calculates an individual white balance gain in unit of pixel constituting an image or in unit of image area including multiple pixels.
(12) The image processing device according to (11), in which
the white balance gain calculation unit
executes interpolation processing using a white balance gain calculated in unit of pixel constituting an image or in unit of image area including multiple pixels, and calculates a white balance gain corresponding to a white balance gain uncalculated pixel or corresponding to an image area.
(13) The image processing device according to (11) or (12), in which
the white balance gain calculation unit
executes interpolation processing in which a weight is set, the weight according to a distance between a white balance gain calculated pixel and a white balance gain uncalculated pixel.
(14) The image processing device according to any one of (11) to (13), in which
the white balance gain calculation unit
performs clustering processing that is area segmentation processing of an image, and
calculates a white balance gain for every class that is an image area set by the clustering processing.
(15) The image processing device according to (14), in which
the white balance gain calculation unit
executes image area segmentation processing to which pattern matching or semantic segmentation is applied.
(16) The image processing device according to any one of (11) to (15), in which
the white balance gain calculation unit
changes a calculation mode of a white balance gain in accordance with a variation in a white balance gain calculated in unit of pixel or in unit of image area.
(17) The image processing device according to (16), in which
the white balance gain calculation unit
calculates a white balance gain common to an entire image area, in a case where a variation in a white balance gain calculated in unit of pixel or in unit of image area is within a preset allowable range.
(18) The image processing device according to (16) or (17), in which
the white balance gain calculation unit
sets a white balance gain calculated in unit of pixel or in unit of image area as final white balance gain, in a case where a variation in a white balance gain calculated in unit of pixel or in unit of image area exceeds a preset allowable range.
(19) An image processing method executed in an image processing device, the image processing method being for executing:
a polarization information acquisition step of acquiring, by a polarization information acquisition unit, polarization information from a color polarized image;
a white balance gain calculation step of calculating, by a white balance gain calculation unit, a white balance gain by using polarization information acquired in the polarization information acquisition step; and
a white balance adjustment step of executing, by a white balance adjustment unit, white balance adjustment processing to which a white balance gain calculated in the white balance gain calculation step is applied, in which
the polarization information acquisition step includes
a step of calculating a color-corresponding polarization degree from the color polarized image, and
the white balance gain calculation step
calculates a white balance gain by using color-corresponding polarization information of a pixel position where polarization degrees of two colors coincide with each other.
(20) A program for causing an image processing device to execute image processing, the program causing execution of:
a polarization information acquisition step of causing a polarization information acquisition unit to acquire polarization information from a color polarized image;
a white balance gain calculation step of causing a white balance gain calculation unit to calculate a white balance gain by using polarization information acquired in the polarization information acquisition step; and
a white balance adjustment step of causing a white balance adjustment unit to execute white balance adjustment processing to which a white balance gain calculated in the white balance gain calculation step is applied, in which
in the polarization information acquisition step,
a color-corresponding polarization degree is calculated from the color polarized image, and
in the white balance gain calculation step,
a white balance gain is calculated using color-corresponding polarization information of a pixel position where polarization degrees of two colors coincide with each other.

Note that a series of processing herein described can be executed by hardware, software, or a combined configuration of the both. In a case where processing by software is executed, a program in which a processing sequence is recorded can be installed and executed in a memory in a computer incorporated in dedicated hardware, or the program can be installed and executed in a general-purpose computer capable of executing various types of processing. For example, the program can be recorded in advance in a recording medium. In addition to being installed in a computer from the recording medium, a program can be received via a network such as a local area network (LAN) or the Internet and installed in a recording medium such as an internal hard disk or the like.

Furthermore, the various types of processing herein described may be performed not only in time series as described, but also in parallel or individually in accordance with the processing capability of the device that performs the processing or as necessary. Furthermore, a system herein described is a logical set configuration of a plurality of devices, and is not limited to a system in which devices of respective configurations are in the same housing.

### INDUSTRIAL APPLICABILITY

As described above, according to the configuration of one embodiment of the present disclosure, a configuration is realized in which white balance gain calculation processing and white balance adjustment are executed by using polarization information acquired from a color polarized image.

Specifically, for example, there are provided: the polarization information acquisition unit configured to acquire polarization information from a color polarized image; the white balance gain calculation unit configured to calculate a white balance gain by using the acquired polarization information; and the white balance adjustment unit configured to execute white balance adjustment processing to which the calculated white balance gain is applied. The polarization information acquisition unit calculates a color-corresponding polarization degree from the color polarized image, and the white balance gain calculation unit detects a pixel position where polarization degrees of two colors coincide with each other on the basis of a pixel position where subject reflectances of the two colors coincide with each other, and calculates a white balance gain by using color-corresponding polarization information of the detected pixel position.

With this configuration, a configuration is realized in which white balance gain calculation processing and white balance adjustment are executed by using polarization information acquired from a color polarized image.

### REFERENCE SIGNS LIST

10 Light source
11 Irradiation light
20 Subject
22 Observation light (=reflection light)
30 Imaging unit
50 Imaging unit (color polarized image capturing camera)
51 Polarizing filter
52 Image sensor
80 Imaging system
100 Image processing device
101 Polarization information acquisition unit
102 White balance gain calculation unit
103 White balance adjustment unit
301 CPU
302 ROM
303 RAM
304 Bus
305 Input/output interface
306 Input unit
307 Output unit
308 Storage unit
309 Communication unit
310 Drive
311 Removable medium

1. An image processing device comprising:
a polarization information acquisition unit configured to acquire polarization information from a color polarized image;
a white balance gain calculation unit configured to calculate a white balance gain by using polarization information acquired by the polarization information acquisition unit; and
a white balance adjustment unit configured to execute white balance adjustment processing to which a white balance gain calculated by the white balance gain calculation unit is applied, wherein
the polarization information acquisition unit
calculates a color-corresponding polarization degree from the color polarized image, and
the white balance gain calculation unit
calculates a white balance gain by using color-corresponding polarization information of a pixel position where polarization degrees of two colors coincide with each other.

2. The image processing device according to claim 1, wherein
the white balance gain calculation unit
detects a pixel position where polarization degrees of two colors coincide with each other, as a pixel position where subject reflectances of the two colors coincide with each other, and
calculates a white balance gain by using polarization information of the pixel position where the subject reflectances of the two colors coincide with each other.

3. The image processing device according to claim 1, wherein
the polarization information acquisition unit
calculates a linear polarization degree (DoLP) corresponding to each color of R (red), G (green), and B (blue) from the color polarized image, and
the white balance gain calculation unit
detects a pixel position where linear polarization degrees (DoLP) of two colors selected from RGB coincide with each other, and
calculates a white balance gain by using a Stokes parameter of the two selected colors at the detected pixel position.

4. The image processing device according to claim 3, wherein
the white balance gain calculation unit
detects a pixel position where a linear polarization degree (DoLP_{R}) of R (red) and a linear polarization degree (DoLP_{G}) of G (green) coincide with each other, and
calculates a white balance gain k_{R} corresponding to R (red) by using a Stokes parameter of two colors of R (red) and G (green) at the detected pixel position.

5. The image processing device according to claim 3, wherein
the white balance gain calculation unit
detects a pixel position where a linear polarization degree (DoLP_{B}) of B (blue) and a linear polarization degree (DoLP_{G}) of G (green) coincide with each other, and
calculates a white balance gain k_{B} corresponding to B (blue) by using a Stokes parameter of two colors of B (blue) and G (green) at the detected pixel position.

6. The image processing device according to claim 1, wherein
the polarization information acquisition unit
calculates a linear polarization degree (DoLP) corresponding to each color of R (red), G (green), and B (blue) from the color polarized image, and
the white balance gain calculation unit
calculates a white balance gain by using a relationship that an opposite color of a white balance adjusted image is equal to a color of a linear polarization degree (DoLP).

7. The image processing device according to claim 6, wherein
the white balance gain calculation unit
generates two relational expressions indicating a relationship that an opposite color of a white balance adjusted image is equal to a color of a linear polarization degree (DoLP), and
solves the two generated relational expressions as simultaneous equations to calculate two white balance gains that are unknowns included in the two relational expressions.

8. The image processing device according to claim 7, wherein
each of the relational expressions is
a relational expression including a Stokes parameter that can be acquired from a captured image and a white balance gain that is an unknown.

9. The image processing device according to claim 7, wherein
unknowns included in each of the relational expressions are:
a white balance gain k_{R} corresponding to R (red); and
a white balance gain k_{B} corresponding to B (blue).

10. The image processing device according to claim 1, wherein
the white balance gain calculation unit
calculates a white balance gain to be applied to an entire image area.

11. The image processing device according to claim 1, wherein
the white balance gain calculation unit
calculates an individual white balance gain in unit of pixel constituting an image or in unit of image area including multiple pixels.

12. The image processing device according to claim 11, wherein
the white balance gain calculation unit
executes interpolation processing using a white balance gain calculated in unit of pixel constituting an image or in unit of image area including multiple pixels, and calculates a white balance gain corresponding to a white balance gain uncalculated pixel or corresponding to an image area.

13. The image processing device according to claim 11, wherein
the white balance gain calculation unit
executes interpolation processing in which a weight is set, the weight according to a distance between a white balance gain calculated pixel and a white balance gain uncalculated pixel.

14. The image processing device according to claim 11, wherein
the white balance gain calculation unit
performs clustering processing that is area segmentation processing of an image, and
calculates a white balance gain for every class that is an image area set by the clustering processing.

15. The image processing device according to claim 14, wherein
the white balance gain calculation unit
executes image area segmentation processing to which pattern matching or semantic segmentation is applied.

16. The image processing device according to claim 11, wherein
the white balance gain calculation unit
changes a calculation mode of a white balance gain in accordance with a variation in a white balance gain calculated in unit of pixel or in unit of image area.

17. The image processing device according to claim 16, wherein
the white balance gain calculation unit
calculates a white balance gain common to an entire image area, in a case where a variation in a white balance gain calculated in unit of pixel or in unit of image area is within a preset allowable range.

18. The image processing device according to claim 16, wherein
the white balance gain calculation unit
sets a white balance gain calculated in unit of pixel or in unit of image area as final white balance gain, in a case where a variation in a white balance gain calculated in unit of pixel or in unit of image area exceeds a preset allowable range.

19. An image processing method executed in an image processing device, the image processing method being for executing:
a polarization information acquisition step of acquiring, by a polarization information acquisition unit, polarization information from a color polarized image;
a white balance gain calculation step of calculating, by a white balance gain calculation unit, a white balance gain by using polarization information acquired in the polarization information acquisition step; and
a white balance adjustment step of executing, by a white balance adjustment unit, white balance adjustment processing to which a white balance gain calculated in the white balance gain calculation step is applied, wherein
the polarization information acquisition step includes
a step of calculating a color-corresponding polarization degree from the color polarized image, and
the white balance gain calculation step
calculates a white balance gain by using color-corresponding polarization information of a pixel position where polarization degrees of two colors coincide with each other.

20. A program for causing an image processing device to execute image processing, the program causing execution of:
a polarization information acquisition step of causing a polarization information acquisition unit to acquire polarization information from a color polarized image; and
a white balance gain calculation step of causing a white balance gain calculation unit to calculate a white balance gain by using polarization information acquired in the polarization information acquisition step; and
a white balance adjustment step of causing a white balance adjustment unit to execute white balance adjustment processing to which a white balance gain calculated in the white balance gain calculation step is applied, wherein
in the polarization information acquisition step,
a color-corresponding polarization degree is calculated from the color polarized image, and
in the white balance gain calculation step,
a white balance gain is calculated using color-corresponding polarization information of a pixel position where polarization degrees of two colors coincide with each other.
